(19) United States
(12) Patent Application Publication
(10) Pub. No.: US 2015/0127556 A1
(43) Pub. Date: May 7, 2015

(54) INFORMATION PRESENTATION METHOD, INFORMATION PRESENTATION SYSTEM, PROGRAM, AND RECORDING MEDIUM

(71) Applicant: Panasonic Intellectual Property Corporation of America, Torrance, CA (US)

(72) Inventors: Shunji Harada, Osaka (JP); Kouji Miura, Osaka (JP); Eiichi Naito, Kyoto (JP); Tomohiko Kitamura, Osaka (JP); Aki Yoneda, Hyogo (JP); Kozo Nishimura, Osaka (JP)

(73) Assignee: Panasonic Intellectual Property Corporation of Ame, Torrance, CA (US)

(21) Appl. No.: 14/400,792

(22) PCT Filed: Apr. 8, 2014
(86) PCT No.: PCT/JP2014/002001

§ 371 Date: Nov. 12, 2014

(30) Foreign Application Priority Data
Apr. 15, 2013 (JP) 2013-084718

(51) Int. Cl. G06Q 30/00

(52) U.S. Cl. CPC G06Q 30/012
USPC 705/302

(57) ABSTRACT

One aspect of the present disclosure provides an information presentation method for presenting a recommended guarantee content of a first device included in a plurality of devices. The information presentation method includes acquiring use history information including data indicating use of the first device (S3210), generating information indicating a use situation of the first device based on the use history information and processing defined in each type of the device (S3220), deciding the recommended guarantee content of the first device based on the information indicating the use situation of the first device (S3230), and presenting the recommended guarantee content to a user of the first device (S3240).

### TECHNICAL FIELD

The present disclosure relates to an information presentation method for presenting information about a recommended guarantee content concerning a device such as a home appliance, an information presentation system, a program, and a recording medium.

### BACKGROUND ART

A manufacturer guarantee provided by a device manufacturer and an extended guarantee provided by a device distributor are well known as a guarantee of a device such as a home appliance. In the manufacturer guarantee, a spontaneous failure generated in a given period (generally, for 1 year) from a purchase date of the device is repaired with no charge in principle. In the extended guarantee, a spontaneous failure generated in a predetermined period (generally, for 4 years) after the expiration of the manufacturer guarantee is repaired at a nominal fee.

PTL 1 discloses objective presentation of how a user has used the device, to the user himself/herself.

PTL 2 discloses a vehicle-management-state diagnostic unit that estimates a tire pneumatic pressure management situation of an automobile, and an insurance fee calculator that calculates an insurance fee and/or insurance payment of automobile insurance based on an estimation result of the vehicle-management-state diagnostic unit.

### CITATION LIST

### Patent Literatures

PTL 1: Unexamined Japanese Patent Publication No. 2008-102936

PTL 2: Unexamined Japanese Patent Publication No. 2004-145489

### SUMMARY OF THE INVENTION

However, further improvement is required in a conventional configuration. One aspect of the present disclosure provides an information presentation method for presenting a recommended guarantee content of a first device included in a plurality of devices, the information presentation method including: acquiring use history information including data indicating use of the first device; generating information indicating a use situation of the first device, based on the use history information and processing defined in each type of the device; deciding the recommended guarantee content of the first device, based on the information indicating the use situation of the first device; and presenting the recommended guarantee content to a user of the first device.

The general or specific aspect of the present disclosure may be implemented as a device, a system, an integrated circuit, a computer program, or a computer readable non-temporary recording medium such as a CD-ROM, or any combination of the device, the system, the integrated circuit, the computer program, and the recording medium.

The information presentation method of the present disclosure can achieve further improvement.

### BRIEF DESCRIPTION OF DRAWINGS

FIG. 1A is a view illustrating an overview of a recommended guarantee content presentation system according to an exemplary embodiment.

FIG. 1B is a view illustrating a data center operating company of the exemplary embodiment.

FIG. 1C is a view illustrating the data center operating company of the exemplary embodiment.

FIG. 2 is a view illustrating a configuration of the recommended guarantee content presentation system according to a first exemplary embodiment.

FIG. 3 is a view illustrating a configuration of a group of the first exemplary embodiment.

FIG. 4 is a view illustrating a configuration of a cloud server of the first exemplary embodiment.

FIG. 5 is a view illustrating a configuration of a server of the first exemplary embodiment.

FIG. 6 is a view illustrating a processing flow of device use history management service of the first exemplary embodiment.

FIG. 7 is a view illustrating a user management table managed by the cloud server of the first exemplary embodiment.

FIG. 8 is a view illustrating a device management table managed by the cloud server of the first exemplary embodiment.

FIG. 9A is a view illustrating a use history management table of a lighting device managed by the cloud server of the first exemplary embodiment.

FIG. 9B is a view illustrating the use history management table of the lighting device managed by the cloud server of the first exemplary embodiment.

FIG. 10 is a view illustrating a processing flow of device recommended guarantee presentation service of the first exemplary embodiment.

FIG. 11 is a view illustrating a user management table managed by a server of the first exemplary embodiment.

FIG. 12 is a view illustrating a device management table managed by a server of the first exemplary embodiment.

FIG. 13A is a view illustrating use characteristic information about the lighting device in the first exemplary embodiment.

FIG. 13B is a view illustrating the use characteristic information about the lighting device in the first exemplary embodiment.

FIG. 14A is a view illustrating a table used to decide a recommended guarantee content of the lighting device in the first exemplary embodiment.

FIG. 14B is a view illustrating the table used to decide the recommended guarantee content of the lighting device in the first exemplary embodiment.

FIG. 15A is a view illustrating a display screen example of recommended guarantee information about the lighting device in the first exemplary embodiment.

FIG. 15B is a view illustrating a display screen example of recommended guarantee information about the lighting device in the first exemplary embodiment.

FIG. 16 is a view illustrating a configuration of a server according to a second exemplary embodiment.

FIG. 17 is a view illustrating a processing flow of device recommended guarantee presentation service of the second exemplary embodiment.

FIG. 18A is a view illustrating a service point providing process of the second exemplary embodiment.

FIG. 18B is a view illustrating the service point providing process of the second exemplary embodiment.

FIG. 19 is a view illustrating a display screen example of recommended guarantee information about the lighting device in the second exemplary embodiment.

FIG. 20A is a view illustrating a television-set use history management table managed by a cloud server according to a third exemplary embodiment.

FIG. 20B is a view illustrating the television-set use history management table managed by the cloud server of the third exemplary embodiment.

FIG. 21A is a view illustrating use characteristic information about a television set in the third exemplary embodiment.

FIG. 21B is a view illustrating the use characteristic information about the television set in the third exemplary embodiment.

FIG. 22A is a view illustrating a table used to decide a recommended guarantee content of the television set in the third exemplary embodiment.

FIG. 22B is a view illustrating a table used to decide the recommended guarantee content of the television set in the third exemplary embodiment.

FIG. 22C is a view illustrating a table used to decide the recommended guarantee content of the television set in the third exemplary embodiment.

FIG. 22D is a view illustrating a table used to decide the recommended guarantee content of the television set in the third exemplary embodiment.

FIG. 23A is a view illustrating a display screen example of recommended guarantee information about the television set in the third exemplary embodiment.

FIG. 23B is a view illustrating a display screen example of the recommended guarantee information about the television set in the third exemplary embodiment.

FIG. 23C is a view illustrating a display screen example of the recommended guarantee information about the television set in the third exemplary embodiment.

FIG. 24A is a view illustrating an air conditioner use history management table managed by a cloud server according to a fourth exemplary embodiment.

FIG. 24B is a view illustrating an air conditioner use history management table managed by the cloud server of the fourth exemplary embodiment.

FIG. 24C is a view illustrating an air conditioner use history management table managed by the cloud server of the fourth exemplary embodiment.

FIG. 25A is a view illustrating use characteristic information about the air conditioner in the fourth exemplary embodiment.

FIG. 25B is a view illustrating use characteristic information about the air conditioner in the fourth exemplary embodiment.

FIG. 25C is a view illustrating use characteristic information about the air conditioner in the fourth exemplary embodiment.

FIG. 25D is a view illustrating use characteristic information about the air conditioner in the fourth exemplary embodiment.

FIG. 26A is a view illustrating a table used to decide a recommended guarantee content of the air conditioner in the fourth exemplary embodiment.

FIG. 26B is a view illustrating a table used to decide the recommended guarantee content of the air conditioner in the fourth exemplary embodiment.

FIG. 26C is a view illustrating a table used to decide the recommended guarantee content of the air conditioner in the fourth exemplary embodiment.

FIG. 27A is a view illustrating a display screen example of recommended guarantee information about the air conditioner in the fourth exemplary embodiment.

FIG. 27B is a view illustrating a display screen example of the recommended guarantee information about the air conditioner in the fourth exemplary embodiment.

FIG. 28 is a view illustrating service type 1 of the exemplary embodiment.

FIG. 29 is a view illustrating service type 2 of the exemplary embodiment.

FIG. 30 is a view illustrating service type 3 of the exemplary embodiment.

FIG. 31 is a view illustrating service type 4 of the exemplary embodiment.

FIG. 32 is a flowchart illustrating a presentation flow of recommended guarantee content in the first exemplary embodiment.

### DESCRIPTION OF EMBODIMENTS

Underlying Knowledge Forming Basis of the Present Disclosure

The present inventors found the following problem.

For a content of the extended guarantee of a device such as a home appliance, generally a participating contract of the extended guarantee is performed at the time of a purchase of the device, and a guarantee period is a predetermined period after the expiration of the manufacturer guarantee, a guarantee contract is for profit, and the spontaneous failure is repaired with no charge. That is, the content of the extended guarantee does not reflect a use history (for example, use frequency) of the device. Generally, it is considered that the failure of the device is easily generated with increasing use frequency of the device, and that whether the failure of the device is generated in an extended guarantee period mainly depends on the use history (for example, use frequency) of the device until starting of an extended guarantee period. This is because it is considered that the use history of the device before the starting of the extended guarantee period is generally similar to the use history of the device in the extended guarantee period.

Therefore, users whose devices differ from each other in the use history have a sense of unfairness for an extended guarantee content in which the use history of the device is not considered.

In order to present a recommended extended guarantee content, in which the use history is considered, to the user, it is necessary to decide an extended guarantee content to be presented in consideration of a type of a device such that a target device of the extended guarantee is an air conditioner or a washing machine. This is because the air conditioner differs from the washing machine in a use condition.

PTL 1 discloses objective presentation of how a user has used the device, to the user himself/herself. PTL 2 discloses a vehicle-management-state diagnostic unit that estimates a tire pneumatic pressure management situation of an automobile, and an insurance fee calculator that calculates an insurance fee and/or insurance payment of automobile insurance based on an estimation result by the vehicle-management-state diagnostic unit. PTL 2 illustrates an example in which the type of the target device is one kind, namely, the automobile. That is, in the methods disclosed in PTL 1 and PTL 2, the recommended guarantee content can hardly be presented based on the type of the device and the use history, and thus the user can hardly solve the sense of unfairness.

In order to solve the problem, one aspect of the present disclosure provides an information presentation method for presenting a recommended guarantee content of a first device included in a plurality of devices, the information presentation method including: acquiring use history information including data indicating use of the first device; generating information indicating a use situation of the first device, based on the use history information and processing defined in each type of the device; deciding the recommended guarantee content of the first device, based on the information indicating the use situation of the first device; and presenting the recommended guarantee content to a user of the first device.

Therefore, the recommended guarantee content can be presented based on the type of the device and the use history, thereby solving the user's sense of unfairness.

The information indicating the use situation of the first device may include information indicating a degree of use of the first device, the recommended guarantee content may include at least one of a guarantee fee, a guarantee period, and a guarantee coverage that are decided based on the information indicating the degree of use of the first device, and the information indicating the degree of use of the first device may be presented to the user of the first device together with the recommended guarantee content.

Therefore, objectivity can be ensured for the presented recommended guarantee content.

The information indicating the degree of use of the first device may include information indicating a degree of use of a specific functional module included in the first device.

Therefore, the recommended guarantee content can finely be presented based on a use situation in a unit of the functional module included in the first device, thereby solving the user's sense of unfairness.

The information presentation method may further include: generating a service point applicable to the guarantee fee included in the recommended guarantee content, based on the information indicating the degree of use of the first device; and adding the generated service point to a service point possessed by the user of the first device. At this point, the post-addition service point may be presented to the user of the first device together with the recommended guarantee content.

Therefore, approval of the presented recommended guarantee content is easily obtained from the user.

The information presentation method may further include: acquiring information identifying the user of the first device, the information identifying the user of the first device corresponding to the data indicating the use of the first device; and generating information indicating the use situation of the first device in each user, based on the use history information further including the information identifying the user of the first device which corresponds to the data indicating the use of the first device, and based on the processing defined in each type of the device. At this point, the information indicating the use situation of the first device in each user may be presented to the user of the first device together with the recommended guarantee content.

Therefore, objectivity can be ensured for the presented recommended guarantee content.

The use history information may include data indicating the use of the first device in a second period included in a first period started from a purchase date of the first device, the guarantee period of the recommended guarantee content may be started after the expiration of the first period, and the first period may be a guarantee period of the first device by a device manufacturer.

Therefore, the user's sense of unfairness can be solved in applying for the extended guarantee.

The use history information may include data indicating the use of the first device in a fourth period included in a third period started after the first period started from a purchase date of the first device, the guarantee period of the recommended guarantee content may be started after a third period, and the first period may be a guarantee period of the first device by a device manufacturer.

Therefore, the user's sense of unfairness can be solved in applying for the additional extended guarantee.

The data indicating the use of the first device may include data indicating use of a functional module that is newly added to the first device or updated, and the fourth period may be a period started from a day on which the functional module is newly added or updated.

Therefore, the valid guarantee content can be provided even if the functional module is added or updated via a network.

When the specific functional module is exchanged, the information indicating the degree of use of the specific functional module in the period until the exchange of the specific functional module may be reset.

Therefore, the valid recommended guarantee content can be decided.

The information presentation method may further include acquiring information identifying an installation place of the first device. At this point, the guarantee fee for installing the first device indoor may be lower than the guarantee fee for installing the first device outdoor, or the guarantee period for installing the first device indoor may be longer than the guarantee period for installing the first device outdoor.

Therefore, the valid recommended guarantee content can be decided.

The information presentation method may further include: acquiring error history information including data indicating that the second device is not normally operated, as use history information about the second device that is identical to the first device in a type and manufacturing information identical to that of the first device; and deciding the recommended guarantee content of the first device based on the error history information.

Therefore, the valid recommended guarantee content can be decided.

The first device may be a television set that can receive terrestrial broadcasting, the specific functional module may be a terrestrial-broadcasting-related functional module including a function of receiving the terrestrial broadcasting, the use history information may include information indicating when the terrestrial-broadcasting-related functional module is used, and information indicating the degree of use of the specific functional module may include an average number of days of each month of a number of days on which the terrestrial-broadcasting-related functional module is used for a predetermined time or more per day in a fifth period included in the first period started from the purchase date of the first device.

The plurality of devices may include a television set and a lighting device, which differ from each other in the type of the device. The first device may be the lighting device, and information indicating the degree of use of the lighting device may include the average number of days of each month of the number of days on which the lighting device is used for a predetermined time or less per day in a sixth period included in the first period started from the purchase date of the first device.

The information presentation method may further include: acquiring use history information including data indicating use of each of n (n is a natural number) devices each of which is identical to the first device in a type; generating information indicating a degree of use of each of the n devices, based on the use history information corresponding to each of the n devices and the processing defined in each type of the device; generating information indicating an integrated degree of use of the first device and the n devices, based on the information indicating the degree of use of the first device and the information indicating the degree of use of each of the n devices; deciding a package recommended guarantee content of the first device and the n devices, based on the information indicating the integrated degree of use; and presenting the package recommended guarantee content to the user of the first device together with the information indicating the integrated degree of use.

Therefore, the user can efficiently apply for the guarantee contract for the plurality of devices of the identical type.

The information presentation method may further include: using the package recommended guarantee content as a recommended guarantee content of a third device that is identical to the first device in a type; and presenting the package recommended guarantee content as the recommended guarantee content of the third device to the user of the third device together with the information indicating the integrated degree of use.

Therefore, the recommended guarantee content of the third device in which the type is identical to that of the plurality of devices including the first device can efficiently be presented.

The first device may be a first air conditioner, the n devices may be n air conditioners, the information indicating the degree of use of the first device may be a number of days decided based on an average number of days of each month of a number of days on which the first air conditioner is used for a predetermined time or more per day in a predetermined period, the information indicating the degree of use of each of the n devices may be a number of days decided based on an average number of days of each month of a number of days on which each of the n air conditioners is used for the predetermined time or more per day in the predetermined period, and the information indicating the integrated degree of use may be an average value of the decided number of days for the first air conditioner and the decided number of days for each of the n air conditioners.

The general or specific aspect of the present disclosure may be implemented as a device, a system, an integrated circuit, a computer program, or a computer readable non-temporary recording medium such as a CD-ROM, or any combination of the device, the system, the integrated circuit, the computer program, and the recording medium.

Each of the following exemplary embodiments shows a comprehensive or specific example.

A numerical value, a shape, a component, a step, and order of the step of the following exemplary embodiments are described by way of example, but the present disclosure is not limited to these details. In the components of the following exemplary embodiments, the component that is not described in an independent claim indicating the highest concept is described as an arbitrary component. Contents of all the exemplary embodiments can be combined with each other.

(Overview of Service to be Provided)

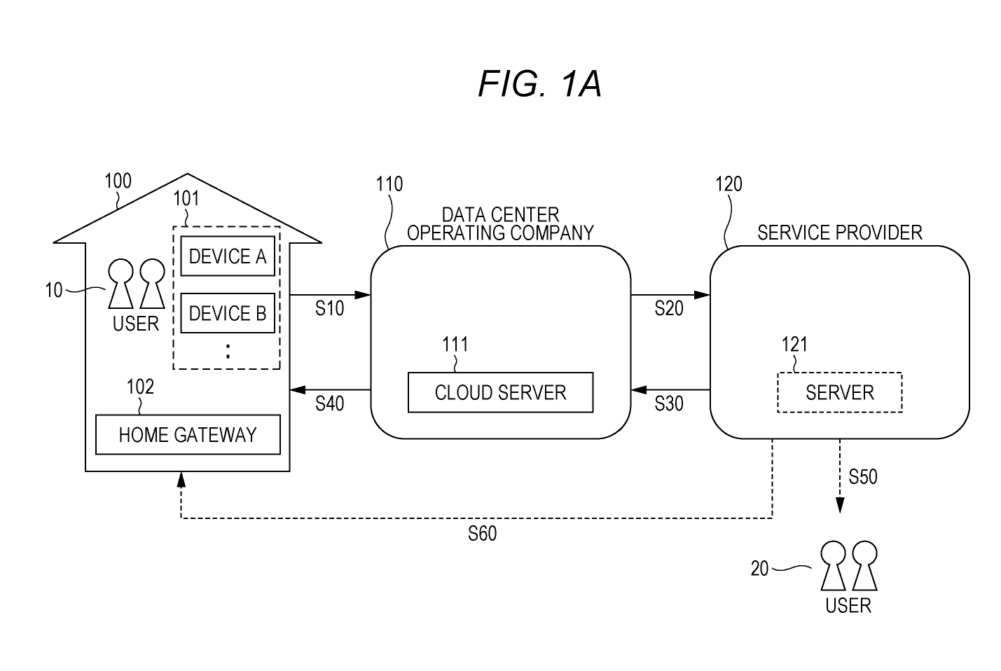

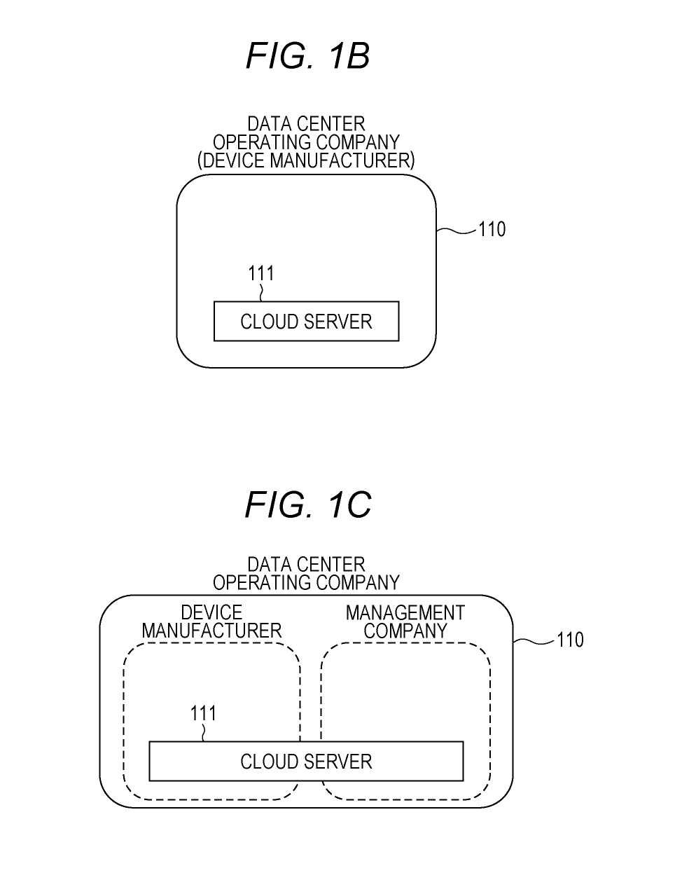

FIG. 1A illustrates an overview of a recommended guarantee content presentation system according to the exemplary embodiment.

<Schematic Configuration of Group 100>

For example, group 100 is a company, an organization, and a home irrespective of a scale of group 100. Device A and device B that are the plurality of devices 101, and home gateway 102 exist in group 100. The plurality of devices 101 include devices (such as a smartphone, a tablet terminal, a PC (Personal Computer), and a television set) connectable to the Internet and devices (such as a lighting device, a washing machine, a refrigerator, a rice cooker, a microwave oven, a cleaner, and an air conditioner) that are not connectable to the Internet by itself. For example, each of the devices that are not connectable to the Internet by itself may include a device, which is connectable to the Internet through home gateway 102 that can communicate with various devices in a house. User 10 who uses the plurality of devices 101 exists in group 100. Although FIG. 1A illustrates the case where the plurality of devices 101 are the two devices, the number of the plurality of devices 101 is not limited to two. For example, the plurality of devices 101 may be one device or at least three devices.

Examples of the plurality of devices 101 include devices (such as a lighting device, a washing machine, a refrigerator, a rice cooker, a microwave oven, a cleaner, an air conditioner, and a television set) that are registered in cloud server 111 of data center operating company 110 by user 10 and managed by cloud server 111. Devices (such as a smartphone, a tablet terminal, and a PC) that are not managed by cloud server 111 may exist.

[Supplements of Each Device and Home Gateway]

1) The device connectable to the Internet includes a wired LAN or wireless LAN connecting function. Using the wired LAN or wireless LAN connecting function, the device may be connected to a general-purpose router (home gateway 102 in the case where home gateway 102 includes a general-purpose router function), and connected to the Internet through the general-purpose router. In the devices connectable to the Internet, mobile terminals such as the smartphone and the tablet terminal include a function of communicating with a 3G (Third Generation) or LTE (Long Term Evolution) mobile phone network, in addition to the wireless LAN connecting function. Each of the mobile terminals may be connected to the mobile phone network using the communication function, and connected to the Internet via the mobile phone network.

2) For example, the devices that are not connectable to the Internet by itself include wireless communication functions such as an infrared ray, Bluetooth (registered trademark), and specified lower power radio. Each of the devices may be connected to home gateway 102 through the wireless communication functions, and connected to the Internet through home gateway 102. For example, each of the devices that are not connectable to the Internet by itself includes a close-range communication function called NFC (Near Field Communication). The device is connected to the NFC enabled smartphone in which an application compatible with the NFC is installed, and information about the device may be read and transferred to a server connected to the Internet through the smartphone. For the use of the NFC, the smartphone is presented to the device to conduct the communication between the smartphone and the device by NFC, whereby the smartphone reads the information about the device.

3) For example, home gateway 102 is a network device (such as a general-purpose router) that serves as a bridge between a wide area communication network such as the Internet and a LAN (Local Area Network) such as a domestic network. Home gateway 102 may be a network device that serves as a bridge between the wide area communication network such as the Internet and a device having wireless communication functions such as Bluetooth (registered trademark) and specified lower power radio. Home gateway 102 may have a function of managing pieces of use history information of device A and device B. For example, using a predetermined communication protocol such as ECHONET Lite (registered trademark), home gateway 102 may have a function of controlling device A and device B based on an instruction of user 10. Home gateway 102 is not necessarily provided. For example, in a case where all the plurality of devices are connected to the Internet with no use of home gateway 102, necessity of home gateway 102 is eliminated.

4) The configurations of the device connectable to the Internet and the device that is not connectable to the Internet by itself, and the home gateway are described by way of example, and other configurations are possible.

<Schematic Configuration of Data Center Operating Company 110>

Cloud server 111 exists in data center operating company 110. As used herein, cloud server 111 means a virtual server coordinating with various devices via the Internet. Cloud server 111 mainly manages huge data (big data) that is hardly dealt with by a normal database management tool or the like. Data center operating company 110 performs data management and management of cloud server 111, and operates a data center that performs the data management and the management of cloud server 111, and the like. Services performed by data center operating company 110 are described in detail later. At this point, data center operating company 110 is not limited to a company that only performs the data management and the operation of cloud server 111, and the like. For example, in a case where a device manufacturer that develops and produces one of the plurality of devices 101 also performs the data management and management of the cloud server 111, and the like, the device manufacturer corresponds to data center operating company 110 (FIG. 1B). Data center operating company 110 is not limited to one company. For example, in a case where a device manufacturer and another management company collaboratively perform or share the data management and the operation of cloud server 111, both or one of the device manufacturer and the management company corresponds to data center operating company 110 (FIG. 1C).

The data center operating company is not limited to one company. The plurality of data center operating companies may exist.

<Schematic Configuration of Service Provider 120>

Service provider 120 includes server 121. Irrespective of a scale of server 121, for example, server 121 as used herein includes a memory in a personal computer. Sometimes the service provider does not include server 121.

In FIG. 1A, data center operating company 110 and service provider 120 exist separately. Alternatively, data center operating company 110 and service provider 120 may be integrated.

The service provider is not limited to one provider. The plurality of service providers may exist.

<Information Flow>

An information flow in the service provided by the system will be described below with reference to FIG. 1A. At this point, it is assumed that user 10 registers a device A and a device B of group 100 in services provided by cloud server 111 of data center operating company 110 and server 121 of service provider 120. The registration in the service is described in detail later.

Each of device A and device B of group 100 transmits use history information about the device to cloud server 111 of data center 110. Cloud server 111 accumulates the use history information about device A and the use history information about device B (S10). As used herein, the use history information means information indicating, for example, an operational situation or the operational date and time of each device included in the plurality of devices 101. Examples of the use history information includes a television viewing history, recording reservation information about a recorder, the operational date and time of a washing machine, a laundry amount detected by a washing machine, the door opening and closing date and time of a refrigerator, the number of door opening and closing times of a refrigerator, the date and time of turning on a lighting device, the date and time of turning off the lighting device, and the operational date and time of an air conditioner, an operational mode of the air conditioner. The use history information is not limited to the above examples, and means all pieces of information that can be acquired from all the devices. In the pieces of information, specific information may be used as the use history information.

The use history information may directly be provided to cloud server 111 from the plurality of devices 101 without the home gateway. The pieces of use history information may temporarily be accumulated in home gateway 102 from the plurality of devices, and provided to cloud server 111 from home gateway 102.

Using a device, such as a smartphone, which is provided with input means, user 10 transmits information about user 10 (identification information or profile information) or information about the plurality of devices 101 to cloud server 111 of data center operating company 110 and server 121 of service provider 120 for the purpose of the registration in the service. As described above, the information about the user and the information about the devices are transmitted from the device such as the smartphone to the server of service provider 120. Alternatively, the information about the user and the information about the devices may be transmitted from the device such as the smartphone to cloud server 111 of data center operating company 110, and transmitted from cloud server 111 to service provider.

Cloud server 111 of data center operating company 110 provides accumulated use history information to service provider 120 in a constant unit. At this point, the constant unit is either a unit at which the data center operating company can provide the accumulated information to service provider 120 while organizing the accumulated information or a unit for which service provider 120 makes a request. Although the constant unit is not necessarily constant, sometimes a provided information amount varies depending on the situation. The use history information is stored in server 121 included in service provider 120 as needed basis (S20).

Service provider 120 organizes the use history information into information suitable for a service provided to the user, and provides the service to the user based on the organized information. The user to whom the service is provided may be user 10 who uses the plurality of devices 101 or external user 20. As to a method for providing the service to the user, for example, the service provider may directly provide the service to the user (S50 and S60). As to a method for providing the service to the user, for example, the service may be provided to user 10 through cloud server 111 of data center operating company 110 again (S30 and S40). Alternatively, cloud server 111 of data center operating company 110 may organize the use history information into the information suitable for the service provided to the user, and provide the organized information to service provider 120.

User 10 and user 20 may be identical to or different from each other.

The use history information is not directly acquired from the device, but the use history information may be information that can indirectly be acquired through another device. For example, the operation of the device may be monitored by other devices such as a sensor and a monitoring camera, and cloud server 111 may acquire information about the operation of the device as the use history information from other devices.

### First Exemplary Embodiment

In a first exemplary embodiment, a description will be given of a case where the lighting device is taken as an example, and the recommended guarantee content (such as a guarantee fee, a guarantee period, and a guarantee coverage) is decided and presented to the user according to the use history information about the lighting device in a constant period from a purchase date.

<Entire Configuration of Recommended Guarantee Content Presentation System>

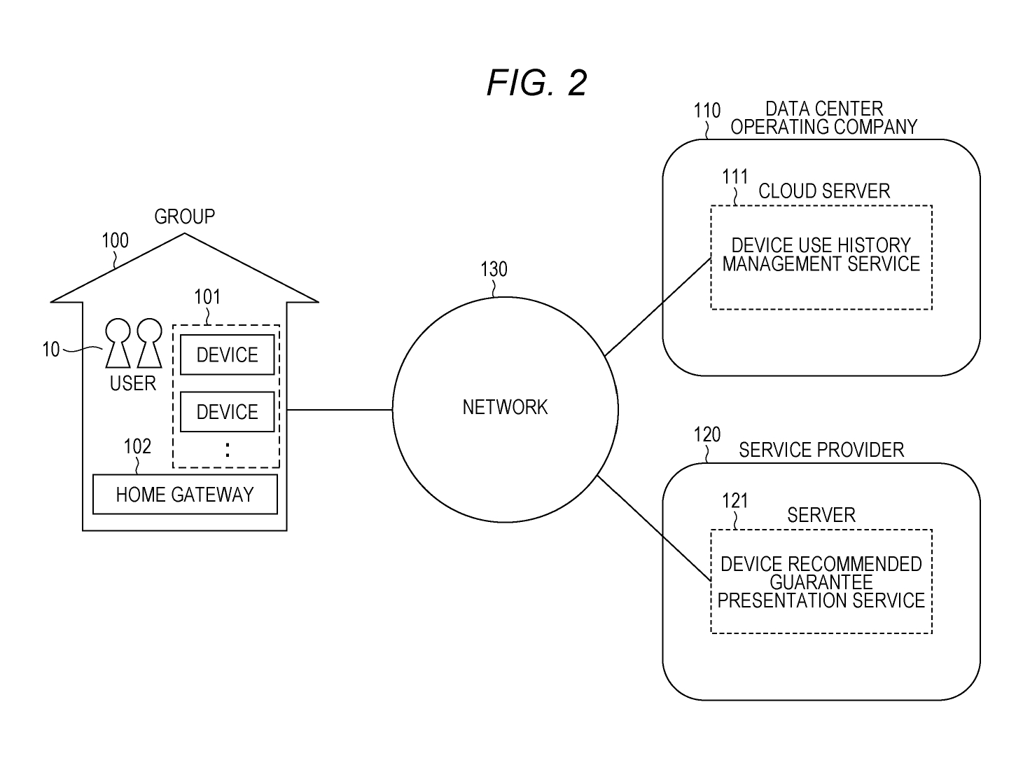

FIG. 2 illustrates a configuration of a recommended guarantee content presentation system according to the first exemplary embodiment. As illustrated in FIG. 2, the recommended guarantee content presentation system of the first exemplary embodiment includes the plurality of devices 101 and home gateway 102 that are used by user 10 of group 100, cloud server 111 of data center operating company 110, server 121 of service provider 120, and network 130 (such as the Internet) that connects the servers to one another.

Cloud server 111 of data center operating company 110 acquires and manages the use history information corresponding to each of the plurality of devices 101 of user 10, and provides to service provider 120 service (hereinafter referred to as “device use history management service”) to provide the acquired use history information corresponding to each of the plurality of devices 101 of user 10 or the information in which the pieces of use history information corresponding to each of the plurality of devices 101 are organized. In the device use history management service, the acquired use history information corresponding to each of the plurality of devices 101 or the information in which the pieces of use history information corresponding to each of the plurality of devices 101 are organized may be provided to user 10.

Based on the use history information about each of the plurality of devices of user 10 acquired from cloud server 111 of data center operating company 110, server 121 of service provider 120 decides the recommended guarantee content of each of the plurality of devices, and provides to user 10 service (hereinafter referred to as “device recommended guarantee presentation service”) to present the recommended guarantee content.

In this case, although the term of the plurality of devices 101 is used, the plurality of devices 101 may be one device as described above.

FIG. 2 illustrates the case where one group 100, one cloud server 111, and one server 121 are connected to network 130. However, the recommended guarantee content presentation system is not limited to the configuration in FIG. 2. For example, the plurality of groups, the cloud servers of the plurality of data center operating companies and the servers of the plurality of service providers may be connected to network 130. The data center operating company may be identical to the service provider.

It is assumed that the device use history management service and the device recommended guarantee presentation service coordinate with each other in user's agreement. The coordination between both the services is described in detail later.

<Detailed Configuration of Group 100>

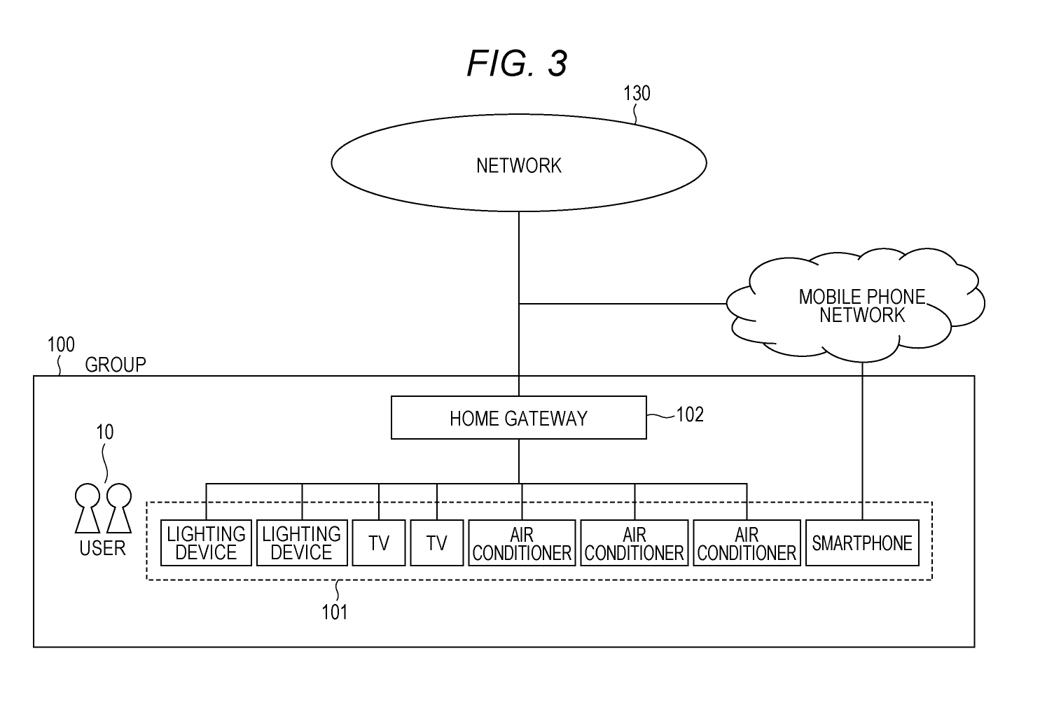

FIG. 3 illustrates a detailed configuration of group 100. As illustrated in FIG. 3, the plurality of devices 101 (two lighting devices, two television sets, three air conditioners, and one smartphone) used by user 10 exist in group 100.

In the plurality of devices 101, it is assumed that each television set includes the LAN connecting function, that each television set is connected to home gateway 102 using the LAN connecting function, and that each television set is connected to the Internet, which is an example of network 130, through home gateway 102.

It is assumed that each lighting device or each air conditioner includes the wireless communication functions such as an infrared ray, Bluetooth (registered trademark), and specified lower power radio, that the lighting device or the air conditioner is connected to home gateway 102 using the wireless communication functions, and that the lighting device or the air conditioner is connected to the Internet through home gateway 102. It is assumed that the smartphone includes the function of communicating with the 3G or LTE mobile phone network, that the smartphone is connected to the mobile phone network using the communication function, and that the smartphone is connected to the Internet via the mobile phone network. Means for connecting to the Internet as described herein are described by way of example, and each device may be connected to the Internet via another means.

In the plurality of devices 101, the two lighting devices, the two television sets, and the three air conditioners are registered in the device use history management service provided by cloud server 111 of data center operating company 110, connected to the Internet, which is network 130, through the network connecting function, and each transmit the use history information to cloud server 111 of data center operating company 110 via network 130. The registration of each device in the device use history management service provided by cloud server 111 of data center operating company 110 is described in detail later.

<Detailed Configuration of Cloud Server 111 of Data Center Operating Company 110>

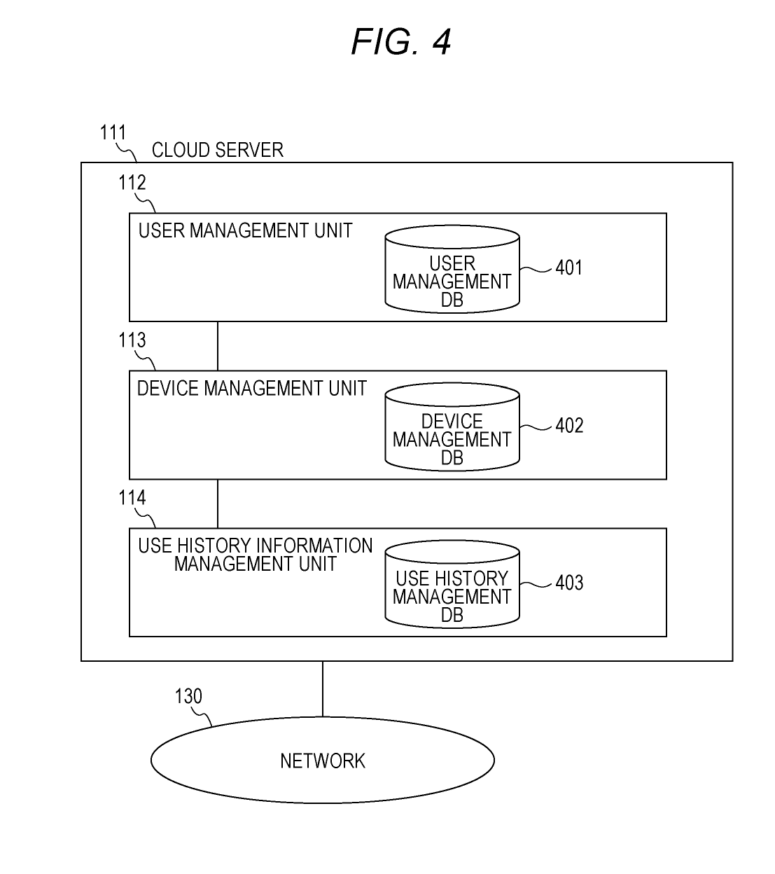

FIG. 4 illustrates a detailed configuration of cloud server 111 of data center operating company 110.

As illustrated in FIG. 4, cloud server 111 of data center operating company 110 includes user management unit 112, device management unit 113, and use history information management unit 114.

User management unit 112 includes user management database (hereinafter referred to as a user management DB) 401, and user management DB 401 manages information about the user that is registered to use the device use history management service. A configuration of user management DB 401 is described later.

Device management unit 113 includes device management database (hereinafter referred to as a device management DB) 402, and device management DB 402 manages information about the device that is registered as a target device of the device use history management service. A configuration of device management DB 402 is described later.

Use history information management unit 114 includes use history management database (hereinafter referred to as a use history management DB) 403, and use history management DB 403 manages the use history information about the device that is registered as the target device of the device use history management service. A configuration of use history management DB 403 is described later.

<Detailed Configuration of Service Provider 120>

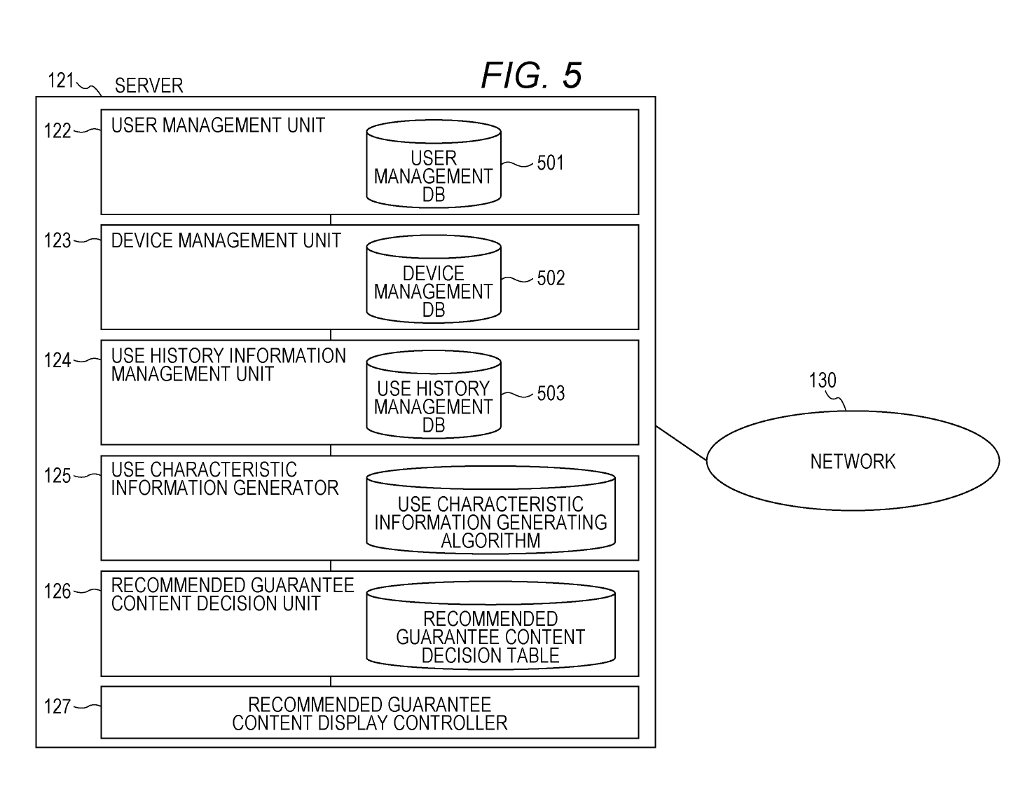

FIG. 5 illustrates a detailed configuration of server 121 of service provider 120.

As illustrated in FIG. 5, server 121 of service provider 120 includes user management unit 122, device management unit 123, use history information management unit 124, use characteristic information generator 125, recommended guarantee content decision unit 126, and recommended guarantee content display controller 127.

User management unit 122 includes user management database (hereinafter referred to as a user management DB) 501. User management DB 501 manages information about the user who agrees with the coordination with the device recommended guarantee presentation service provided by service provider 120, among the users registered in the device use history management service provided by data center operating company 110. A configuration of user management DB 501 is described later.

Device management unit 123 includes device management database (hereinafter referred to as a device management DB) 502. Device management DB 502 manages information about the device of the user who agrees with the coordination with the device recommended guarantee presentation service provided by service provider 120, among the users registered in the device use history management service provided by data center operating company 110. A configuration of device management DB 502 is described later.

Use history information management unit 124 includes use history management database (hereinafter referred to as a use history management DB) 503. Use history management DB 503 manages the use history information about the device of the user who agrees with the coordination with the device recommended guarantee presentation service provided by service provider 120, among the users registered in the device use history management service provided by data center operating company 110. A configuration of use history management DB 503 is described later.

At this point, it is assumed that user 10 agrees with the coordination between the device use history management service provided by data center operating company 110 and the device recommended guarantee presentation service provided by service provider 120 to thereby transmit, to server 121 of service provider 120, the information about user 10, the information about the plurality of devices 101 of user 10, and the use history information about each of the plurality of devices 101, the pieces of information being managed by cloud server 111 of data center operating company 110.

In this case, service provider 120 manages the information about the user who agrees with the coordination with the device recommended guarantee presentation service provided by service provider 120, among the users registered in the device use history management service provided by data center operating company 110. However, service provider 120 is not limited to the above configuration. For example, service provider 120 may manage the information about the user who agrees with the coordination with the device use history management service provided by data center operating company 110 among the users registered in the device recommended guarantee presentation service provided by service provider 120.

Use characteristic information generator 125 includes a use characteristic information generating algorithm that generates use characteristic information about the target device concerning a predetermined use condition defined in each type of the device, and generates the use characteristic information about the device from the use history information about the device by using the use characteristic information generating algorithm. The use characteristic information generating algorithm is described later. The type of the device is a name used to classify the device by focusing on a main function of the device. Examples of the type of the device include a washing machine and a refrigerator.

Recommended guarantee content decision unit 126 includes a recommended guarantee content decision table in each type of the device, and decides the recommended guarantee content of the device based on the generated use characteristic information about the device by using the recommended guarantee content decision table. The recommended guarantee content decision table is described later.

Recommended guarantee content display controller 127 performs control to display the generated use characteristic information about the device and the decided recommended guarantee content about the device to user 10.

<Processing Flow of Device Use History Management Service Provided by Data Center Operating Company 110>

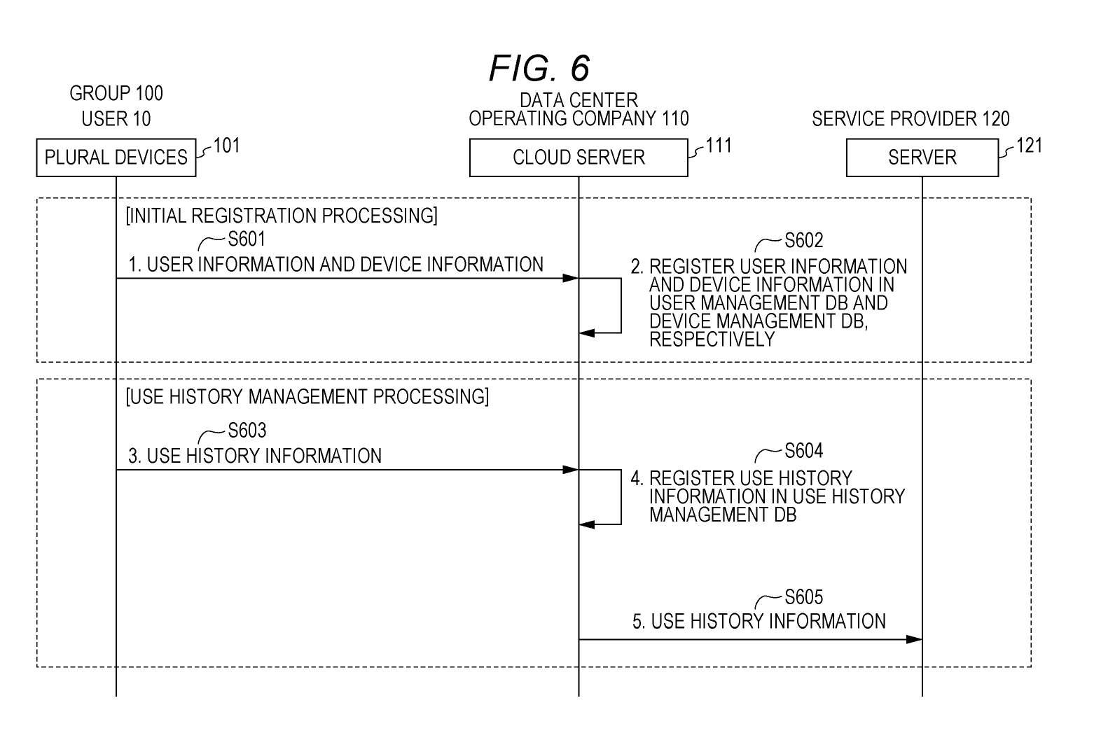

A processing flow of the device use history management service provided by data center operating company 110 will be described below with reference to FIG. 6.

[Initial Registration Processing]

(1) For example, user 10 (in a case where the device is used by the plurality of users (for example, three users: a husband, a wife, and a child), a representative (for example, the husband)) of group 100 accesses an initial registration screen of the device use history management service provided by cloud server 111 of data center operating company 110 by using an information input device such as the smartphone in the plurality of devices 101, and inputs, according to the initial registration screen, the information on user 10 (user information and password) and the information on the plurality of devices 101 (the two lighting devices, the two television sets, and the three air conditioners) used by user 10 (device information), the pieces of information being registered in the device use history management service (S601).

(2) Cloud server 111 of data center operating company 110 registers the input user information and password in user management DB 401, and registers the input device information in device management DB 402 (S602).

The initial registration processing as described herein is an example, but the initial registration processing is not limited to the configuration in FIG. 6.

[Use History Management Processing]

(3) Each of the plurality of devices 101 of user 10 transmits the use history information about each of the plurality of devices 101 to cloud server 110 of data center operating company 110 at a predetermined time (S603). For example, the use history information may be transmitted each time of the use, or the pieces of use history information in a constant period may collectively be transmitted on a regular basis (for example, the pieces of use history information on previous day are collectively transmitted at midnight every day). The pieces of use history information in a predetermined period may collectively be transmitted on an irregular basis. The use history information may be transmitted upon request from cloud server 110.

(4) Cloud server 111 registers the use history information received from each of the plurality of devices 101 of user 10 in use history management DB 403 (S604).

(5) Cloud server 111 transmits the use history information received from each of the plurality of devices 101 of user 10 managed by cloud server 111 to server 121 of service provider 120 in the case where user 10 agrees with the coordination between the device use history management service provided by data center operating company 110 and the device recommended guarantee presentation service provided by service provider 120. The pieces of use history information in a constant period may collectively be transmitted on a regular basis. The pieces of use history information in a predetermined period may collectively be transmitted on an irregular basis. The use history information may be transmitted upon request from service provider 120.

In S603, each of the plurality of devices 101 of user 10 transmits the use history information to home gateway 102, home gateway 102 temporarily manages the use history information, and home gateway 102 may transmit the use history information about each of the plurality of devices 101 to cloud server 110 of data center operating company 110, the use history information about each of the plurality of devices 101 being managed at a predetermined time.

[User Management DB 401 of Data Center Operating Company 110]

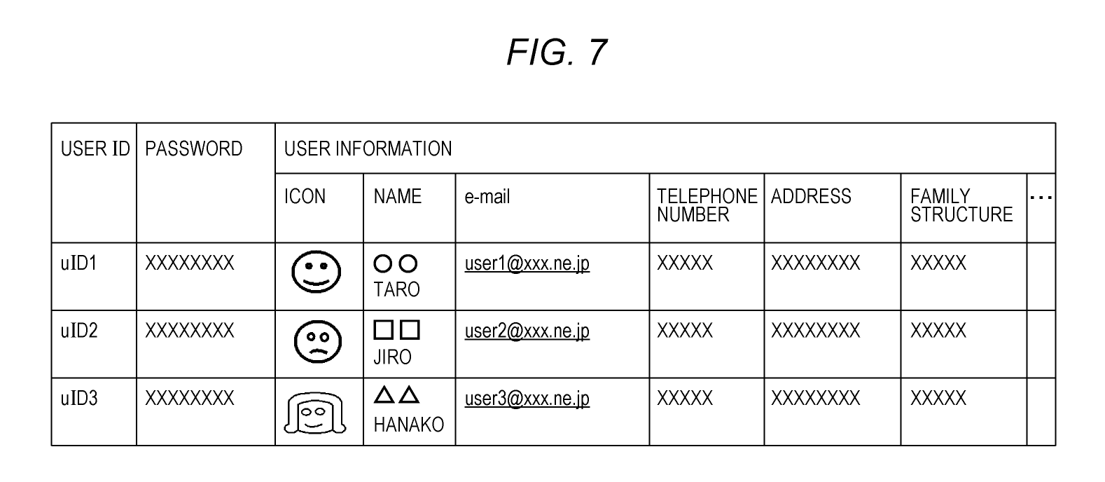

FIG. 7 illustrates an example of the user management table managed by user management DB 401 of data center operating company 110. As illustrated in FIG. 7, the user management table of data center operating company 110 includes a user ID, a password, and the information about a user (user information).

<Supplements of User ID, Password, and User Information>

1) The user ID is information uniquely identifying the user in the device use history management service provided in cloud server 111. For example, the user ID is an arbitrary character string set by the service. Although it is assumed that the user ID is set by the service, the user ID is not limited to the configuration. For example, the user may set unique information in the service to the user ID (for example, user name, nickname, and electronic mail address and the like). In a case where the device use history management service coordinates with another service or application, the user ID may be acquired from another service or application.

2) The password is information, which is used to authenticate the user by the device use history management service and secretly retained by the user. The password is alphanumeric characters satisfying a predetermined condition (for example, at least eight alphanumeric characters). The password is set and registered by the user. It is assumed that the service authenticates the user based on the user ID and the password. Although it is assumed that the user is authenticated using the user ID and the password, the user authentication is not limited to the configuration. For example, the user may be authenticated using hardly-changeable information (for example, biological information such as fingerprint) unique to the user instead of the password.

3) Examples of the user information include an icon that is an image such as a photograph of a user's face, the user name, the electronic mail address, a telephone number, an address, a family structure (for example, family of four), a relationship in the family (for example, whether the user is a head of household, or a relationship to the head of household), an age, gender, a taste, and preference. The user information may include information (group ID) identifying a group (such as a family) to which the user belongs. It is assumed that the user information is basically registered by the user. In the case where the device use history management service coordinates with another service, the user information may be acquired from another service. The device use history management service may register the user information based on the acquired use history information about the device. For example, based on a television viewing history, the taste and the preference of the user may be estimated to register the user information. The information about the family structure of the user or the relationship of the user in the family may be acquired from the use history information about a body composition meter and the like to register the user information.

[Device Management DB 402 of Data Center Operating Company 110]

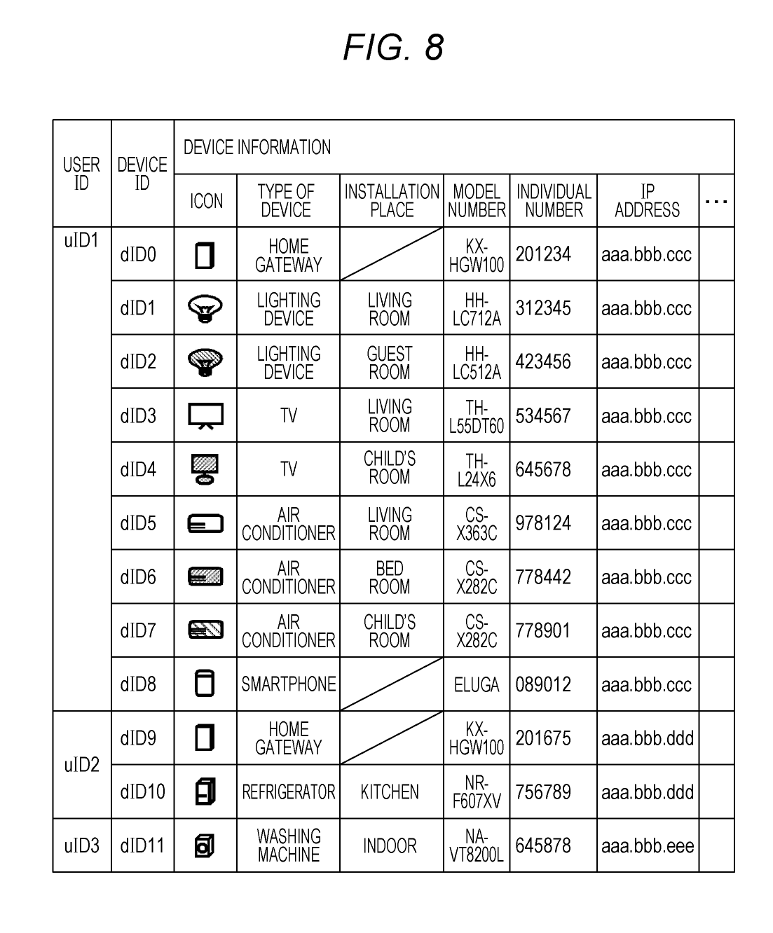

FIG. 8 illustrates an example of the device management table managed by device management DB 402 of data center operating company 110. As illustrated in FIG. 8, the device management table includes the user ID, a device ID, and information about the device (device information).

<Supplements of User ID, Device ID, and Device Information>

1) As described above, the user ID is the information that is issued by the device use history management service in order to uniquely identify the user in the service.

2) The device ID is the information uniquely identifying the device in the device use history management service. For example, the device ID is an arbitrary character string set by cloud server 111 providing the device use history management service. Although it is assumed that the device ID is set by the device use history management service, the device ID is not limited to the configuration. For example, the device ID may be a serial number of each device. Cloud server 111 may acquire the device ID in a manner such that the user registers the device ID, or cloud server 111 may acquire the device ID from the use history information.

3) Examples of the device information include an icon that is an image or illustration expressing each device, the type of the device (such as the lighting device, the television set, the air conditioner, the refrigerator, and the home gateway), information expressing an installation place of the device (such as a living room, a guest room, a bed room, a child room, indoor, and outdoor), a model number and an individual number of the device, information such as an IP address, which expresses a location of the device on the network, a device manufacturer name, device performance, version numbers of an OS of the device and the functional module, a part number, a model name, a model brand name, a model series name, a model category name (genre name), manufacturing place of the device, a manufacturing factory, a manufacturing date, manufacturing lot information, use environment information (temperature and humidity around the device and a degree of dirt of ambient air), and an update content and update day of the functional module of the device. Cloud server 111 may acquire the device information in a manner such that the user registers the device information, or cloud server 111 may automatically register the device information using the use history information.

4) The user does not necessarily set all the pieces of device information. For example, the user sets the IP address of home gateway 102, and the device use history management service may access home gateway 102 based on the set IP address to acquire the information (such as the model number and the individual number) about home gateway 102 and the information (such as the model number, the individual number, and the IP address of the device) about each of the plurality of devices 101 connected to home gateway 102 through home gateway 102. The device use history management service may include a device DB that can search the device information from the acquired model number or individual number of each device, and search the device DB to acquire and register the device information corresponding to the model number or individual number of each device. At this point, for example, the device DB is configured to be able to search the type of the device, the device manufacturer name, the device performance, the version numbers of an OS of the device and the functional module, the part number, the model name, the model brand name, the model series name, the model category name (genre name), the manufacturing place of the device, the manufacturing factory, the manufacturing date, and the manufacturing lot information from the model number or individual number of the device.

5) In the case where the device use history management service coordinates with another service or application, the device information may be acquired from another service or application. For example, the data center operating company may acquire the installation place information about the device and the use environment information about the device, which are managed by the device use history management service, from another device management service.

[Device Use History Management DB 403 of Data Center Operating Company 110]

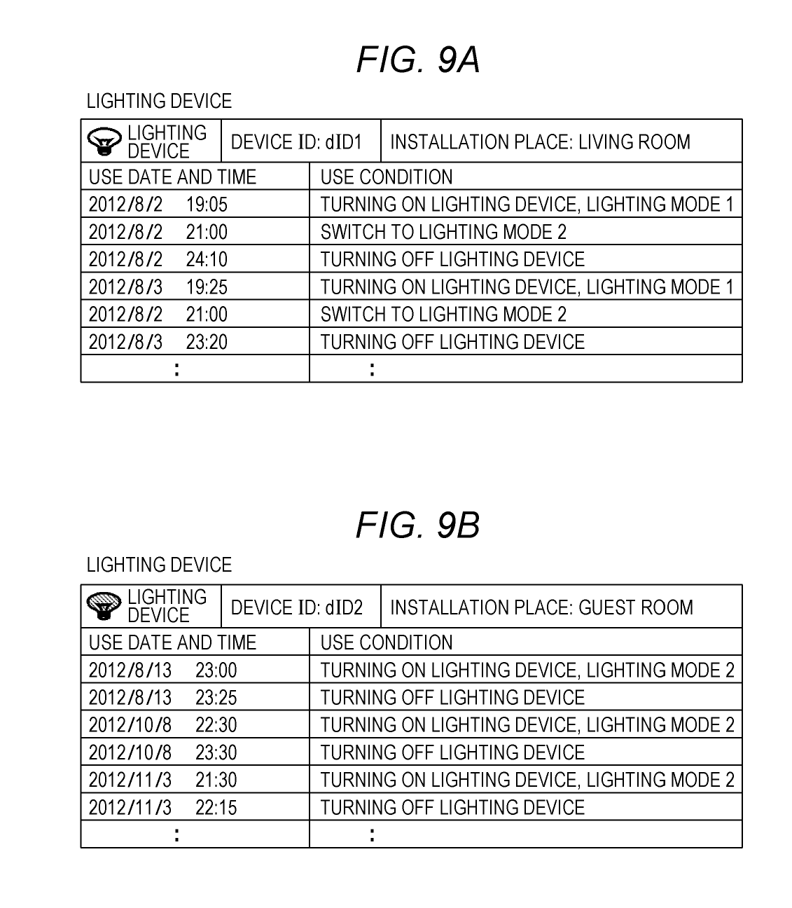

FIGS. 9A and 9B illustrate examples of a use history management table managed by use history management DB 403 of data center operating company 110 with the lighting device as an example. FIG. 9A illustrates the use history management table of the lighting device having the device ID of dID1, and FIG. 9B illustrates the use history management table of the lighting device having the device ID of dID2.

As illustrated in FIGS. 9A and 9B, each of the use history management tables of the lighting devices includes the icon expressing the lighting device, the device ID of the lighting device, the installation place of the lighting device, and the use date and time and the use condition of the lighting device.

The use condition of the lighting device includes turning on/off the lighting device and a lighting mode (for example, the lighting mode includes a lighting mode 1 for a regular life, a lighting mode 2 for relaxation before sleep, and a lighting mode 3 for a study room) in which the lighting device is controlled according to various scenes.

<Operational Flow of Device Recommended Guarantee Presentation Service Provided by Service Provider 120>

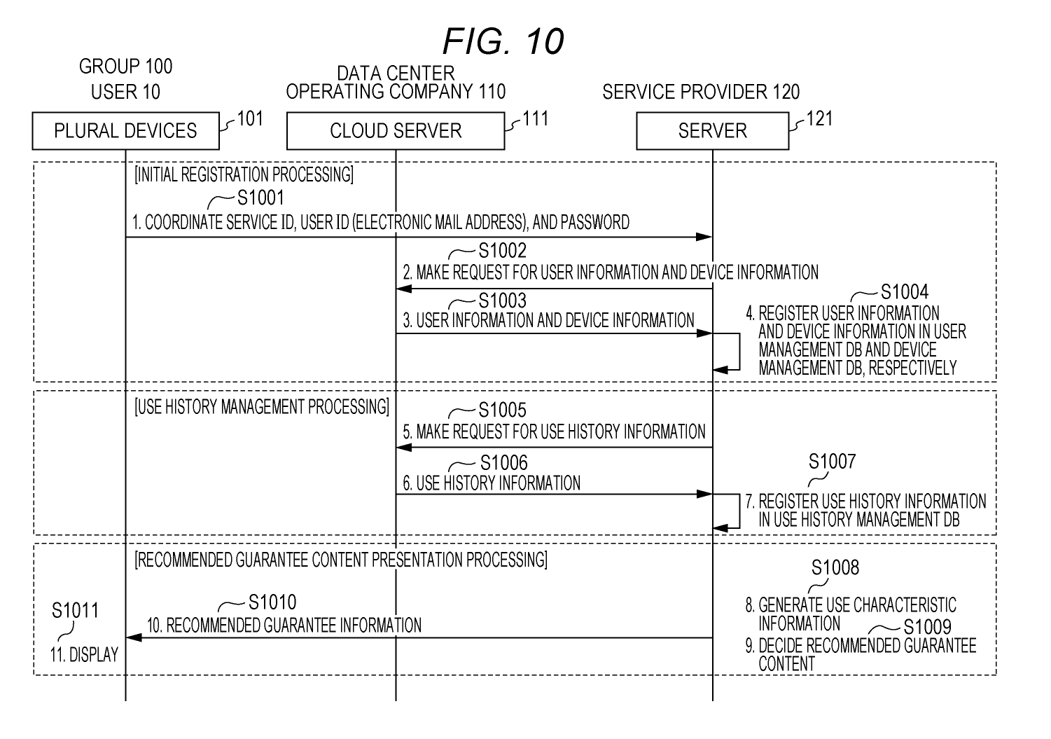

FIG. 10 illustrates a processing flow of the device recommended guarantee presentation service provided by server 121 of service provider 120.

[Initial Registration Processing]

(1) User 10 of group 100 accesses the initial registration screen of the device recommended guarantee presentation service provided by server 121 of service provider 120 by using the information input device such as the smartphone, registers a coordination service ID, which is the information uniquely identifying the coordinated device use history management service, according to the initial registration screen, and inputs the user ID (or electronic mail address) and password that are registered in the device use history management service (S1001).

Using the identical user ID and password, the user registered in the device use history management service provided by data center operating company 110 registers the information in the device recommended guarantee presentation service provided by service provider 120 in coordination with the device use history management service.

(2) Server 121 of service provider 120 transmits the user ID (or electronic mail address) and password that are input by user 10 to cloud server 111 providing the coordinated device use history management service in which user 10 registers, and makes a request for the user information about user 10 and the device information about each of the plurality of devices 101, the pieces of information being managed by the device use history management service (S1002).

(3) Cloud server 111 of data center operating company 110 transmits the user information about user 10 and the device information about each of the plurality of devices 101 that are requested from server 121 of service provider 120 to server 121 of service provider 120 (S1003).

(4) Server 121 of service provider 120 registers the user information about user 10 received from cloud server 111 of data center operating company 110 in user management DB 501, and registers the device information about each of the plurality of devices 101 received from cloud server 111 in device management DB 502 (S1004).

[Use History Management Processing]

(5) Server 121 of service provider 120 makes a request for the use history information about each of the plurality of devices 101 of user 10 to cloud server 111 of data center operating company at a predetermined time (S1005).

(6) Cloud server 111 of data center operating company 110 transmits the use history information about each of the plurality of devices 101 of user 10 requested from server 121 of service provider 120 to server 121 of service provider 120 (S1006).

(7) Server 121 of service provider 120 receives the use history information about each of the plurality of devices 101, and registers the use history information about each of the plurality of devices 101 in use history management DB 503 (S1007).

[Recommended Guarantee Content Providing Processing]

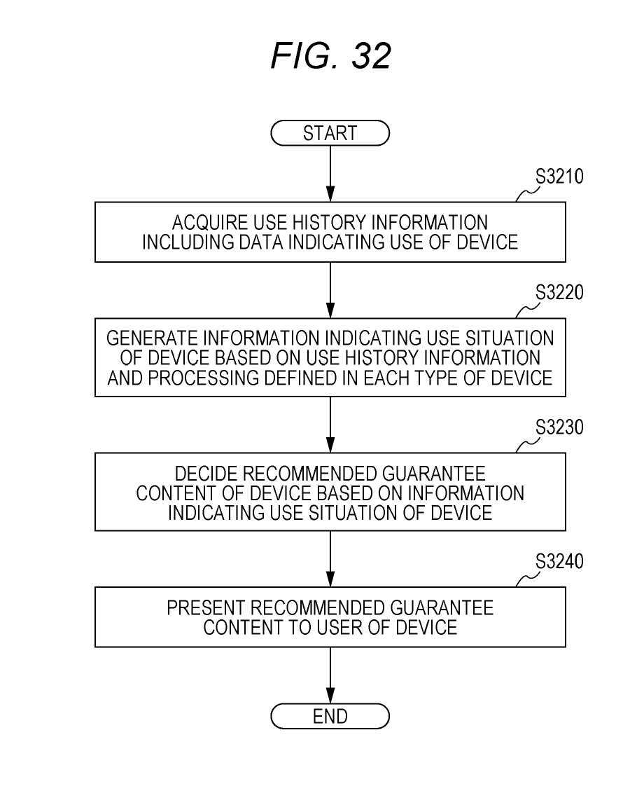

FIG. 32 is a flowchart illustrating a presentation flow of the recommended guarantee content.

The use history information including the data indicating the use of the device is acquired (S3210). The information indicating the use situation of the device is generated based on the use history information and the processing defined in each type of the device (S3220). The recommended guarantee content of the device is decided based on the information indicating the use situation of the device (S3230). Finally, the recommended guarantee content and the like are presented to the user of the device (S3240). The details are as follows.

(8) As to the processing defined in each type of the device, server 121 of service provider 120 generates the use characteristic information about the target device as an example of the information indicating the use situation of the device, at a predetermined time, for example, a time point 10 months elapse from the purchase date of the device, according to the use history information about the device in a predetermined period, for example, 10 months from the purchase date of the device, by using a predetermined use characteristic information generating algorithm defined in each type of the device (S1008). The use characteristic information generating algorithm is described later.

(9) Using a predetermined recommended guarantee content decision table defined in each type of the device, server 121 of service provider 120 decides the recommended guarantee content based on the generated use characteristic information (S1009). The recommended guarantee content decision table is described later.

(10) Based on the decided recommended guarantee content, server 121 of service provider 120 generates the recommended guarantee information including an expiration date, and notifies an information output device such as the smartphone of user 10 of the recommended guarantee information including the expiration date (for example, the recommended guarantee in which the guarantee contract is valid for one year from the purchase date) (S1010).

(11) The information output device such as the smartphone of user 10 displays the recommended guarantee information including the expiration date that is received from server 121 of service provider 120 (S1011).

With this configuration, user 10 can determine whether to apply for the guarantee (extended guarantee) of the device after user 10 confirms the recommended guarantee content including the expiration date with respect to the device registered in device recommended guarantee presentation service.

In the example, the use history information about the target device in the predetermined period is used to generate the use characteristic information and the predetermined period is set to 10 months from the purchase date of the device. However, the predetermined period is not limited to 10 months from the purchase date of the device. For example, the predetermined period may be set to any period within one year from the purchase date of the device. A starting day of the predetermined period may be set to a use starting day of the device.

The use history information is acquired with a specific period in a period until the end of a manufacturer guarantee period from the purchase of the device as a target, and the information indicating the degree of use of the device in the specific period may be generated to decide the recommended guarantee content. Before the end of the guarantee period of the manufacturer guarantee, the generated information indicating the degree of use of the device may be presented to the user of the device together with the decided recommended guarantee content.

For example, the manufacturer guarantee is one year from the purchase of the device, the specific period is six months from the purchase of the device, and the information indicating the degree of use of the device may be presented to the user of the first device together with the recommended guarantee content in the seventh month from the purchase of the device.

As described above, the guarantee period of the manufacturer guarantee provided by the device manufacturer may be set to a constant period from the purchase date of the device, for example, one year from the purchase of the device. The guarantee period of the extended guarantee provided by a device distributor may be set to a predetermined period after the expiration of the manufacturer guarantee, for example, the guarantee period of the extended guarantee may be started from 1 year after the purchase of the device and ended after 5 years from the purchase of the device. The extended guarantee is set to a first extended guarantee, and a second extended guarantee may be provided after the expiration of the first extended guarantee. In the example, the period of the second extended guarantee may be started from 5 years after the purchase of the device and ended after 8 years from the purchase of the device.

The use history information is acquired with a specific period (for example, for 2 years from the starting of the initial extended guarantee period) in the initial extended guarantee period (for example, 4 years) as the target, and the information indicating the degree of use of the device may be generated based on the use history information to decide the recommended guarantee content in the second extended period. Before the end of the period of the initial extended guarantee (for example, after 2 years and 1 month from the starting of the initial extended guarantee period), the generated information indicating the degree of use of the device may be presented to the user of the device together with the recommended guarantee content in the decided second extended period.

[User Management DB 501 of Service Provider 120]

A user management table managed by user management DB 501 of service provider 120 is acquired from the user management DB. The user management DB is managed by the cloud server (for example, cloud server 111 of data center operating company 110 for user 10) of the data center operating company coordinating with each user.

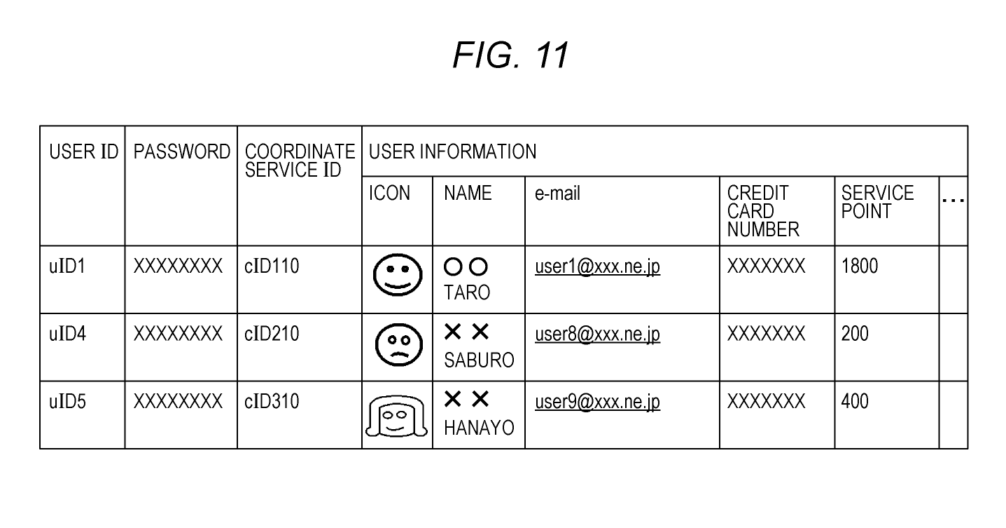

FIG. 11 illustrates an example of the user management table managed by the user management DB of service provider 120. As illustrated in FIG. 11, the user management table of service provider 120 includes the user ID, the password, the coordination service ID, and the user information.

At this point, most pieces of information about the user ID, the password, and the user are substantially identical to those managed by the user management DB of cloud server 111 of data center operating company 110, and therefore the description is not given. The following point differs from the information managed by the user management DB of data center operating company 110.

<Coordination Service ID>

1) The coordination service ID is information identifying the device use history management service of the data center operating company, to which the user coordinates with the device recommended guarantee presentation service. The user information about the user and the device information about the device used by the user are acquired from the device use history management service of the data center operating company, the device use history management service being identified by the coordination service ID.

2) For example, user 10 has the coordination service ID of “cID110” in FIG. 11, and it is assumed that the coordination service ID of “cID110” expresses that user 10 coordinates with the device use history management service of data center operating company 110.

<User Information>

1) The user information is managed by the user management DB of data center operating company 110, and the user information may include unique information in the device recommended guarantee presentation service provided by service provider 120 in addition to the user information acquired from cloud server 111 of data center operating company 110. For example, the user information may include credit card number information used by each user in order to pay the guarantee fee and a service point provided by the device recommended guarantee presentation service. The service point is described in detail in a second exemplary embodiment.

[Device Management DB 502 of Service Provider 120]

A device management table managed by the device management DB of service provider 120 is acquired from the device management DB managed by the cloud server (for example, cloud server 111 of data center operating company 110 for user 10) of the data center operating company, each user coordinating with the device management DB.

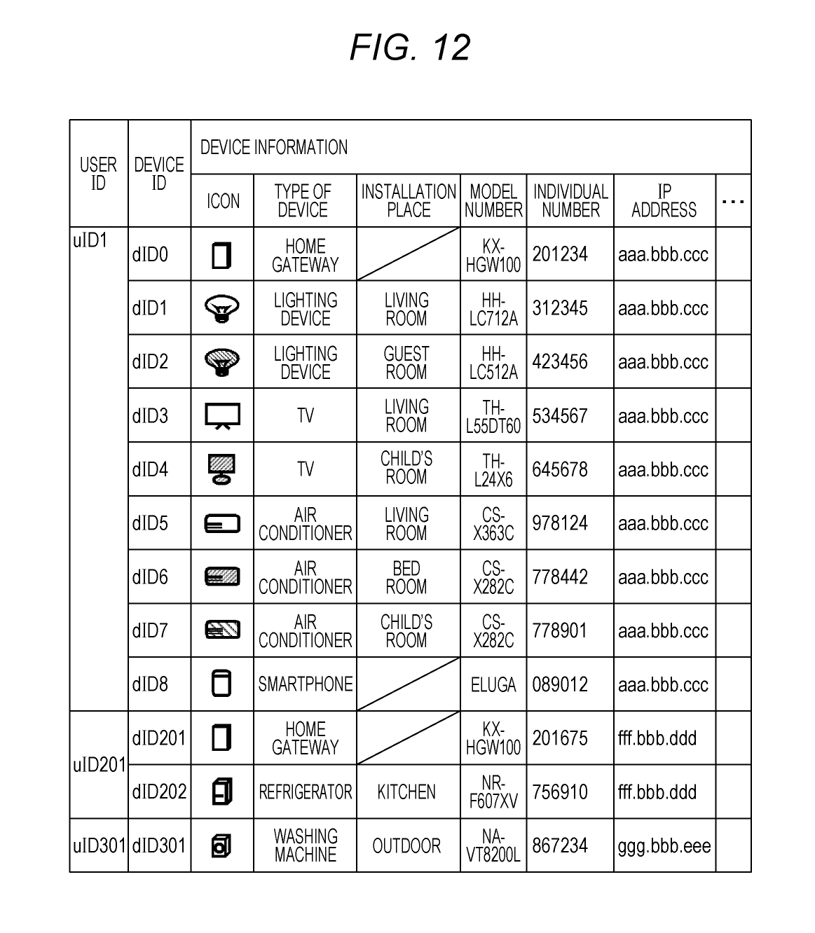

FIG. 12 illustrates an example of the device management table managed by the device management DB of service provider 120. As illustrated in FIG. 12, the device management table of service provider 120 includes the user ID, the device ID, and the information about the device (device information).

At this point, most pieces of information about the user ID, the device ID, and the device are substantially identical to those managed by the device management DB of data center operating company 110, and therefore the description is not given. The following point differs from the information managed by the device management DB of data center operating company 110.

<Device Information>

1) The device information is managed by the device management DB of data center operating company 110, and the device information may include unique information in the device recommended guarantee presentation service provided by service provider 120 in addition to the device information acquired from cloud server 111 of data center operating company 110. For example, the already-contracted guarantee content (the guarantee fee, the guarantee period, and the guarantee coverage) of the device and the purchase date of the device may be included as the device information. In the case where the device recommended guarantee presentation service coordinates with on-line sales service with which the device is sold, the purchase date of the device may be acquired from the on-line sales service with which the device is sold.

[Use History Management DB 503 (S3210) of Service Provider 120]

A use history information management table managed by the use history management DB of service provider 120 is acquired, based on the device ID, from the use history management DB managed by the cloud server (for example, cloud server 111 of data center operating company 110 for user 10) of the data center operating company, each user coordinating with the use history management DB. The data configuration of the use history management DB of service provider 120 is identical to that of use history information management table (see FIGS. 9A and 9B) managed by the use history management DB of data center operating company 110, and therefore the description is not given.

[Use Characteristic Information Generating Algorithm of Service Provider 120 and Use Characteristic Information Example (S3220)]

Use characteristic information generator 125 of server 121 of service provider 120 includes the use characteristic information generating algorithm generating the use characteristic information about the target device concerning a predetermined use condition defined in each type of the device, and inputs the use history information about the target device to the use characteristic information generating algorithm to generate the use characteristic information about the device.

The type of the device corresponding to the device ID of the target device is identified using the device management table (FIG. 8), and the use characteristic information generating algorithm corresponding to the target device may be identified in the plurality of use characteristic information algorithms included in the use characteristic information generator 125 by using the identified type of the device.

As described above, the use characteristic information generating algorithm is provided in each type of the device. Specifically, the use characteristic information generating algorithm may be provided in each of types of home appliances such as the lighting device, the television set, and the air conditioner, each of categories of the home appliances such as a home electric appliance, a digital home appliance, and a health and beauty home appliance, or each of models of the home appliances.

As described above, the use characteristic information generating algorithm generates the use characteristic information about the target device with respect to the predetermined use condition defined in each type of the device. Specifically, the use characteristic information generating algorithm may generate the use characteristic information (for example, an average use frequency of the use condition) about the target device with respect to the use condition in which a product life of the target device is shortened (or a failure of the target device is possibly generated). Alternatively, the use characteristic information generating algorithm may generate the use characteristic information (for example, the average use frequency of the use condition) about the target device with respect to the use condition in which the product life of the target device is prolonged (or the failure of the target device is hardly generated).

The use characteristic information generating algorithm will be described below with the lighting device as an example.

In the use characteristic information generating algorithm for the lighting device, the use history information about the lighting device in FIGS. 9A and 9B included in the use history management DB of service provider 120 is used as input data, 1) the number of days during each of which a lighting time is less than 1 hour in each use month, 2) the number of days during each of which the lighting time is greater than or equal to 1 hour and less than 20 hours in each use month, 3) the number of days during each of which the lighting time is greater than or equal to 20 hours in each use month, and the monthly average number of days of the items 1) to 3) are obtained as the use characteristic information about the lighting device, and are output as output data.

In the use characteristic information generating algorithm, the use condition “the lighting time is less than 1 hour per day” is an example of the use condition in which the life of the lighting device is prolonged, and the use condition “the lighting time is greater than or equal to 20 hours per day” is an example of the use condition in which the life of the lighting device is shortened. “The monthly average number of days during each of which the lighting time is less than 1 hour” is an example of the use characteristic information (average use frequency) about the use condition.

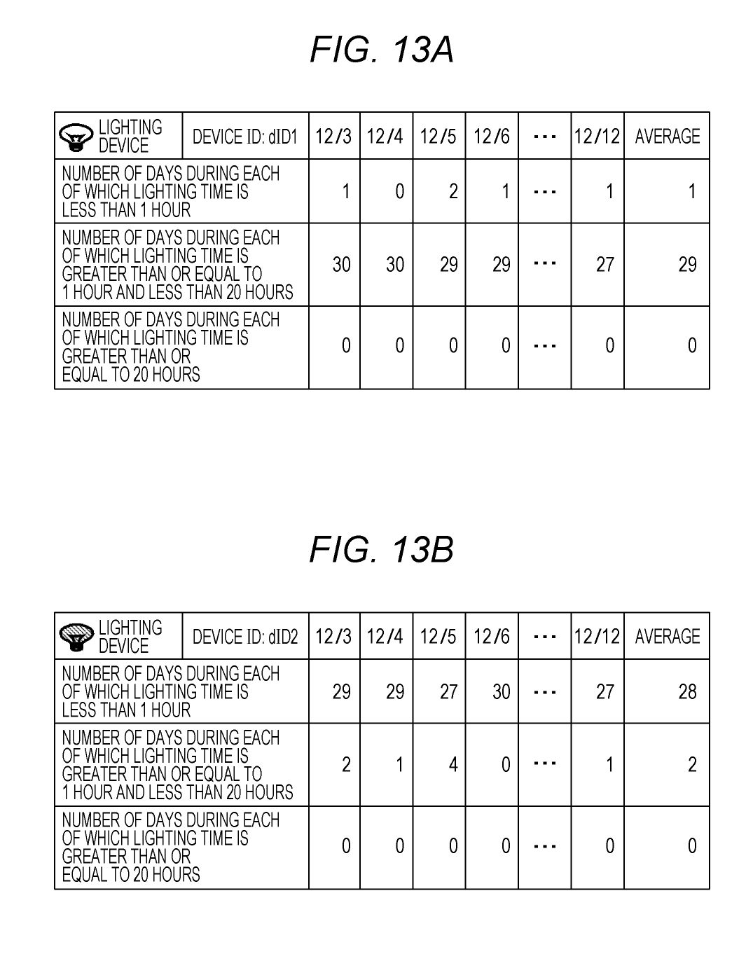

FIGS. 13A and 13B illustrate examples of the use characteristic information about the lighting device that is generated using the use characteristic information generating algorithm for the lighting device. FIG. 13A illustrates the use characteristic information about the lighting device having the device ID of dID1. In FIG. 13A, for example, the use of March, 2012 is as follows.
The number of days during each of which a lighting time is less than 1 hour is 1.
The number of days during each of which the lighting time is greater than or equal to 1 hour and less than 20 hours is 30.
The number of days during each of which the lighting time is greater than or equal to 20 hours is 0. The monthly average number of days for 10 months from March, 2012 to December, 2012 is as follows.
The monthly average number of days during each of which the lighting time is less than 1 hour is 1.
The monthly average number of days during each of which the lighting time is greater than or equal to 1 hour and less than 20 hours is 29.
The monthly average number of days during each of which the lighting time is greater than or equal to 20 hours is 0.

The three monthly average numbers of days for 10 months may be used as the information indicating the use situation that is the degree of use of the lighting device identified by the device ID of dID1.

FIG. 13B illustrates the use characteristic information about the lighting device having the device ID of dID2. For example, the monthly average number of days for 10 months from March, 2012 to December, 2012 is as follows.
The monthly average number of days during each of which the lighting time is less than 1 hour is 28.
The monthly average number of days during each of which the lighting time is greater than or equal to 1 hour and less than 20 hours is 2.
The monthly average number of days during each of which the lighting time is greater than or equal to 20 hours is 0.

The three monthly average numbers of days for 10 months may be used as the information indicating the use situation that is the degree of use of the lighting device identified by the device ID of dID2.

[Detail (S3230) of Recommended Guarantee Content Decision Processing of Service Provider 120]

Recommended guarantee content decision unit 126 of server 121 of service provider 120 includes a recommended guarantee content decision table for the device in each type of the device, and decides the recommended guarantee content of the device by using the recommended guarantee content decision table.

As described above, the recommended guarantee content decision table is provided in each type of the device. Specifically, the recommended guarantee content decision table may be provided in each of types of the home appliances such as the lighting device, the television set, and the air conditioner. The recommended guarantee content decision table may be provided in each of categories of the home appliances such as the home electric appliance, the digital home appliance, and the health and beauty home appliance.

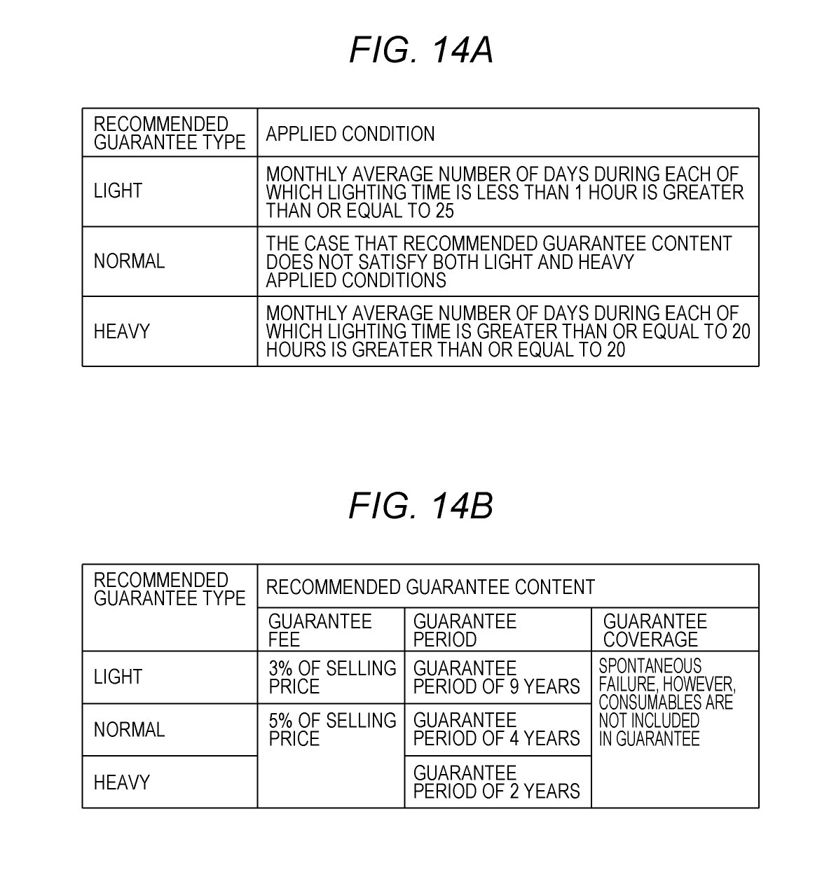

FIGS. 14A and 14B illustrate examples of tables used to decide the recommended guarantee content of the lighting device.

FIG. 14A illustrates a table (an auxiliary table used to decide the recommended guarantee content) used to decide a recommended guarantee type of the lighting device based on the use characteristic information about the lighting device. That is, it is decided which one of the recommended guarantee types (light, normal, and heavy) of the table in FIG. 14A corresponds to the use characteristic information (the monthly average number of days of each lighting time) about each lighting device.

FIG. 14B illustrates a table (recommended guarantee content decision table) used to decide the recommended guarantee content according to the decided recommended guarantee type.

As illustrated in FIG. 14B, the guarantee fee (3% of selling price) of the light recommended guarantee type is set cheaper than the guarantee fee (5% of selling price) of the normal or heavy recommended guarantee type. The guarantee period (9 years) of the light recommended guarantee type is set longer than the guarantee period (4 years) of the normal recommended guarantee type or the guarantee period (2 years) of the heavy recommended guarantee type. This is because the product life of the lighting device corresponding to the light recommended guarantee type is considered to be longer than that of the lighting device corresponding to the normal or heavy recommended guarantee type (the spontaneous failure is hardly generated). Thus, for the use characteristic in which the product life is prolonged (the spontaneous failure is hardly generated), the guarantee fee is set cheaper and the guarantee period is set longer in the recommended guarantee content decision table.

The contents (for example, the threshold that the monthly average number of days during each of which the lighting time is less than 1 hour is greater than or equal to 25) of the tables in FIGS. 14A and 14B used to decide the recommended guarantee are described by way of example, but the applied condition used to decide the recommended guarantee type and the recommended guarantee content in each recommended guarantee type are not limited to the contents in FIGS. 14A and 14B. As described above, any applied condition and any recommended guarantee content may be used as long as the recommended guarantee content gives preferential treatment to the lighting device having the use characteristic in which the life is prolonged (the spontaneous failure is hardly generated). In the example of FIG. 14B, the preferential treatment is given with respect to both the guarantee fee and the guarantee period. Alternatively, the preferential treatment is given with respect to either the guarantee fee or the guarantee period.

In FIG. 14B, the “spontaneous failure” is described in the field of the guarantee coverage, and this indicates that the case where the failure is generated even if the lighting device is used according to an instruction manual (spontaneous failure) becomes a repair target. The description “however, consumables are not included in the guarantee” indicates that the consumables used in the device are not included in the guarantee. The guarantee coverage in FIG. 14B is described by way of example, and the guarantee coverage is not limited to the example in FIG. 14B.

A flow of recommended guarantee content decision processing with the tables in FIGS. 14A and 14B used to decide the recommended guarantee content will be described below with the lighting device as an example.

(1) Recommended guarantee content decision unit 126 of server 121 decides which one of the recommended guarantee types corresponds to the input use characteristic information about the lighting device by using the auxiliary table in FIG. 14A used to decide the recommended guarantee content.

(2) Recommended guarantee content decision unit 126 of server 121 decides the recommended guarantee content corresponding to the decided recommended guarantee type based on the recommended guarantee content decision table in FIG. 14B.

For example, the use characteristic information in FIG. 13A about the lighting device having the device ID of dID1 is decided as follows.
The number of days during each of which a lighting time is less than 1 hour is 1.
The number of days during each of which the lighting time is greater than or equal to 1 hour and less than 20 hours is 29.
The number of days during each of which the lighting time is greater than or equal to 20 hours is 0. Therefore in FIG. 14A, because the recommended guarantee type does not satisfy both the “light” and “heavy” applied conditions, the recommended guarantee type is decided to be “normal”.

For the “normal” recommended guarantee type, “the guarantee fee is 5% of the selling price, the guarantee period is 4 years, and the guarantee coverage is the spontaneous failure (however, consumables are not included in the guarantee)” is decided as the recommended guarantee content by using the table in FIG. 14B.

The use characteristic information in FIG. 13B about the lighting device having the device ID of dID2 is decided as follows.
The monthly average number of days during each of which the lighting time is less than 1 hour is 28.
The monthly average number of days during each of which the lighting time is greater than or equal to 1 hour and less than 20 hours is 2.
The monthly average number of days during each of which the lighting time is greater than or equal to 20 hours is 0. Therefore in FIG. 14A, because the recommended guarantee type satisfies the “light” applied condition, the recommended guarantee type is decided to be “light”.

For the “light” recommended guarantee type, “the guarantee fee is 3% of the selling price, the guarantee period is 9 years, and the guarantee coverage is the spontaneous failure (however, consumables are not included in the guarantee)” is decided as the recommended guarantee content by using the table in FIG. 14B.

[Detail of Recommended Guarantee Display Control Processing of Service Provider 120]

A flow of the recommended guarantee display control processing in recommended guarantee content display controller 127 will be described below with the lighting device as an example.

(1) Recommended guarantee content display controller 127 of server 121 of service provider 120 generates recommended guarantee information including the expiration date (for example, the recommended guarantee information including the expiration date on the same day after one year from the purchase date) by using the recommended guarantee content decided by recommended guarantee content decision unit 126 and the use characteristic information generated by use characteristic information generator 125 of server 121. The generated recommended guarantee information including the expiration date may be stored in a memory of server 121.

(2) For example, recommended guarantee content display controller 127 of server 121 of service provider 120 transmits information (for example, URL information used to access the recommended guarantee information) used to access the generated recommended guarantee information including the expiration date to the smartphone that is the information output device of user 10.

(3) The smartphone that is the information output device of user 10 displays the recommended guarantee display information including the expiration date based on the information (for example, the URL information used to access the recommended guarantee information), which is used to access the recommended guarantee display information including the expiration date and received from recommended guarantee content display controller 127 of server 121.

With this configuration, user 10 can determine whether to apply for the extended guarantee service of the device after user 10 confirms the recommended guarantee content including the expiration date with respect to the target device.

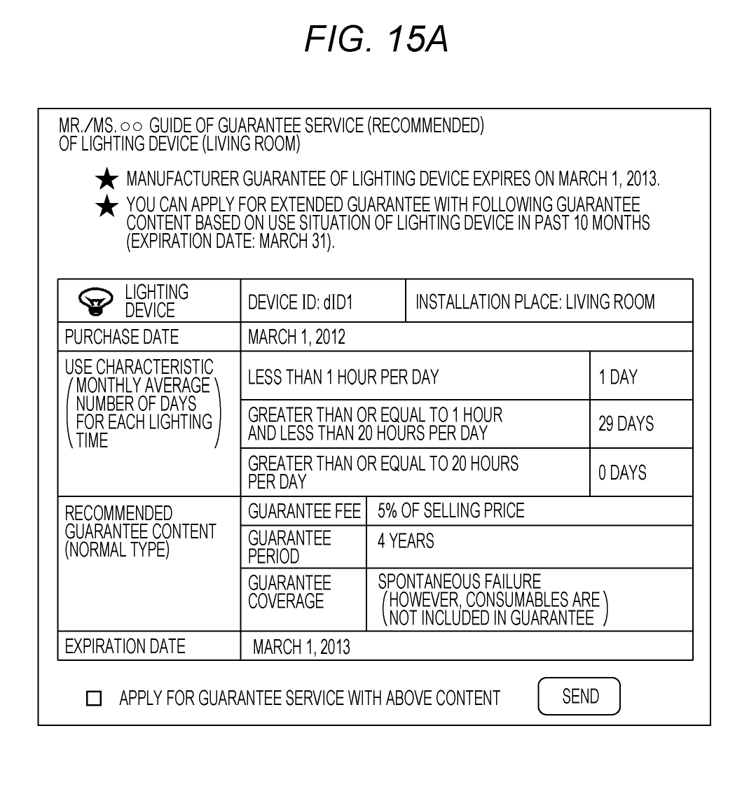

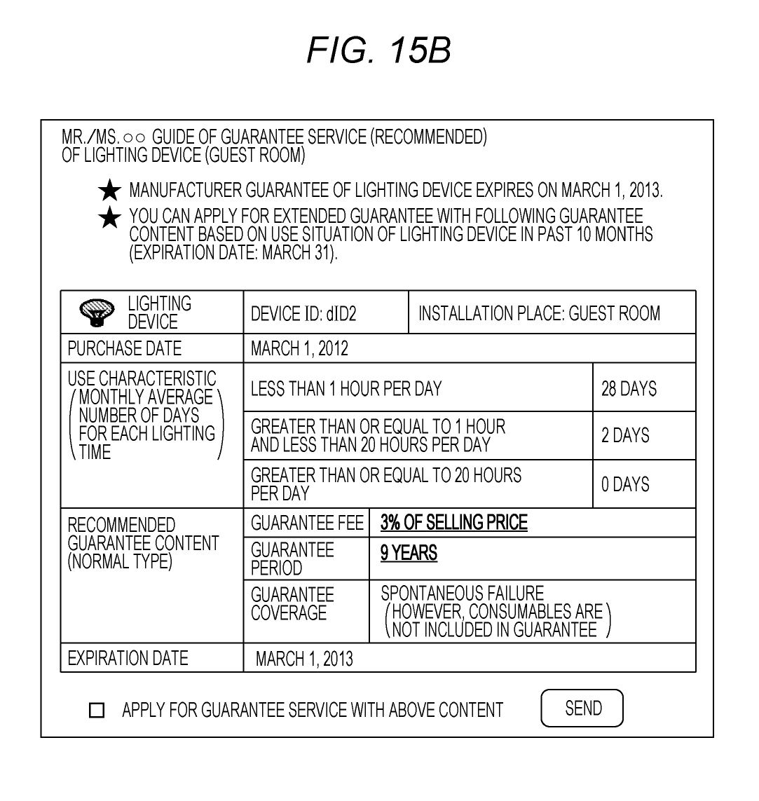

FIGS. 15A and 15B illustrate examples of a display screen of the recommended guarantee display information in the smartphone that is the information output device of user 10 (S3240 in FIG. 32).

FIG. 15A illustrates a display screen example of the recommended guarantee display information about the lighting device (the installation place is a living room) having the device ID of dID1, and FIG. 15B illustrates a display screen example of the recommended guarantee display information about the lighting device (the installation place is a guest room) having the device ID of dID2.

As illustrated in FIGS. 15A and 15B, the display screen of the recommended guarantee display information includes the information about the device (the type of the device (lighting device), the icon expressing the device, the device ID, the installation place of the device, and the purchase date of the device), the use characteristic of the device, the recommended guarantee content, and a contract expiration date (the expiration date to which the recommended guarantee content is applied) of the recommended guarantee content. For the guarantee content to which the preference treatment is given compared with the usual case (normal case) like the guarantee fee and guarantee period in FIG. 15B, the guarantee content is highlighted such that the user can easily recognize the guarantee content to which the preference treatment is given. In an example in FIG. 15B, the guarantee content is highlighted by an underline or a bold type. However, the highlighting is not limited to the example in FIG. 15B. For example, the highlighting may be performed by changing a display color or a background color of a character or enlarging a character size. Alternatively, a drawing pattern may be inserted in a highlighted place so as to attract attention of the user.

In a case where user 10 confirms the content displayed in FIG. 15A to apply for the guarantee service, user 10 checks “apply for the guarantee service with the content” in a bottom portion of the display screen, and touches a send button, which allows user 10 to apply for the guarantee service. The checkbox and send button that are used to apply for the guarantee service are provided in the bottom portion of the display screen in FIG. 15A. However, the display screen is not limited to the configuration in FIG. 15A. For example, the checkbox and send button that are used to apply for the guarantee service may be provided in any position of the display screen. Applying means with which the user applies for the guarantee service may be provided by another method other than the checkbox and the send button that are used to apply for the guarantee service.

In the recommended guarantee display control processing, server 121 of service provider 120 transmits the information (for example, the URL information used to access the recommended guarantee information) used to access the recommended guarantee information to the smartphone that is the information output device of user 10. However, the recommended guarantee display control processing is not limited to this configuration. For example, server 121 transmits announcement information indicating the generation of the recommended guarantee information to the smartphone that is the information output device of user 10. In the case where the smartphone that is the information output device of user 10 receives the announcement information, user 10 logs in the device recommended guarantee presentation service provided by server 121 of service provider 120 by using the user ID and the password. The recommended guarantee information including the expiration date may be displayed on the smartphone that is the information output device of user 10.

(Modifications of First Exemplary Embodiment)

(1) In the first exemplary embodiment, the lighting device is taken as an example, the monthly average number of days of each lighting time per day is obtained as the use characteristic information with respect to each lighting device in the predetermined period (the constant period from the purchase date), and the recommended guarantee content is decided based on the obtained use characteristic information. The first exemplary embodiment can be applied to a device other than the lighting device. For air conditioning devices such as a humidifier, a dehumidifying dryer, and an air cleaner, the monthly average number of days of each operating time per day is obtained as the use characteristic information in the predetermined period (the constant period from the purchase date), and the recommended guarantee content may be decided based on the obtained use characteristic information. In the case where the operational situation of the device varies depending on a season like the air conditioner and a heating appliance, the monthly average number of days of each operating time per day is obtained as the use characteristic information with respect to the device in a predetermined period of each season (for example, in the constant period from the purchase date, June to September in a summer season and November to March in a winter season), and the recommended guarantee content may be decided based on the obtained use characteristic information in each season.

In the devices such as the refrigerator and the like, basically the power is normally turned on, and the failure is possibly generated by repeatedly turning off the power. In such devices, a monthly average number of times at each of which the power is turned off or a number of times at each of which the power is repeatedly turned off within a predetermined time is obtained as the use characteristic information, and the recommended guarantee content may be decided based on the obtained use characteristic information. In the case where the monthly average number of times at each of which the power is turned off or the number of times at each of which the power is repeatedly turned off within the predetermined time is greater than or equal to a predetermined threshold, because the product life is possibly shortened, the guarantee fee is set more expensive, or the guarantee period is shortened. In the devices, such as the air conditioner, the washing machine, and the cleaner, which need to be cared for, the recommended guarantee content may be decided based on the use characteristic information about the use condition concerning the care (for example, the use frequency of an operation function of cleaning an internal device of a main body or a filter for the air conditioner, the use frequency of an operation function of cleaning a washing tank for the washing machine, and a lighting frequency of a filter exchange lamp for the cleaner). The first exemplary embodiment can be applied to any device (such as a rice cooker, a microwave oven, a shaver, a fitness device, a massaging tool, a television set, a DVD recorder, a BD recorder, a digital camera, a digital video camera, a car navigation system, a telephone, and a facsimile machine) other than the above devices.

(2) In the first exemplary embodiment, the monthly average number of days of each lighting time per day is obtained as the use characteristic information with respect to each lighting device in the predetermined period (the constant period from the purchase date), and the recommended guarantee content is decided based on the obtained use characteristic information. The first exemplary embodiment is not limited to this configuration. For example, the lighting time on every day (or every time the lighting device is used) is acquired as the use history information with respect to the lighting device in a predetermined period, the average lighting time per day (or every time the lighting device is used) is obtained as the use characteristic information from the acquired use history information. For example, the recommended guarantee type is set to “light” in the case where the average lighting time per day (or every time the lighting device is used) is less than 1 hour, the recommended guarantee type is set to “normal” in the case where the average lighting time per day (or every time the lighting device is used) is greater than or equal to 1 hour and less than 20 hours, the recommended guarantee type is set to “heavy” in the case where the average lighting time per day (or every time the lighting device is used) is greater than or equal to 20 hours, and the recommended guarantee content may be decided based on the recommended guarantee content decision table in FIG. 14B. Similarly, in the devices (such as a washing machine, a refrigerator, a rice cooker, a microwave oven, an air conditioner, an air cleaner, a humidifier, a shaver, a fitness device, a massaging tool, a television set, a DVD recorder, a BD recorder, a digital camera, a digital video camera, a car navigation system, a telephone, and a facsimile machine) other than the lighting device, the average use time per day (or every time the device is used) is obtained as the use characteristic information, and the recommended guarantee content may be decided based on the obtained use characteristic information.

(3) In the first exemplary embodiment, after registering initially in the device use history management service provided by cloud server 111 of data center operating company 110, the user registers initially in the device recommended guarantee presentation service provided by server 121 of service provider 120 (registers in the coordination with the device use history management service). However, the first exemplary embodiment is not limited to this configuration. For example, after registering initially in the device recommended guarantee presentation service provided by server 121 of service provider 120, user 10 may register initially in the device use history management service provided by cloud server 111 of data center operating company 110 (register in the coordination with the device recommended guarantee presentation service). The modification (3) of the first exemplary embodiment may be applied to the following other exemplary embodiments.

(4) In the first exemplary embodiment, data center operating company 110 and service provider 120 are separately provided. Alternatively, data center operating company 110 may serve concurrently as service provider 120. In this case, the initial registration in the device recommended guarantee presentation service may be completed by the initial registration in the device use history management service provided by cloud server 111 of data center operating company 110. In this case, user management unit 112, device management unit 113, and use history information management unit 114 of cloud server 111 of data center operating company 110 may be integrated in user management unit 122, device management unit 123, and use history information management unit 124 of server 121 of service provider 120, respectively. The modification (4) of the first exemplary embodiment may be applied to the following other exemplary embodiments.

(5) In the first exemplary embodiment, at the predetermined time, for example, at the time point 10 months elapses from the purchase date of the device, the use characteristic information about the target device is generated according to the use history information about the device in the predetermined period, for example, for 10 months from the purchase date of the device, the recommended guarantee content is decided based on the generated use characteristic information, and the generated use characteristic information and the recommended guarantee content are presented to the user. However, the first exemplary embodiment is not limited to this configuration. For example, the use characteristic information about the target device is generated periodically at a predetermined time (for example, at the time points 1 month, 2 months, . . . , 10 months elapse from the purchase date of the device), a temporary recommended guarantee content is decided at each time point based on the generated use characteristic information, and the generated use characteristic information and temporary recommended guarantee content may be presented to the user (or the user may be notified of the generated use characteristic information and the temporary recommended guarantee content) together with information indicating that the temporary recommended guarantee content becomes the final recommended guarantee content in the case where the similar use situation is continued. For example, the use characteristic information about the target device is generated at the predetermined time, for example, every time the device is used, the temporary recommended guarantee content is decided at that time point based on the generated use characteristic information, the generated use characteristic information and the temporary recommended guarantee content may be presented to the user (or the user may be notified of the generated use characteristic information and the temporary recommended guarantee content) together with the information indicating that the temporary recommended guarantee content becomes the final recommended guarantee content in the case where the similar use situation is continued. In the presentation, the decided guarantee period may be displayed to the user by using a bar graph and the like. The bar graph indicating the guarantee period may be updated (extends or shortens) every time the device is used.

(6) In the first exemplary embodiment, on-site repair service on weekend or during night on weekdays may be included in the guarantee coverage in the case where a high use frequency of the device on weekend or during night on weekdays is recognized from the use history information about each device of the group.

### Second Exemplary Embodiment

In a second exemplary embodiment, a description will be given of a case where the lighting device is taken as an example, and a service point that can be appropriated for part of the guarantee fee is decided and presented to the user in addition to the recommended guarantee content (such as the guarantee fee, the guarantee period, and the guarantee coverage) based on the use history information about the lighting device in the constant period from the purchase date.

The configuration of the recommended guarantee content presentation system of the second exemplary embodiment is substantially identical to that of the recommended guarantee content presentation system of the first exemplary embodiment. Therefore, a different point is mainly described below.

The following configurations of the second exemplary embodiment are identical to those of the first exemplary embodiment, and therefore the description is not given.
The entire configuration of the recommended guarantee content presentation system (see FIG. 2).
The configuration of the group (see FIG. 3).
The configuration of the cloud server of the data center operating company (see FIG. 4).
The processing flow of the device use history management service provided by the data center (see FIG. 6).
The user management table managed by the user management DB of the data center (see FIG. 7).
The device management table managed by the device management DB of the data center (see FIG. 8).
The use history management table managed by the use history management DB of the data center (see FIGS. 9A and 9B).
The user management table managed by the user management DB of the service provider (see FIG. 11).
The device management table managed by the device management DB of the service provider (see FIG. 12).
The use characteristic information generated by the service provider (see FIGS. 13A and 13B).
The table managed by the service provider to decide the recommended guarantee content (see FIGS. 14A and 14B).

The second exemplary embodiment differs from the first exemplary embodiment in the following points.

[Configuration of Server of Service Provider]

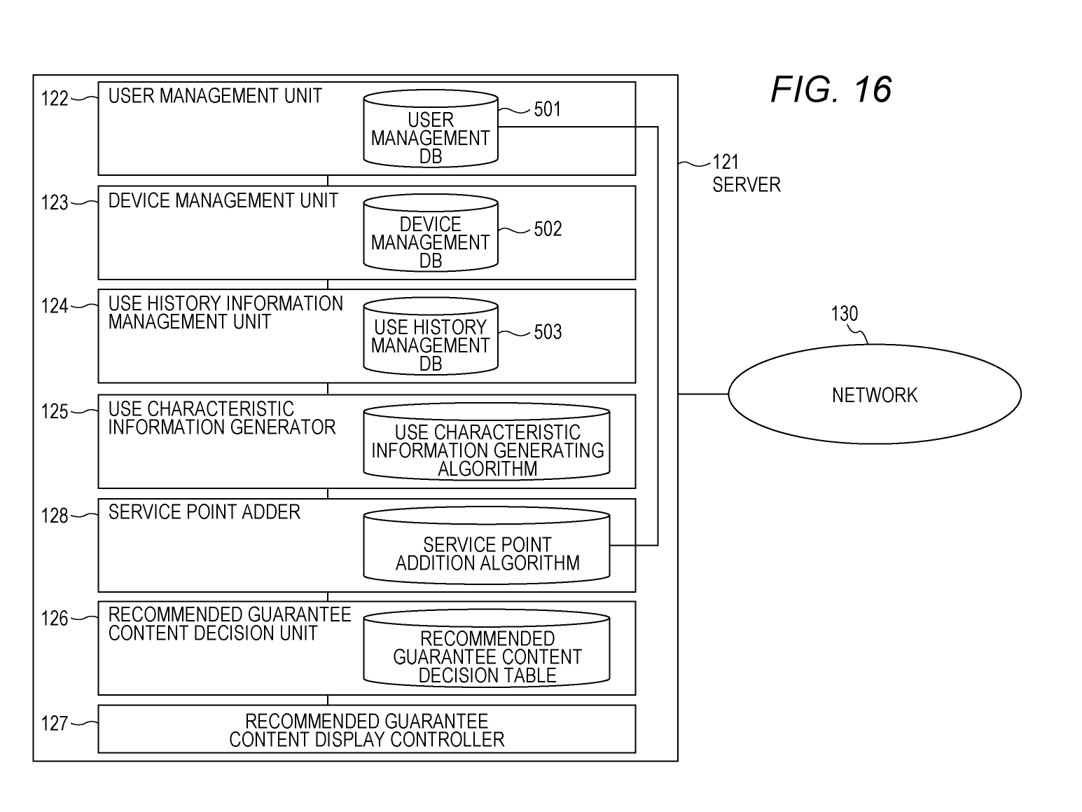

FIG. 16 illustrates a configuration of server 121 of service provider 120 in the second exemplary embodiment. As illustrated in FIG. 16, in server 121 of service provider 120 of the second exemplary embodiment, service point adder 128 is added to the configuration of server 121 of the first exemplary embodiment.

Service point adder 128 includes a service point addition algorithm in each type of the device, generates the service point of the device from the use history information about the device by using the service point addition algorithm, and adds the generated service point to a holding service point managed by the user management DB. The service point addition algorithm is described later.

[Processing Flow of Device Recommended Guarantee Presentation Service Provided by Service Provider]

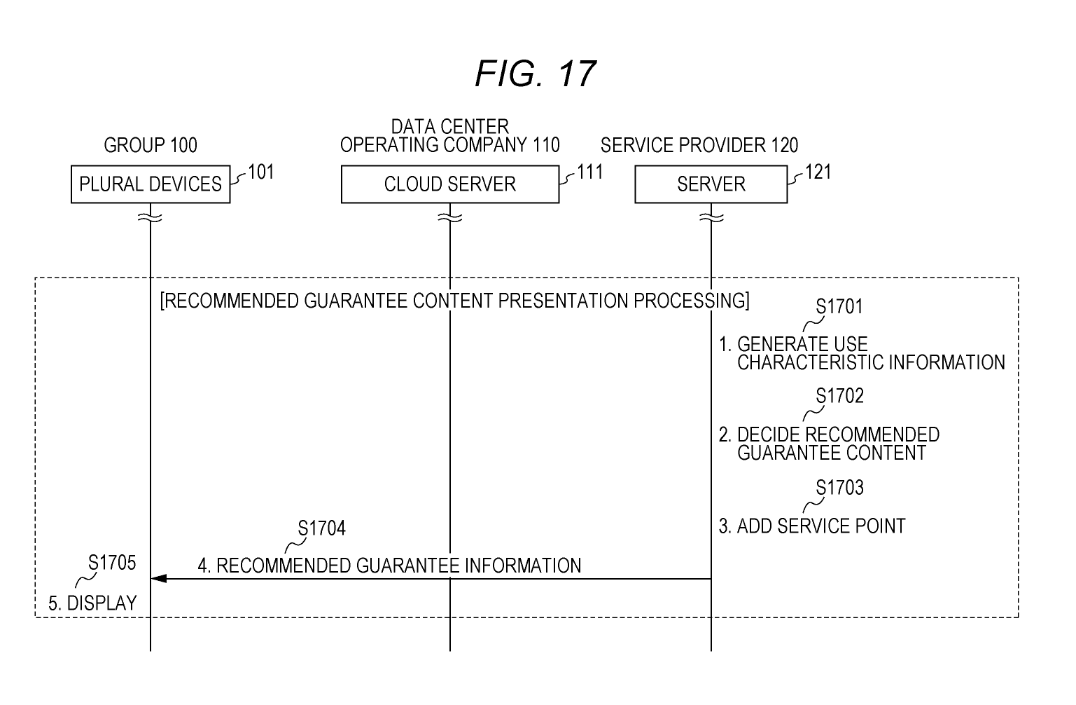

FIG. 17 illustrates a processing flow (only a “recommended guarantee content presentation processing” portion different from that of the first exemplary embodiment) of the device guarantee presentation service provided by server 121 of service provider 120.

As illustrated in FIG. 17, the second exemplary embodiment differs from the first exemplary embodiment only in that a service point addition step (S1703) is added. Other portions of the recommended guarantee content presentation processing of the second exemplary embodiment are identical to those of the first exemplary embodiment, and therefore the description is not given.

Specifically, the recommended guarantee content presentation processing of the second exemplary embodiment is as follows.

(1) Using the predetermined use characteristic information generating algorithm, server 121 of service provider 120 generates the use characteristic information about the target device at the predetermined time, for example, at the time point 10 months elapse from the purchase date of the device, according to the use history information about the target device in the predetermined period, for example, for 10 months from the purchase date of the device (S1701).

(2) Using the predetermined recommended guarantee content decision table, server 121 of service provider 120 decides the recommended guarantee content based on the generated use characteristic information (S1702).

(3) Using the predetermined service point addition algorithm defined in each type of the device, server 121 of service provider 120 generates the service point of the device from the generated use characteristic information, and adds the service point to the holding service point managed by user management unit 122 (S1703).

(4) Server 121 of service provider 120 generates the recommended guarantee information including the decided recommended guarantee content and the added holding service point, and notifies the information output device such as the smartphone of user 10 of the recommended guarantee information including the expiration date (for example, the recommended guarantee information including the expiration date on the same day after one year from the purchase date) (S1704).

(5) The information output device such as the smartphone of user 10 displays the recommended guarantee information including the expiration date that is received from server 121 of service provider 120 (S1705).

With this configuration, user 10 can determine whether to apply for the extended guarantee service of the device after user 10 confirms the recommended guarantee content including the expiration date with respect to the device and the service point that can be appropriated for part of the guarantee fee.

[Point Addition Algorithm of Service Provider 120]

Service point adder 128 of server 121 includes the service point addition algorithm in each type of the device, generates the service point of the device from the use characteristic information about the device by using the service point addition algorithm, and adds the service point to the holding service point.

As described above, the service point addition algorithm is provided in each type of the device. Specifically, the service point addition algorithm may be provided in each of types of home appliances such as the lighting device, the television set, and the air conditioner, each of categories of the home appliances such as a home electric appliance, a digital home appliance, and a health and beauty home appliance, or each of models of the home appliances.

In the service point addition algorithm, the service point is added to the device having the use characteristic in which the product life of the device is prolonged or the failure is hardly generated, based on the obtained use characteristic information in each type of the device.

The service point addition algorithm will be described below with the lighting device as an example.

In the service point addition algorithm used in the lighting device, for example, a predetermined service point (for example, 1% of selling price) is generated and added to the already held service point in the case where the number of days during each of which the lighting time is less than 1 hour is greater than or equal to 25 in each use month.

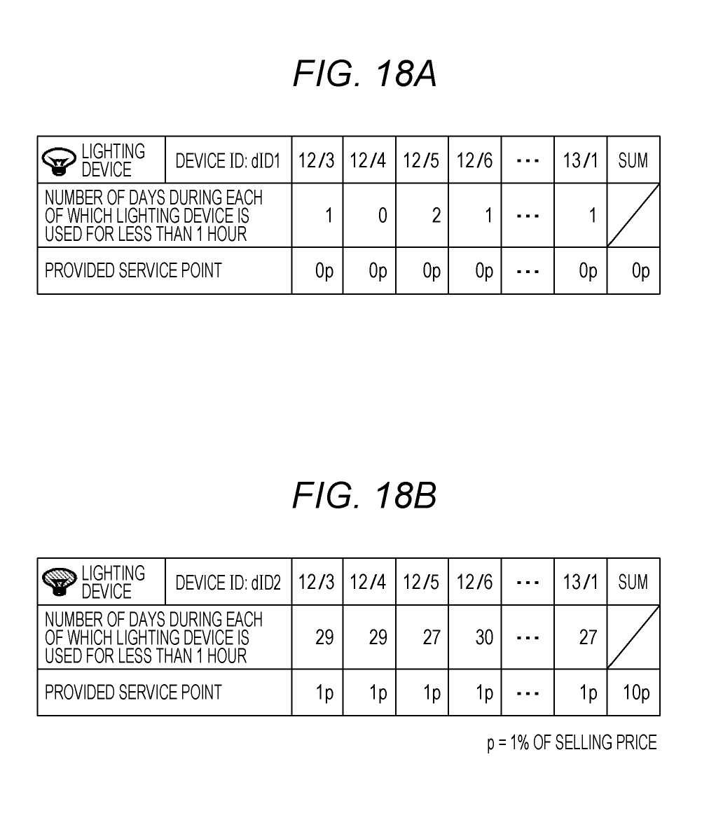

FIGS. 18A and 18B illustrate the service points added using the service point addition algorithm in the lighting devices having the device IDs of dID1 and dID2.

For the lighting device in FIG. 18A, because there is no month in which the number of days during each of which the lighting time is less than 1 hour is greater than or equal to 25, the added service point becomes 0.

For the lighting device in FIG. 18B, because there are 10 months in each of which the number of days during each of which the lighting time is less than 1 hour is greater than or equal to 25, the added service point becomes “selling price×1(%)×10 (months)” that is a value in which the number of corresponding months is multiplied by 1% of the selling price. That is, the added service point becomes 1000 points in the case where the selling price of the lighting device in FIG. 18B is 10000 yen.

The obtained service point is added to the service point already held by the user of the lighting device. The holding service point can be appropriated for part of the guarantee fee. At this point, for example, it is assumed that 1 service point is converted into 1 yen.

In the second exemplary embodiment, the service point is set so as to be proportional to the selling price such as 1% of the selling price. However, the second exemplary embodiment is not limited to this configuration. Alternatively, the service point may be set as a fixed point irrespective of the selling price.

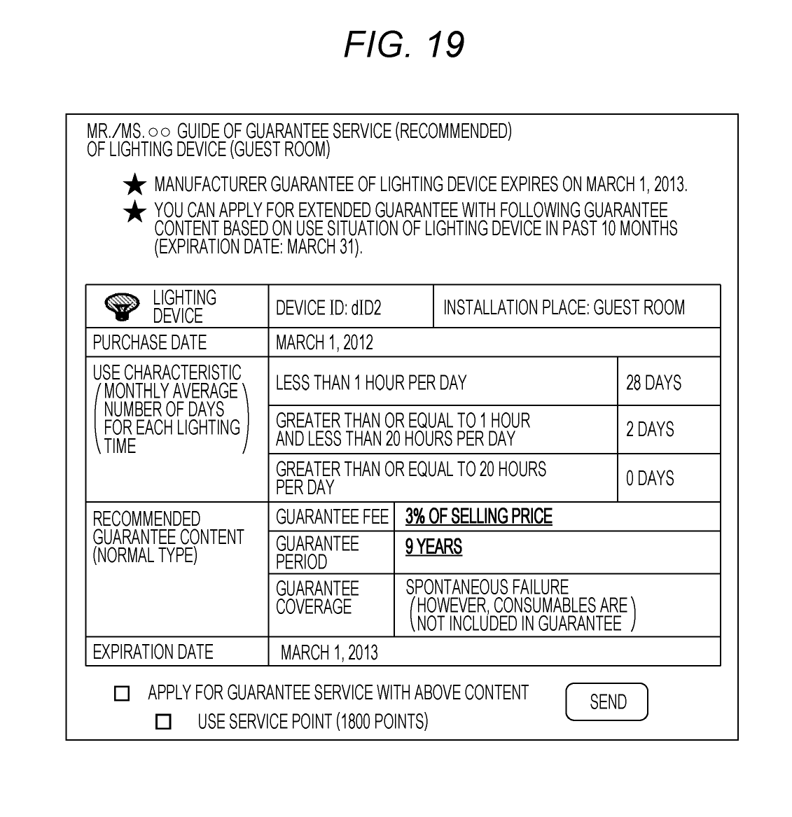

FIG. 19 illustrates an example of the display screen of the recommended guarantee display information for the lighting device in FIG. 18B. As illustrated in FIG. 19, the post-addition service point (1800 points) is presented in addition to the recommended guarantee content of the lighting device.

In the display screen of FIG. 19, after checking “the use of the service point (1800 points)” in the bottom portion of the display screen in FIG. 19, the user checks “apply for the guarantee service with the above content” to touch the send button. Therefore, the service point (1800 points) provided to user 10 is appropriated for part of the guarantee fee in the recommended guarantee content (used to discount the guarantee fee), and the user can apply for the guarantee contract.

This enables the user to determine whether to apply for the guarantee contract after confirming the holding service point in addition to the use characteristic of the lighting device and the recommended guarantee content.

The service point generated with respect to the lighting device in FIG. 18B may be appropriated for part of the guarantee fee in the recommended guarantee content of another device (for example, the lighting device in FIG. 18A) (used to discount the guarantee fee).

(Modifications of Second Exemplary Embodiment)

(1) In the second exemplary embodiment, the lighting device is taken as an example, the monthly average number of days during each of which the lighting time is less than 1 hour is obtained with respect to each lighting device in the predetermined period (the constant period from the purchase date) as the use characteristic information, in which the product life of the device is prolonged or the failure of the device is hardly generated, and the service point is added based on the obtained use characteristic information. The second exemplary embodiment can be applied to a device other than the lighting device. For air conditioning devices such as the humidifier, the dehumidifying dryer, and the air cleaner, the monthly average number of days during each of which the operating time is less than a predetermined time (for example, 15 minutes) is obtained in the predetermined period (the constant period from the purchase date) as the use characteristic information, in which the product life of the device is prolonged or the failure of the device is hardly generated, and the service point may be added based on the obtained use characteristic information. In the case where the operational situation of the device varies depending on the season like the air conditioner and the heating appliance, the monthly average number of days during each of which the operating time is less than a predetermined time (for example, 15 minutes) is obtained in each season (for example, in the constant period from the purchase date, June to September in the summer season and November to March in the winter season) included in the predetermined period as the use characteristic information, in which the product life of the device is prolonged or the failure of the device is hardly generated, and the service point may be added based on the obtained use characteristic information.

In the devices, such as the air conditioner, the washing machine, and the cleaner, which need to be cared for, the service point may be added or subtracted based on the use characteristic information about the use condition concerning the care (for example, the use frequency of the operation function of cleaning the internal device of the main body or the filter in the air conditioner, the use frequency of the operation function of cleaning a washing tank in the washing machine, and a lighting frequency of a filter exchange lamp of the cleaner). The second exemplary embodiment can be applied to any device (such as the refrigerator, the washing machine, the cleaner, the rice cooker, the microwave oven, the shaver, the fitness device, the massaging tool, the television set, the DVD recorder, the BD recorder, the digital camera, the digital video camera, the car navigation system, the telephone, and the facsimile machine) other than the above devices.

(2) In the second exemplary embodiment, the monthly average number of days during each of which the lighting time is less than 1 hour is obtained with respect to the lighting device in the predetermined period (the constant period from the purchase date) as the use characteristic information, in which the product life of the device is prolonged or the failure of the device is hardly generated, and the service point is added based on the obtained use characteristic information. However, the second exemplary embodiment is not limited to this configuration. For example, the average lighting time per day is obtained as the use characteristic information from the daily lighting time of the lighting device (or the lighting time of the day on which the lighting device is used) in the predetermined period, and the service point may be decided based on the obtained use characteristic information.

The second exemplary embodiment is not limited to the above configuration, and any configuration is possible as long as in each type of the device, the service point may be added to the device having the use characteristic in which the product life of the device is prolonged or the failure of the device is hardly generated.

(3) In the second exemplary embodiment, the use characteristic information, in which the product life of the device is prolonged or the failure of the device is hardly generated is obtained, and the service point is added based on the obtained use characteristic information. However, the second exemplary embodiment is not limited to this configuration. For example, the use characteristic information about the recommended function (described in the instruction manual and the like) recommended by the device manufacturer is obtained, and the service point may be added based on the obtained use characteristic information.

For example, the service point may be subtracted based on the use characteristic information in which the product life of the device is shortened or the failure of the device is possibly generated. For example, the use characteristic information about the use condition (described in the instruction manual and the like) that is not recommended by the device manufacturer is obtained, and the service point may be subtracted based on the obtained use characteristic information. The use characteristic information indicating whether the device is used with caution is obtained, and the service point may be added based on the obtained use characteristic information. For example, for the air conditioner, the number of times at which the operation function of cleaning the internal device of the main body or the filter is used or the cleaning operation time is obtained as the use characteristic information indicating whether the device is used with caution, for example, in the end of the season, and the service point may be added or subtracted based on the obtained use characteristic information.

(4) In the second exemplary embodiment, the service point is periodically obtained (for example, each use month), and the service point is added to the holding service point. However, the second exemplary embodiment is not limited to this configuration. For example, the service point is obtained every time the device is used, the service point is added to the holding service point, and the holding service point may be presented to the user or the user may be notified of the holding service point.

(5) At a predetermined time (for example, every time the service point is added or subtracted), the holding service point may be presented to the user or the user may be notified of the holding service point. At this point, the holding service point may be displayed to the user by using the bar graph or the like. The bar graph of the service point may be updated (extends or shortens) every time the device is used.

(6) The user is ranked based on the service point held by the user, and the preference treatment may be given to the guarantee content of the device of the user according to the ranking. For example, according to the service point held by the user, the user becomes a platinum member in the case where the user has the holding service point of over 100000 points, and the guarantee fee of a platinum member price (for example, the price is further cut by 10% of the decided guarantee fee) may be presented to the user. The user becomes a gold member in the case where the user has the holding service point of over 10000 points, and the guarantee fee of a gold member price (for example, the price is further cut by 3% of the decided guarantee fee) may be presented to the user. In the case where the plurality of users exist in the group, a sum of the holding service points of the user of the group is used as the holding service point of the group, the group is ranked based on the service point held by the group, and the preference treatment may be given to the guarantee content of the device of the group according to the ranking. According to the ranking of the user or the group, the on-site repair service on weekend or during night on weekdays or preferential telephone service may be included in the guarantee coverage.

(7) In the second exemplary embodiment, the configuration in which the service point is added is added to the first exemplary embodiment. The configuration in which the service point is added may be added to later-described third and fourth exemplary embodiments.

### Third Exemplary Embodiment

In a third exemplary embodiment, the television set is taken as an example, and the recommended guarantee content (such as the guarantee fee, the guarantee period, and the guarantee coverage) is decided and presented to the user according to the use history information about the television set in a constant period from the purchase date.

The configuration of the recommended guarantee content presentation system of the third exemplary embodiment is substantially identical to that of the recommended guarantee content presentation system of the first exemplary embodiment. Therefore, a different point is mainly described below.

The following configurations of the third exemplary embodiment are identical to those of the first exemplary embodiment, and therefore the description is not given.
The entire configuration of the recommended guarantee content presentation system (see FIG. 2).
The configuration of the group (see FIG. 3).
The configuration of the cloud server of the data center operating company (see FIG. 4).
The configuration of the server of the service provider (see FIG. 5).
The processing flow of the device use history management service provided by the data center (see FIG. 6).
The user management table managed by the user management DB of the data center (see FIG. 7).
The device management table managed by the device management DB of the data center (see FIG. 8).
The processing flow of the device recommended guarantee presentation service provided by the service provider (see FIG. 10).
The user management table managed by the user management DB of the service provider (see FIG. 11).
The device management table managed by the device management DB of the service provider (see FIG. 12).

The third exemplary embodiment differs from the first exemplary embodiment in the following points.

[Device Use History Management DB of Data Center Operating Company]

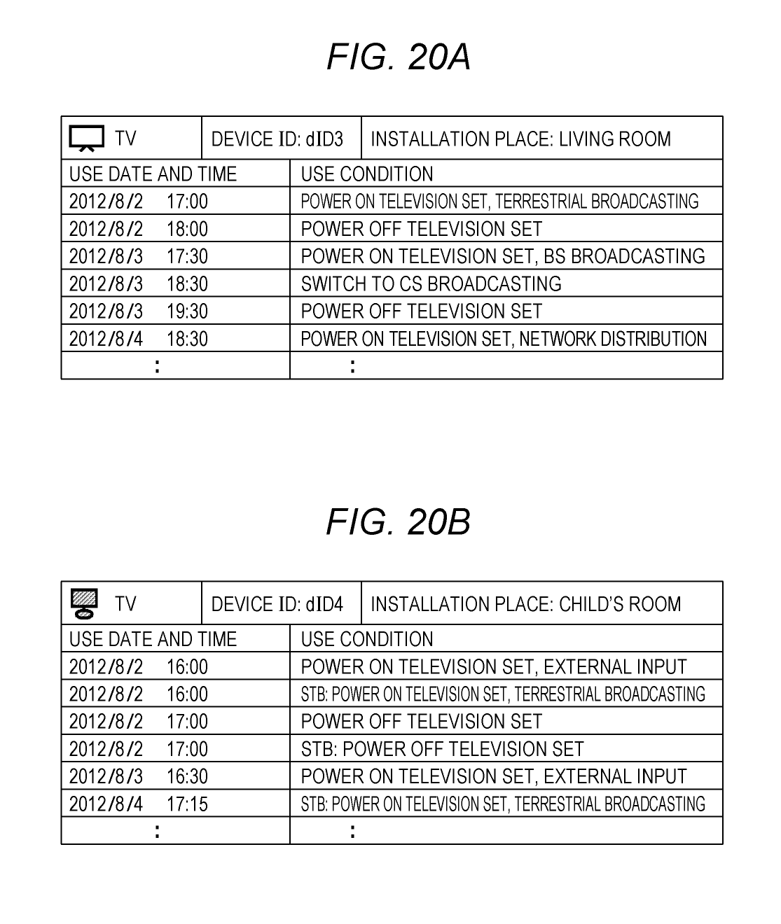

FIGS. 20A and 20B illustrate examples of a television-set use history management table managed by use history management DB 403 of data center operating company 110. FIG. 20A illustrates a use history management table for a television set having a device ID of dID3, and FIG. 20B illustrates a use history management table for a television set having a device ID of dID4.

As illustrated in FIGS. 20A and 20B, the television-set use history management table includes an icon expressing each television set, the device ID of each television set, an installation place of each television set, and a use date and time and a use condition of each television set. Examples of the use condition include turning on/off of the television set and the functional module used (for example, a terrestrial-broadcasting-related functional module, a BS (Broadcasting Satellite)-broadcasting-related functional module, a CS (Communication Satellite)-broadcasting-related functional module, a network-related functional module, an external-input-related functional module, and an external-device-manipulation-related functional module).

As used herein, the external device manipulation means that the device, such as a Set Top Box (STB) of the CA television set or a DVD recorder, which is connected to the television set through the television set, is manipulated. In the example of FIG. 20B, power-on/off of the STB manipulated through the television set and a use function (for example, a terrestrial-broadcasting-related function) in the STB are managed as the use history.

[Use History Management DB of Service Provider]

The television-set use history management table managed by use history management DB 503 of service provider 120 is identical to that of the television-set use history information management table managed by the use history management DB of the data center operating company, and therefore the description is not given (see FIGS. 20A and 20B).

[Use Characteristic Information Generating Algorithm of Service Provider and Use Characteristic Information Example]

Use characteristic information generator 125 of server 121 of service provider 120 includes the use characteristic information generating algorithm generating the use characteristic information about the target device concerning a predetermined use condition defined in each type of the device, and inputs the use history information about the target device to the use characteristic information generating algorithm to thereby generate the use characteristic information about the device.

As described above, the use characteristic information generating algorithm is provided in each type of the device. Specifically, the use characteristic information generating algorithm may be provided in each of types of home appliances such as the lighting device, the television set, and the air conditioner, each of categories of the home appliance such as a home electric appliance, a digital home appliance, and a health and beauty home appliance, or each of models of the home appliances.

As described above, the use characteristic information generating algorithm generates the use characteristic information about the target device with respect to the predetermined use condition defined in each type of the device. Specifically, the use characteristic information generating algorithm may generate the use characteristic information (for example, an average use frequency of the use condition) about the target device with respect to the use condition in which the product life of the target device is shortened (or a failure of the target device is possibly generated) or the use characteristic information (for example, an average use frequency of the use condition) about the target device with respect to the use condition in which the product life of the target device is prolonged (or the failure of the target device is hardly generated).

The use characteristic information generating algorithm will be described below with the television set as an example.

In the use characteristic information generating algorithm for the television set, the use history information about the television set illustrated in FIGS. 20A and 20B is used as the input data, 1) the number of use days during each of which a terrestrial-broadcasting-related functional module (for example, reception, playback, and display of terrestrial broadcasting) is used for greater than or equal to 15 minutes in each use month, 2) the number of use days during each of which a BS-broadcasting-related functional module is used for greater than or equal to 15 minutes in each use month, 3) the number of use days during each of which a CS-broadcasting-related functional module is used for greater than or equal to 15 minutes in each use month, 4) the number of use days during each of which a network-distribution-content-related functional module is used for greater than or equal to 15 minutes in each use month, 5) the number of use days during each of which an external-input-content (for example, the content input from the STB of the CA television set)-related functional module is used for greater than or equal to 15 minutes in each use month, a monthly average number of use days of the items 1) to 5) are obtained and output as the output data.

The threshold is set to at least 15 minutes in obtaining the number of use days of each functional module. However, the third exemplary embodiment is not limited to the threshold of at least 15 minutes. For example, the threshold is set to at least 1 minute or 1 hour.

In the use characteristic information generating algorithm, for example, the case where “the monthly average number of use days during each of which the terrestrial-broadcasting-related functional module is used for greater than or equal to 15 minutes” is 0 indicates that the terrestrial-broadcasting-related functional module is substantially unused, and the case is an example of the use condition in which the life of the terrestrial-broadcasting-related functional module of the television set is prolonged.

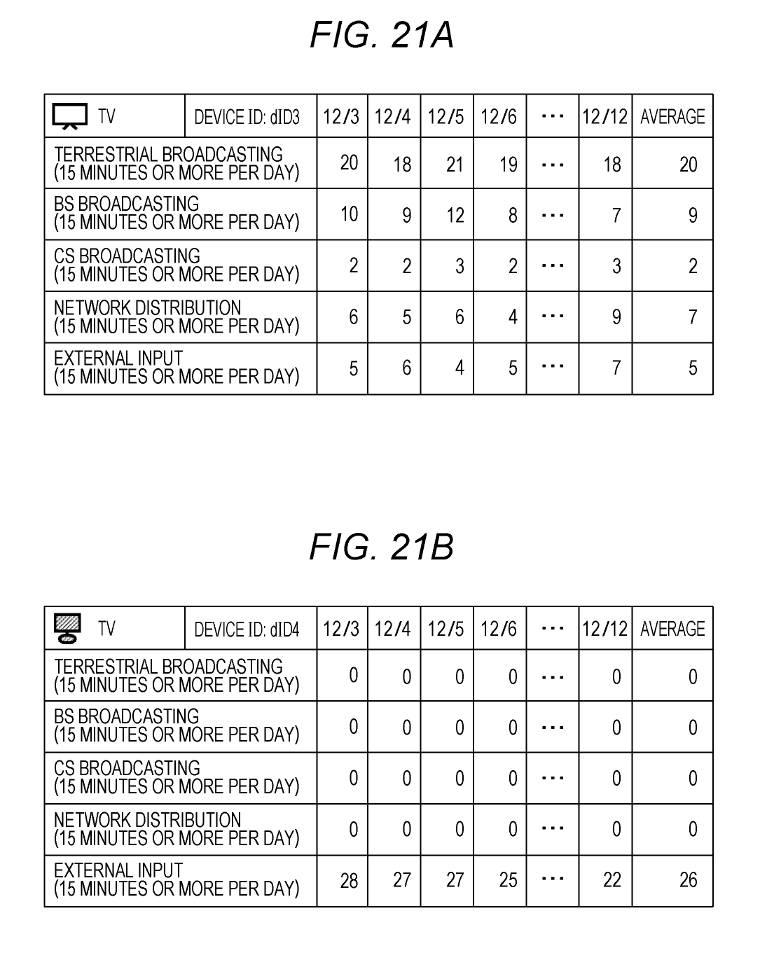

FIGS. 21A and 21B illustrate examples of the use characteristic information about the television set that is generated using the use characteristic information generating algorithm. FIG. 21A illustrates the use characteristic information about the television set having the device ID of dID3. In FIG. 21A, for example, the use on March, 2012 is as follows.
The number of days during each of which the terrestrial-broadcasting-related functional module is used for greater than or equal to 15 minutes is 20.
The number of days during each of which the

BS-broadcasting-related functional module is used for greater than or equal to 15 minutes is 10.
The number of days during each of which the CS-broadcasting-related functional module is used for greater than or equal to 15 minutes is 2.
The number of days during each of which the network-distribution-content-related functional module is used for greater than or equal to 15 minutes is 6.
The number of days during each of which the external-input-content-related functional module is used for greater than or equal to 15 minutes is 5.

The use of 10 months from March, 2012 to December, 2012 is as follows.
The monthly average number of days during each of which the terrestrial-broadcasting-related functional module is used for greater than or equal to 15 minutes is 20.
The monthly average number of days during each of which the BS-broadcasting-related functional module is used for greater than or equal to 15 minutes is 9.
The monthly average number of days during each of which the CS-broadcasting-related functional module is used for greater than or equal to 15 minutes is 2.
The monthly average number of days during each of which the network-distribution-content-related functional module is used for greater than or equal to 15 minutes is 7.
The number of days during each of which the external-input-content-related functional module is used for greater than or equal to 15 minutes is 5.

FIG. 21B illustrates the use characteristic information about the television set having the device ID of dID4. In FIG. 21B, for example, the use of 10 month from March, 2021 to December, 2012 is as follows.
The monthly average number of days during each of which the terrestrial-broadcasting-related functional module is used for greater than or equal to 15 minutes is 0.
The monthly average number of days during each of which the BS-broadcasting-related functional module is used for greater than or equal to 15 minutes is 0.
The monthly average number of days during each of which the CS-broadcasting-related functional module is used for greater than or equal to 15 minutes is 0.
The monthly average number of days during each of which the network-distribution-content-related functional module is used for greater than or equal to 15 minutes is 0.
The number of days during each of which the external-input-content-related functional module is used for greater than or equal to 15 minutes is 26.

[Detail of Recommended Guarantee Content Decision Processing of Service Provider]

Recommended guarantee content decision unit 126 of server 121 of service provider 120 includes a television-set recommended guarantee content decision table, and decides the recommended guarantee content of the television set by using the television-set recommended guarantee content decision table.

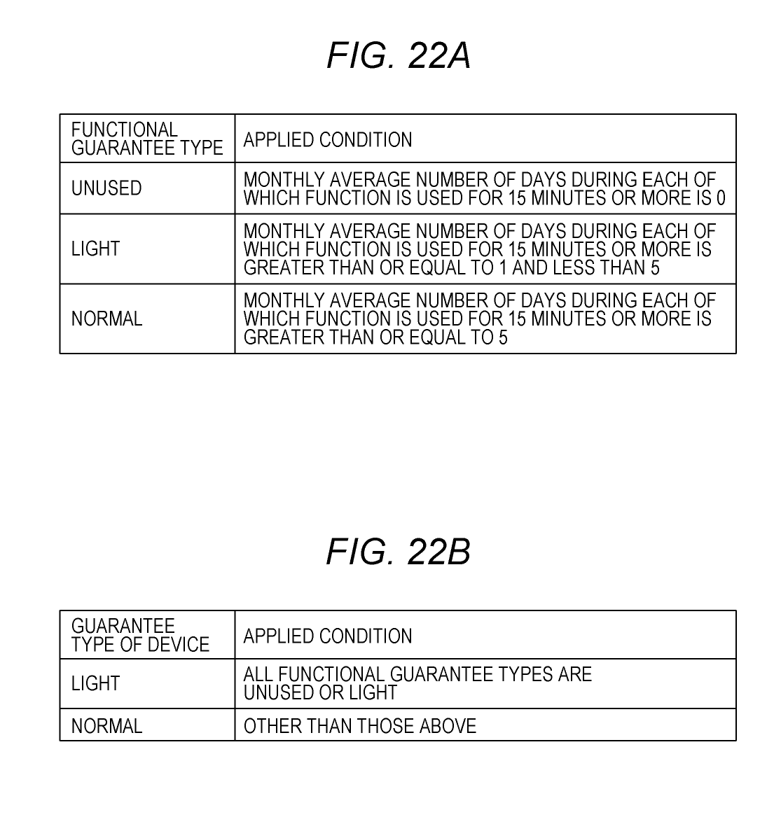

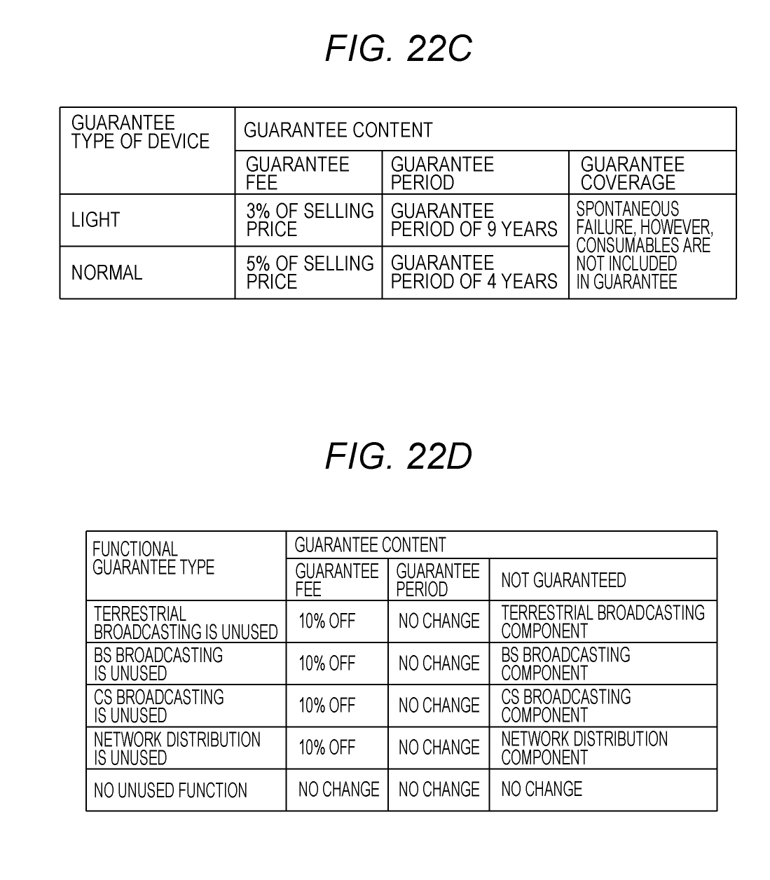

FIGS. 22A, 22B, 22C, and 22D illustrate examples of tables used to decide the recommended guarantee content of the television set.

FIG. 22A illustrates a table (an auxiliary table used to decide the recommended guarantee content) used to decide the recommended guarantee type of each television-set functional module based on the use characteristic information about the television set. That is, it is decided which one of the recommended guarantee types (unused, light, and normal) of the table in FIG. 22A corresponds to each television-set functional module from the use characteristic information about each television set.

FIG. 22B illustrates a table (an auxiliary table used to decide the recommended guarantee content) used to decide the recommended guarantee type of the television set based on the decided recommended guarantee type of each television-set functional module. In the example of FIG. 22B, one of two stages (light and normal) of the recommended guarantee type of the television set is decided based on the decided recommended guarantee type of each functional module.

FIG. 22C illustrates the table (recommended guarantee content decision table) used to temporarily decide the recommended guarantee content according to the decided recommended guarantee type. FIG. 22D illustrates a table (an auxiliary table used to decide the recommended guarantee content) used to correct the temporarily-decided recommended guarantee content in the case where the decided recommended guarantee type of each functional module of the television set is unused.

As illustrated in FIG. 22C, the guarantee fee (3% of selling price) of the light recommended guarantee type is set cheaper than the guarantee fee (5% of selling price) of the normal recommended guarantee type. The guarantee period (9 years) of the light recommended guarantee type is set longer than the guarantee period (4 years) of the normal recommended guarantee type. This is because the product life of the television set corresponding to the light recommended guarantee type is considered to be longer than that of the television set corresponding to the normal recommended guarantee type (the spontaneous failure is hardly generated). Thus, for the use characteristic in which the product life is prolonged (the spontaneous failure is hardly generated), the guarantee fee is set cheaper and the guarantee period is set longer in the recommended guarantee content decision table.

FIGS. 22A, 22B, 22C, and 22D illustrate the tables used to decide the recommended guarantee content by way of example. The applied condition (FIG. 22A) used to decide the recommended guarantee type of each functional module of the television set, the applied condition (FIG. 22B) used to decide the recommended guarantee type of the television set, the recommended guarantee content of each recommended guarantee type (FIG. 22C), and the guarantee content corrected according to the guarantee type of each function of the television set (FIG. 22D) are not limited to the tables in FIGS. 22A, 22B, 22C, and 22D. As described above, any applied condition, any recommended guarantee content, and any guarantee content corrected according to the guarantee type of each function of the television set may be used as long as the recommended guarantee content gives preferential treatment to the television set having the use characteristic in which the product life is prolonged (the spontaneous failure is hardly generated). In the example of FIG. 22C, the preferential treatment is given with respect to both the guarantee fee and the guarantee period. Alternatively, the preferential treatment is given with respect to either the guarantee fee or the guarantee period. In FIG. 22C, the “spontaneous failure” is described in the field of the guarantee coverage, and this indicates that the case where the failure is generated even if the lighting device is used according to the instruction manual (spontaneous failure) becomes the repair target. The description “however, consumables are not included in the guarantee” indicates that the consumables used in the device are not included in the guarantee. The guarantee coverage in FIG. 22C is described by way of example and the guarantee coverage is not limited to the example in FIG. 22C.

A flow of recommended guarantee content decision processing with the tables in FIGS. 22A, 22B, 22C, and 22D used to decide the recommended guarantee content will be described below with the television set as an example.

(1) Recommended guarantee content decision unit 126 of server 121 decides which one of the recommended guarantee types corresponds to the functional module by using the auxiliary table in FIG. 22A used to decide the recommended guarantee content.

(2) Recommended guarantee content decision unit 126 of server 121 decides which one of the recommended guarantee types corresponds to the target television set based on the decided recommended guarantee type of the use functional module by using the auxiliary table in FIG. 22B used to decide the recommended guarantee content.

(3) Recommended guarantee content decision unit 126 of server 121 temporarily decides the recommended guarantee content corresponding to the recommended guarantee type of the target television set based on the recommended guarantee content decision table in FIG. 22C.

(4) Recommended guarantee content decision unit 126 of server 121 finally decides the recommended guarantee content according to the decided recommended guarantee type of the use functional module based on the recommended guarantee content decision table in FIG. 22D.

For example, the recommended guarantee content of the television set in FIG. 21A having the device ID of dID3 is as follows.
The monthly average number of days during each of which the terrestrial-broadcasting-related functional module is used for greater than or equal to 15 minutes is 20.
The monthly average number of days during each of which the BS-broadcasting-related functional module is used for greater than or equal to 15 minutes is 9.
The monthly average number of days during each of which the CS-broadcasting-related functional module is used for greater than or equal to 15 minutes is 2.
The monthly average number of days during each of which the network-distribution-content-related functional module is used for greater than or equal to 15 minutes is 7.
The number of days during each of which the external-input-content-related functional module is used for greater than or equal to 15 minutes is 5. Therefore, as illustrated in FIG. 22A, the functional guarantee type is as follows.
No functional module corresponds to unused.
The functional module corresponding to light is the CS-broadcasting-related functional module.
The functional module corresponding to normal is the terrestrial-broadcasting-related functional module, the BS-broadcasting-related functional module, the network-distribution-content-related functional module, and the external-input-content-related functional module.

Therefore, the recommended guarantee type of the whole television set having the device ID of dID3 is decided to be normal from the table in FIG. 22B. For the “normal” recommended guarantee type, “the guarantee fee is 5% of the selling price, the guarantee period is 4 years, and the guarantee coverage is the spontaneous failure (however, consumables are not included in the guarantee)” is temporarily decided as the recommended guarantee content by using the table in FIG. 22C. Because no functional module corresponds to unused, the temporarily-decided recommended guarantee content is finally decided by using the table in FIG. 22D.

The recommended guarantee content of the television set in FIG. 21B having the device ID of dID4 is as follows.
The monthly average number of days during each of which the terrestrial-broadcasting-related functional module is used for greater than or equal to 15 minutes is 0.
The monthly average number of days during each of which the BS-broadcasting-related functional module is used for greater than or equal to 15 minutes is 0.
The monthly average number of days during each of which the CS-broadcasting-related functional module is used for greater than or equal to 15 minutes is 0.
The monthly average number of days during each of which the network-distribution-content-related functional module is used for greater than or equal to 15 minutes is 0.
The number of days during each of which the external-input-content-related functional module is used for greater than or equal to 15 minutes is 26. Therefore, as illustrated in FIG. 22A, the functional guarantee type is as follows.
The functional module corresponding to unused is the terrestrial-broadcasting-related functional module, the BS-broadcasting-related functional module, the CS-broadcasting-related functional module, and the network-distribution-content-related functional module.
No functional module corresponds to light.
The functional module corresponding to normal is the external-input-content-related functional module.

Therefore, the recommended guarantee type of the whole television set having the device ID of dID3 is temporarily decided to be normal from the table in FIG. 22B. For the “normal” recommended guarantee type, “the guarantee fee is 5% of the selling price, the guarantee period is 4 years, and the guarantee coverage is the spontaneous failure (however, consumables are not included in the guarantee)” is temporarily decided as the recommended guarantee content by using the table in FIG. 22C. Because the four functional modules correspond to unused, components concerning the terrestrial-broadcasting-related, BS-broadcasting-related, CS-broadcasting-related, and network-distribution-content-related functional modules are excluded from the guarantee coverage by using the table in FIG. 22D, and “the guarantee fee is 3% (5%×0.6) of the selling price, the guarantee period is 4 years, and the guarantee coverage is the spontaneous failure (however, consumables and the terrestrial-broadcasting-related, BS-broadcasting-related, CS-broadcasting-related, and network-distribution-content-related components are not included in the guarantee)” in which the guarantee fee is reduced by 40% (10% OFF×4) is finally decided as the recommended guarantee content.

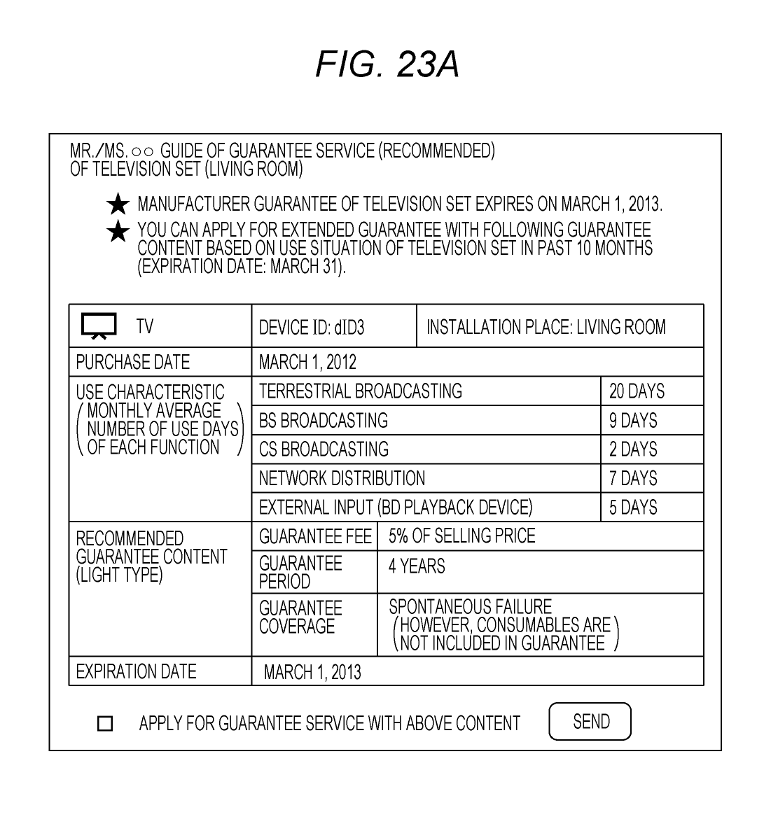

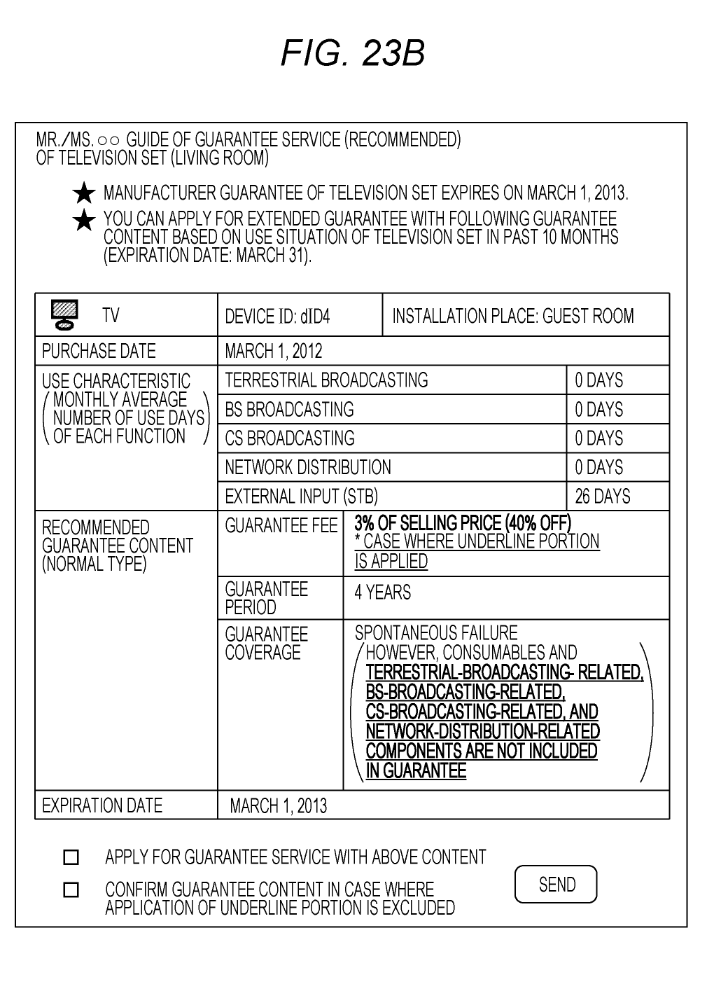

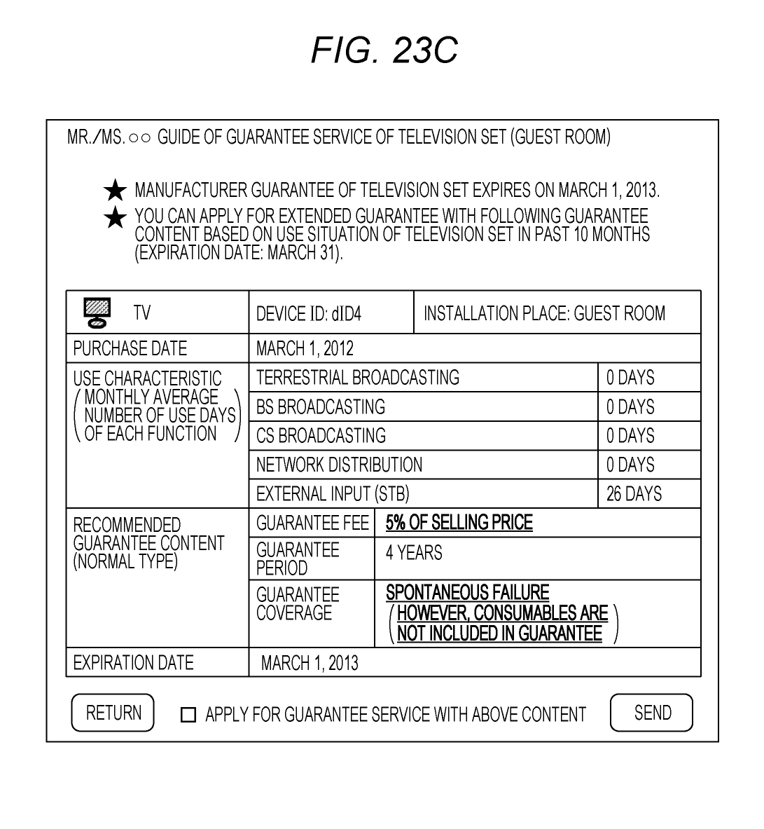

FIG. 23 illustrates an example of the display screen of the recommended guarantee display information displayed on the information output device of user 10.

FIG. 23A illustrates a display screen example of the recommended guarantee display information about the television set having the device ID of dID3, and FIG. 23B illustrates a display screen example of the recommended guarantee display information about the television set having the device ID of dID4.

In the example of FIG. 23B, in the case where the underline portion (the terrestrial-broadcasting-related, BS-broadcasting-related, CS-broadcasting-related, and network-distribution-related components are excluded from the guarantee coverage) is applied to the recommended guarantee content, it is displayed that the guarantee fee becomes “3% of selling price” in which the usual selling price is reduced by 40%. User 10 confirms the recommended guarantee content, and checks “apply for the guarantee service with the above content” to touch the send button, which allows user 10 to apply for the guarantee service with the recommended guarantee content from the display screen.

In the case where user 10 does not want the application of the underline portion (the terrestrial-broadcasting-related, BS-broadcasting-related, CS-broadcasting-related, and network-distribution-related components are excluded from the guarantee coverage) on the display screen in FIG. 23B, user 10 checks “confirm the guarantee content in the case where the application of the underline portion is excluded” to touch the send button, which allows user 10 to apply for the guarantee service with the guarantee content displayed in the case where the underline application is excluded. FIG. 23C illustrates an example of the display screen of the guarantee content in the case where the application of the underline portion is excluded. The user touches a “return” button in the bottom portion of the display screen in FIG. 23C, which allows the user to return to the display screen in FIG. 23B.

In the case where user applies for the guarantee service from the display screen in FIG. 23C, when the user continues the similar use characteristic (that is, the terrestrial-broadcasting-related, BS-broadcasting-related, CS-broadcasting-related, and network-distribution-content-related functional modules are unused) in the guarantee period, and when the failure repair of the unused functional module is not generated in the guarantee period, the service point corresponding to 2% of the selling price may be added to the holding service point of the user after the expiration of the guarantee period.

The added service point can be used as part of the guarantee fee in updating the guarantee service contract of the television set or part of the guarantee fee in the new guarantee service contract of another device.

(Modifications of Third Exemplary Embodiment)

(1) In the third exemplary embodiment, the television set is taken as an example, each use functional module of the television set, namely, the monthly average number of use days of each of the terrestrial-broadcasting-related, BS-broadcasting-related, CS-broadcasting-related, network-related, and external-input-related functional modules in the predetermined period (the constant period from the purchase date) is obtained as the use characteristic information, and the recommended guarantee content is decided based on the obtained use characteristic information. The third exemplary embodiment can similarly be applied to other devices other than the television set. For example, for the air conditioner, the monthly average number of use days of each of the functional modules such as a cooling functional module, a heating functional module, and a dehumidifying functional module is obtained as the use characteristic information, and the recommended guarantee content may be decided based on the obtained use characteristic information. For broadcasting recording devices (such as a DVD recorder and a BD recorder), the monthly average number of use days of each of the functional modules such as a recording functional module, an edit functional module, and a dubbing functional module is obtained as the use characteristic information, and the recommended guarantee content may be decided based on the obtained use characteristic information. For the microwave oven, the monthly average number of use days of each of the functional modules such as a range functional module, an oven functional module, a grill functional module, an automatic functional module (depending on a cooking menu) is obtained as the use characteristic information, and the recommended guarantee content may be decided based on the obtained use characteristic information. For the washing machine, the monthly average number of use days of each of the functional modules such as a washing functional module and a drying functional module is obtained as the use characteristic information, and the recommended guarantee content may be decided based on the obtained use characteristic information. For the refrigerator, the monthly average number of use days of each of the functional modules such as a rapidly cooling functional module and an ice making functional module is obtained as the use characteristic information, and the recommended guarantee content may be decided based on the obtained use characteristic information.

The third exemplary embodiment can be applied to any device (such as a cleaner, a rice cooker, a microwave oven, a shaver, a fitness device, a massaging tool, a television set, a DVD/BD recorder, a digital camera, a digital video camera, a car navigation system, a telephone, and a facsimile machine) other than the above devices.

(2) In the third exemplary embodiment, the monthly average number of days during each of which each functional module of the television set is used is obtained as the use characteristic information in the predetermined period. However, the third exemplary embodiment is not limited to this configuration. For example, a daily average use time of each functional module of the television set is obtained as the use characteristic information from the daily (or on the use day) use time of each functional module in the predetermined period. For example, the recommended guarantee type is set to light in the case where the daily average use time of each functional module (or on the use day) of the television set is less than 1 hour, and the recommended guarantee type is set to normal in other cases, and the recommended guarantee content may be decided based on the recommended guarantee content decision table in FIG. 22B. In any device (such as a washing machine, a cleaner, a rice cooker, a microwave oven, a shaver, a fitness device, a massaging tool, a DVD recorder, a BD recorder, a digital camera, a digital video camera, a car navigation system, a telephone, and a facsimile machine) other than the television set, the daily average use time of each functional module is obtained, as the use characteristic information, from the daily (or on the use day) use time of each functional module, and the recommended guarantee content may be decided based on the obtained use characteristic information.

(3) In a case where the specific functional module is updated (exchanged), information indicating the degree of use of the specific functional module in a period until an exchange of the specific functional module may be reset. For example, in FIG. 21A, in the case where terrestrial-broadcasting-related functional module is exchanged on Nov. 30, 2012 the number of days during each of which the terrestrial-broadcasting-related functional module is used for greater than or equal to 15 minutes may be set to 0 in each of months from March, 2012 to November, 2012.

For example, for 10 months from March, 2012 to December, 2012, the recommended guarantee content may be decided while the monthly average number of days during each of which the terrestrial-broadcasting-related functional module is used for greater than or equal to 15 minutes is set to 1.8 days.

### Fourth Exemplary Embodiment

In a fourth exemplary embodiment, a description will be given of a case where the air conditioner is taken as an example, and a package recommended guarantee content (such as the guarantee fee, the guarantee period, and the guarantee coverage) of the plurality of devices is decided and presented to the user according to the use history information about the identical type of the plurality of devices in the constant period from the purchase date.

The configuration of the recommended guarantee content presentation system of the fourth exemplary embodiment is substantially identical to that of the recommended guarantee content presentation system of the first exemplary embodiment. Therefore, a different point is mainly described below.

The following configurations of the fourth exemplary embodiment are identical to those of the first exemplary embodiment, and therefore the description is not given.
The entire configuration of the recommended guarantee content presentation system (see FIG. 2).
The configuration of the group (see FIG. 3).
The configuration of the cloud server of the data center operating company (see FIG. 4).
The configuration of the server of the service provider (see FIG. 5).
The processing flow of the device use history management service provided by the data center (see FIG. 6).
The user management table managed by the user management DB of the data center (see FIG. 7).
The device management table managed by the device management

DB of the data center (see FIG. 8).
The processing flow of the device recommended guarantee presentation service provided by the service provider (see FIG. 10).
The user management table managed by the user management DB of the service provider (see FIG. 11).
The device management table managed by the device management DB of the service provider (see FIG. 12).

The fourth exemplary embodiment differs from the first exemplary embodiment in the following points.

[Device Use History Management DB of Data Center Operating Company]

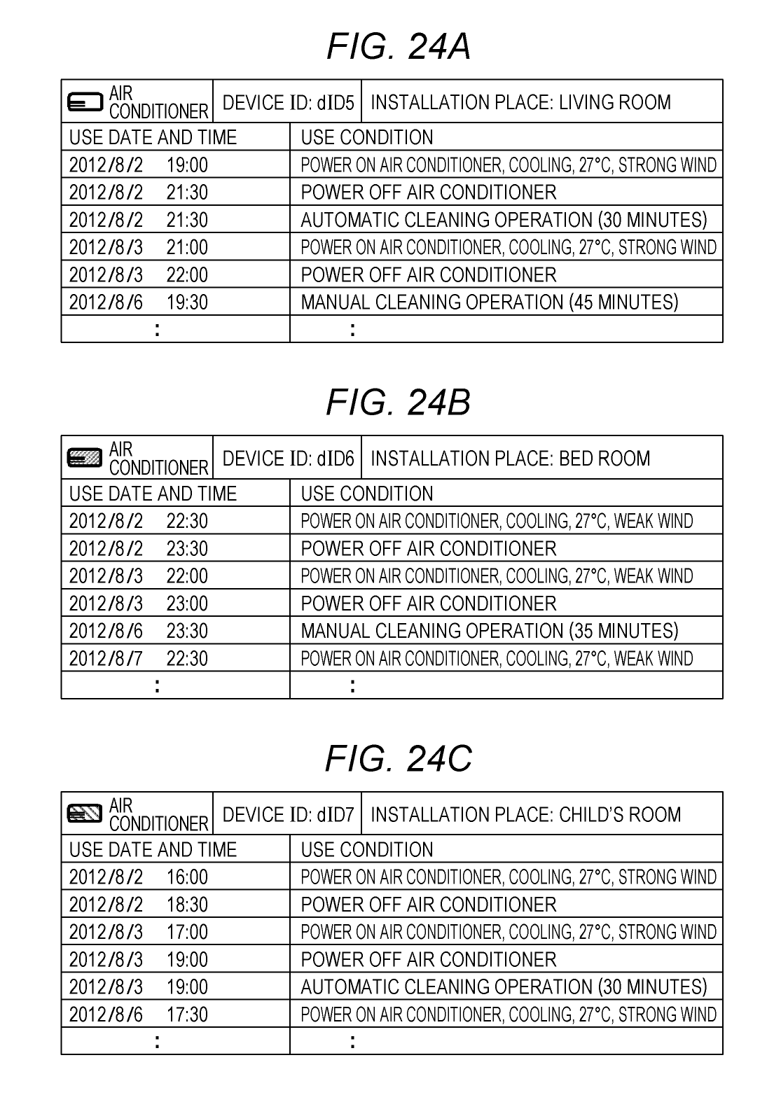

FIGS. 24A, 24B, and 24C illustrate examples of an air-conditioner use history management table managed by use history management DB 403 of data center operating company 110. FIG. 24A illustrates the use history management table for the air conditioner having the device ID of dID5, FIG. 24B illustrates the use history management table for the air conditioner having the device ID of dID6, and FIG. 24C illustrates the use history management table for the air conditioner having the device ID of dID7. Although the three air conditioners are described by way of example, there is no limitation to the number of air conditioners.

As illustrated in FIGS. 24A, 24B, and 24C, the air-conditioner use history management table includes the icon expressing each air conditioner, the device ID of each air conditioner, the installation place of each air conditioner, and the use date and time and the use condition of each air conditioner. Examples of the use condition include the power-on/off of the air conditioner and the functional module used (for example, the cooling functional module, the heating functional module, the dehumidifying functional module, and the cleaning functional module of the filter or the inside of the main body).

[Use History Management DB of Service Provider]

The air-conditioner use history management table managed by the use history management DB of service provider 120 is identical to that of the air-conditioner use history information management table managed by the use history management DB of data center operating company 110, and therefore the description is not given (see FIG. 24).

As described above, for example, cloud server 111 may transmit the use history information about each of the managed plurality of devices of the user to server 121 of service provider 120. Cloud server 111 may transmit the retained use history management table for each air conditioner to server 121 of service provider 120.

[Use Characteristic Information Generating Algorithm of Service Provider and Use Characteristic Information Example]

Use characteristic information generator 125 of server 121 of service provider 120 includes the use characteristic information generating algorithm generating the use characteristic information about the target device concerning a predetermined use condition defined in each type of the device, and inputs the use history information about the target device to the use characteristic information generating algorithm to thereby generate the use characteristic information about the device.

As described above, the use characteristic information generating algorithm is provided in each type of the device. Specifically, the use characteristic information generating algorithm may be provided in each of types of home appliances such as the lighting device, the television set, and the air conditioner, each of categories of the home appliances such as a home electric appliance, a digital home appliance, and a health and beauty home appliance, or each of models of the home appliances.

As described above, the use characteristic information generating algorithm generates the use characteristic information about the target device with respect to the predetermined use condition defined in each type of the device. Specifically, the use characteristic information generating algorithm may generate the use characteristic information (for example, an average use frequency of the use condition) about the target device with respect to the use condition in which the product life of the target device is shortened (or a failure of the target device is possibly generated) or the use characteristic information (for example, an average use frequency of the use condition) about the target device with respect to the use condition in which the product life of the target device is prolonged (or the failure of the target device is hardly generated).

The use characteristic information generating algorithm will be described below with the air conditioner as an example.

As to the air-conditioner use characteristic information generating algorithm, for example, the use history information about the air conditioner as illustrated in FIGS. 24A, 24B, and 24C is used as the input data, the number of days during each of which the air conditioner is used for greater than or equal to 2 hours is divided by the use frequency (cleaning operation frequency) of the cleaning operation functional module to obtain an average cleaning operation interval (indicating the average frequency of the cleaning operation in units of use day during which the air conditioner is used for greater than or equal to 2 hours) in the summer season (June to September), the winter season (November to February), and the summer and winter seasons, and the obtained result is output as the output data.

In the use characteristic information generating algorithm, for example, the use condition “the average cleaning operation interval (indicating the average frequency of the cleaning operation in units of use day during which the air conditioner is used for greater than or equal to 2 hours) is less than 4 use days” is an example of the use condition in which the life of the air conditioner is prolonged.

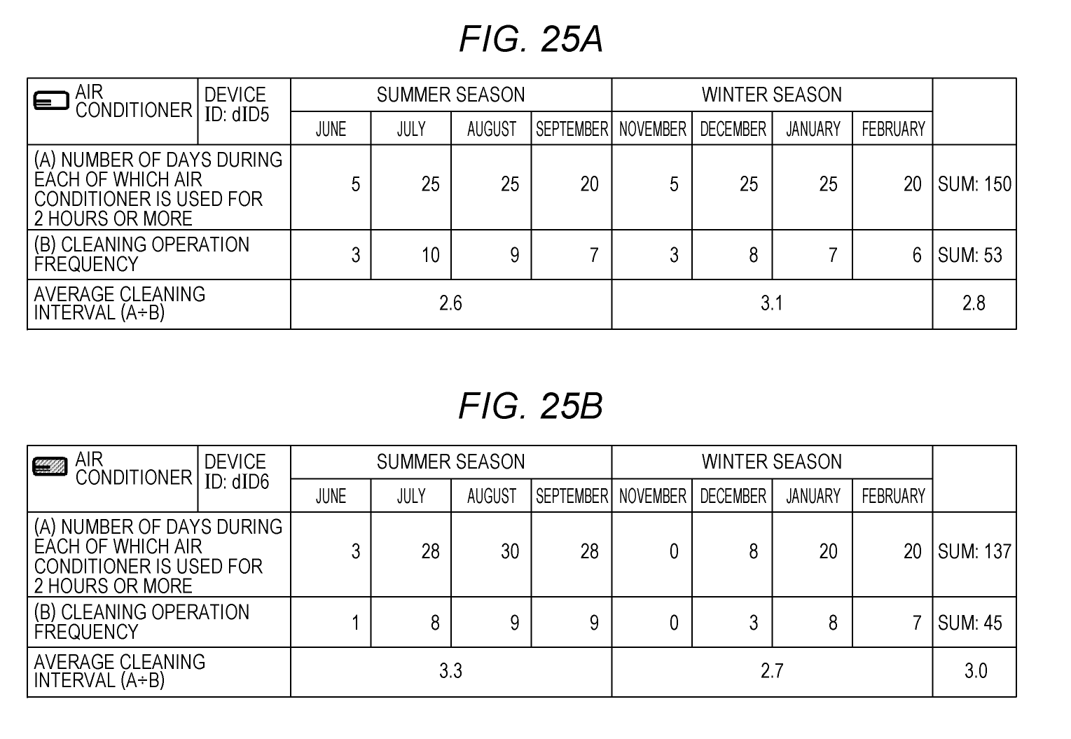

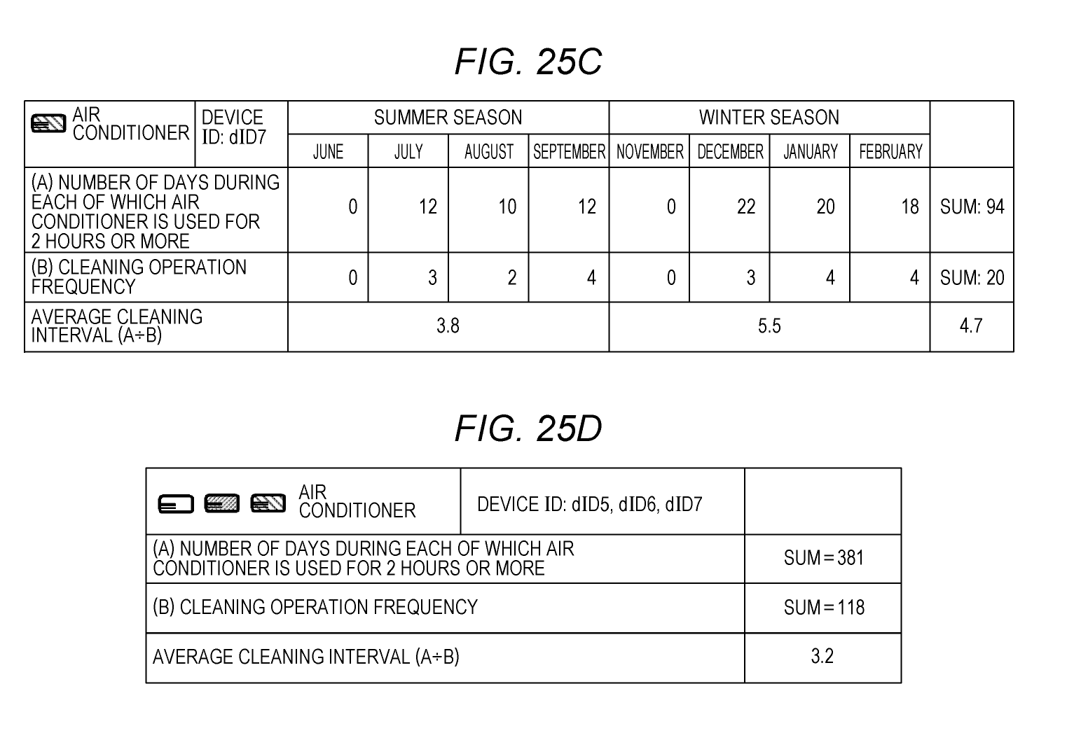

FIGS. 25A, 25B, and 25C illustrate examples of the use characteristic information about the air conditioner that is generated using the use characteristic information generating algorithm.

FIG. 25A illustrates the use characteristic information about the air conditioner having the device ID of dID5. In FIG. 25A, for example, the number of days during each of which the air conditioner is used for greater than or equal to 2 hours is 5 in June, the cleaning operation frequency is 3 in June, the average cleaning operation interval (indicating the average frequency of the cleaning operation in units of use day during which the air conditioner is used for greater than or equal to 2 hours) calculated by dividing the number of days during each of which the air conditioner is used for greater than or equal to 2 hours by the use frequency (cleaning operation frequency) of the cleaning operation functional module is 2.6 days in the summer season from June to September, the average cleaning operation interval is 3.1 days in the winter season from November to February, 2013, and the average cleaning operation interval is 2.8 days in the total of the summer and winter seasons. FIG. 25B illustrates the use characteristic information about the air conditioner having the device ID of dID6. In FIG. 25B, the average cleaning operation interval is 3.0 days in the total of the summer and winter seasons. FIG. 25C illustrates the use characteristic information about the air conditioner having the device ID of dID7. In FIG. 25C, the average cleaning operation interval is 4.7 days in the total of the summer and winter seasons. FIG. 25D illustrates the integrated use characteristic information about the three air conditioners having the device IDs of dID5 to dID7. In FIG. 25D, the average cleaning operation interval is 3.2 days in the total of the summer and winter seasons.

[Detail of Recommended Guarantee Content Decision Processing of Service Provider]

Recommended guarantee content decision unit 126 of server 121 of service provider 120 includes a recommended guarantee content decision table for the device in each type of the device, and decides the recommended guarantee content of the device by using the recommended guarantee content decision table.

As described above, the recommended guarantee content decision table is provided in each type of the device. Specifically, the recommended guarantee content decision table may be provided in each of types of home appliances such as the lighting device, the television set, and the air conditioner, each of categories of the home appliances such as a home electric appliance, a digital home appliance, and a health and beauty home appliance, or each of models of the home appliances.

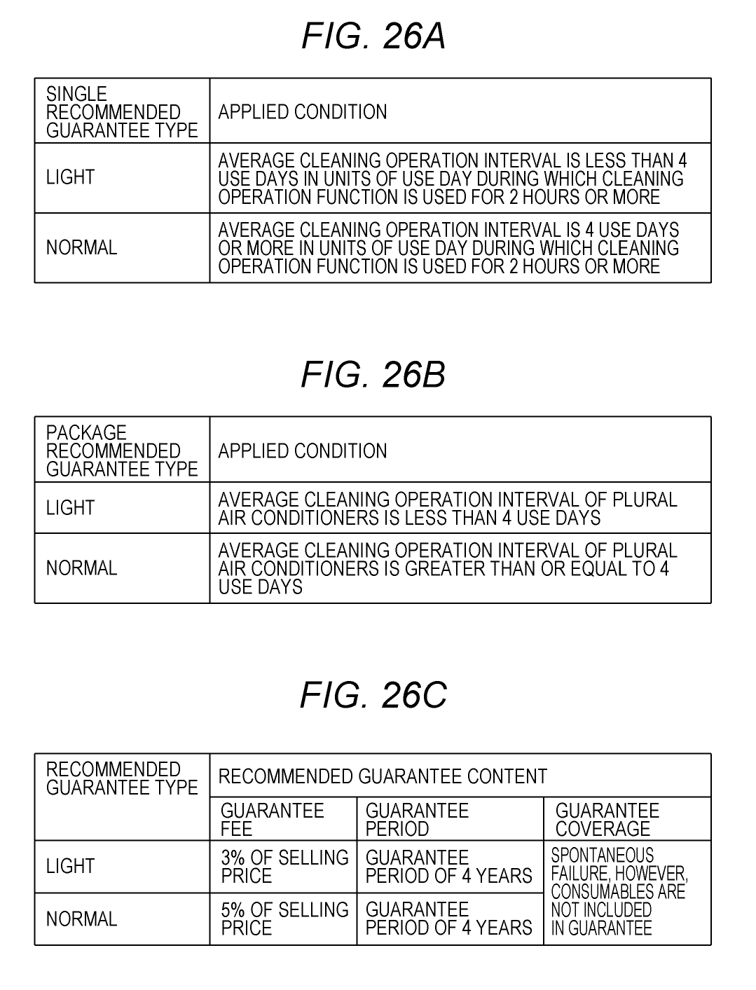

FIGS. 26A, 26B, and 26C illustrate examples of tables used to decide the recommended guarantee content of the air conditioner.

FIG. 26A illustrates a table (an auxiliary table used to decide the recommended guarantee content) used to decide the recommended guarantee type of each air conditioner based on the use characteristic information about the single air conditioner. That is, it is decided which one of the recommended guarantee types (light and normal) of the table in FIG. 26A corresponds to the use characteristic information (average cleaning operation interval) about each air conditioner.

FIG. 26B illustrates a table (an auxiliary table used to decide the recommended guarantee content) used to decide the package recommended guarantee type of the plurality of air conditioners based on the integrated use characteristic information about the plurality of air conditioners. That is, it is decided which one of the recommended guarantee types (light and normal) of the table in FIG. 26B corresponds to the integrated use characteristic information (average cleaning operation interval) about the plurality of air conditioners.

FIG. 26C illustrates a table (recommended guarantee content decision table) used to decide the recommended guarantee content according to the decided recommended guarantee type of each air conditioners or the decided package recommended guarantee type of the plurality of air conditioners.

As illustrated in FIG. 26C, the guarantee fee (3% of selling price) of the light recommended guarantee type is set cheaper than the guarantee fee (5% of selling price) of the normal recommended guarantee type. This is because it is considered that the air conditioner corresponding to the light recommended guarantee type or the air conditioner group corresponding to the light package recommended guarantee type is longer in the product life than the air conditioner corresponding to the normal recommended guarantee type or the air conditioner group corresponding to the normal package recommended guarantee type (the spontaneous failure is hardly generated). Thus, for the use characteristic in which the product life is prolonged (the spontaneous failure is hardly generated), the guarantee fee is set cheaper and the guarantee period is set longer in the recommended guarantee content decision table.

A flow of processing in which recommended guarantee content decision unit 126 of server 121 decides the recommended guarantee content of the air conditioner with the tables in FIGS. 26A, 26B, and 26C used to decide the recommended guarantee content will be described below.

(1) The recommended guarantee type of each air conditioner is decided by using the auxiliary table used to decide the recommended guarantee content in FIG. 26A.

(2) The package recommended guarantee type of the plurality of air conditioners is decided by using the auxiliary table used to decide the recommended guarantee content in FIG. 26B.

(3) The recommended guarantee content corresponding to the decided recommended guarantee type of each air conditioner and the recommended guarantee content corresponding to the decided package recommended guarantee type of the plurality of air conditioner are decided based on the recommended guarantee content decision table in FIG. 26C.

Specifically, because the average cleaning interval of the air conditioner in FIG. 25A having the device ID of dID5 is 2.8 days, the recommended guarantee type is determined to be light by using the auxiliary table in FIG. 26A used to decide the recommended guarantee content, and the recommended guarantee content of the air conditioner is determined to be “the guarantee fee is 3% of the selling price, the guarantee period is 4 years, the guarantee coverage is the spontaneous failure (however, consumables are not included in the guarantee)” based on the recommended guarantee content decision table in FIG. 26C.

Similarly, because the average cleaning interval of the air conditioner in FIG. 25B having the device ID of dID6 is 3.0 days, the recommended guarantee type is determined to be light, and the recommended guarantee content of the air conditioner is determined to be “the guarantee fee is 3% of the selling price, the guarantee period is 4 years, the guarantee coverage is the spontaneous failure (however, consumables are not included in the guarantee)” based on the recommended guarantee content decision table in FIG. 26C.

Similarly, because the average cleaning interval of the air conditioner in FIG. 25C having the device ID of dID7 is 4.7 days, the recommended guarantee type is determined to be normal, and the recommended guarantee content of the air conditioner is determined to be “the guarantee fee is 5% of the selling price, the guarantee period is 4 years, the guarantee coverage is the spontaneous failure (however, consumables are not included in the guarantee)” based on the recommended guarantee content decision table in FIG. 26C.

Then, because the integrated average cleaning interval of the three air conditioners in FIG. 25D having the device IDs of dID5 to dID7 is 3.2 days, the package recommended guarantee type of the three air conditioners is determined to be light by using the auxiliary table in FIG. 26B used to decide the recommended guarantee content, and the package recommended guarantee content of the three air conditioners is determined to be “the guarantee fee is 3% of the selling price, the guarantee period is 4 years, the guarantee coverage is the spontaneous failure (however, consumables are not included in the guarantee)” based on the recommended guarantee content decision table in FIG. 26C.

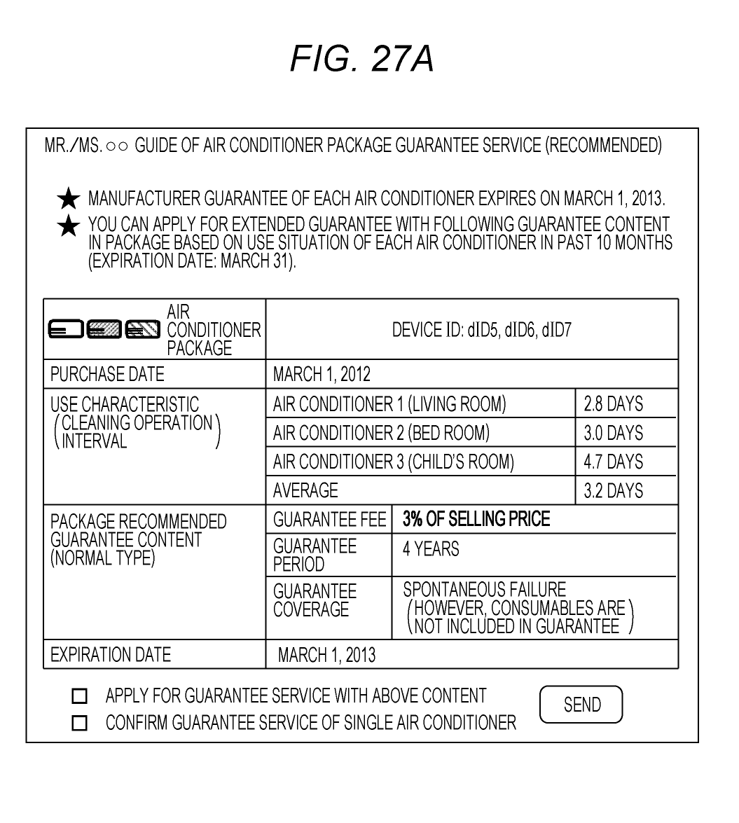

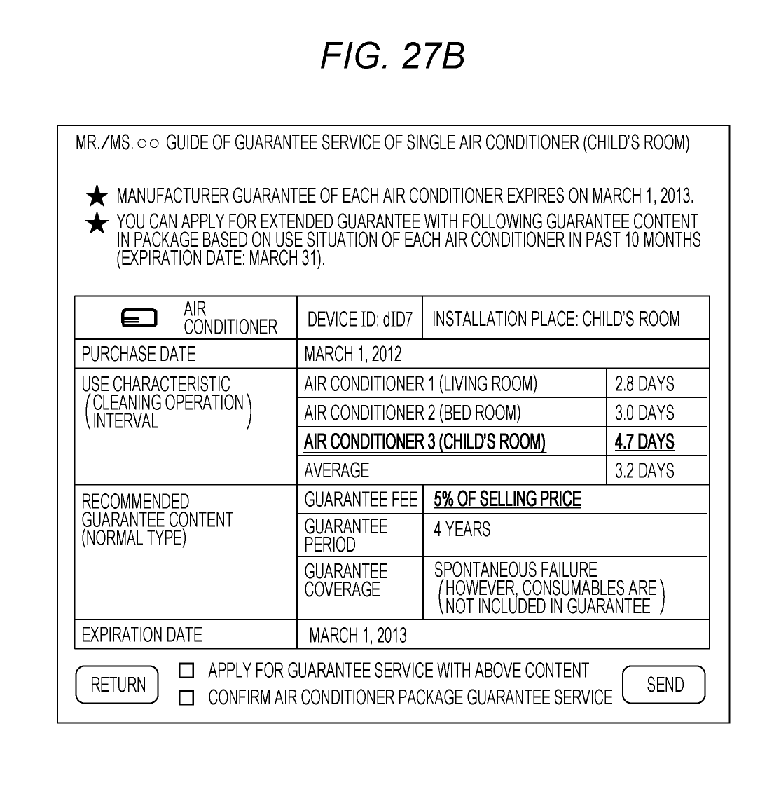

FIGS. 27A and 27B illustrate examples of the display screen of the recommended guarantee display information displayed on the information output device such as the smartphone of user 10.

FIG. 27A illustrates an example of the display screen for the package guarantee of the three air conditioners.

As illustrated in FIG. 27A, for the package guarantee of the three air conditioners, display screen (recommended guarantee display information) includes the information about the device (the type of the device (air conditioner), the icon expressing each device, the device ID of each device, and the purchase date of each device), the use characteristic of each device, the integrated use characteristic, the recommended guarantee content for the package guarantee, and the expiration date (the expiration date onto which the recommended guarantee content is applied) of the contract of the recommended guarantee service.

In the case where user 10 applies for the guarantee service with recommended guarantee content, user 10 checks “apply for the guarantee service with the above content” in the bottom portion of the display screen to touch the send button, which allows user 10 to apply for the guarantee service. In the case where the user confirms the recommended guarantee content of the single air conditioner, the user checks “confirm the guarantee service of the single air conditioner” to touch the send button, which allows the user to sequentially confirm the guarantee service of the single air conditioner. FIG. 27B illustrates an example of the display screen for the guarantee service of the single air conditioner. FIG. 27B illustrates an example of the display screen for the guarantee service of the single air conditioner having the device ID of dID7. The user can also apply for the guarantee service of the single air conditioner through the display screen in FIG. 27B.

The user touches the “return” button in the bottom portion of the display screen in FIG. 27B, which allows the user to return to the display screen in FIG. 27A.

The purchase dates of the air conditioners are identical to one another. However, the purchase dates of the air conditioners are not necessarily identical to one another. For example, for the plurality of air conditioners purchased within 1 year, the package recommended guarantee content may be decided based on the use history information of each air conditioner in the common use period before the manufacturer guarantee of the initially-purchased air conditioner is expired.

(Modifications of Fourth Exemplary Embodiment)

(1) In the fourth exemplary embodiment, the air conditioner is taken as an example, the use characteristic information (average cleaning interval) about each of the plurality of air conditioners and the integrated use characteristic information (average cleaning interval) about the plurality of air conditioners are obtained in the predetermined period (the constant period from the purchase date), and the recommended guarantee content of each air conditioner and the package recommended guarantee content of the plurality of air conditioners are decided based on the obtained use characteristic information. However, the fourth exemplary embodiment can also be applied to other devices other than the air conditioner. For example, the fourth exemplary embodiment can be applied to the identical kind of the plurality of devices such as the plurality of lighting devices, the plurality of television set, and the plurality of air cleaning humidifiers.

The fourth exemplary embodiment can also be applied to the plurality of devices having a common use characteristic. For example, the use history information (for example, the use history information about the automatic cleaning function of the washing machine, the lighting frequency of the filter exchange lamp of the cleaner, the use history information about an automatic defrosting function of the refrigerator, and a use history of the automatic care function of the microwave oven) on the case of each device is acquired with respect to the groups of the washing machines, cleaners, refrigerators, and microwave ovens, which need to be periodically cared, the integrated use characteristic information about the care functions of the plurality of devices is generated, and whether the device is frequently cared may be determined to decide the package recommended guarantee content of the plurality of devices based on the generated use characteristic information.

The fourth exemplary embodiment may be applied to the plurality of devices in which the use characteristics are considered to be similar to each other because the identical user mainly uses the devices. Specifically, for example, the fourth exemplary embodiment may be applied to the plurality of devices (a cooking device group, such as the microwave oven, an IH cooking device, and the rice cooker, which is installed in a kitchen) that are identical to each other in the installation place. The fourth exemplary embodiment may be applied to the plurality of devices (for example, a home electric appliance group such as the cleaner, the washing machine, and the iron, a digital home appliance group such as the television set, the recorder, and the digital camera, and a health home appliance group such as the body composition meter and a blood-pressure meter) of the identical category. The fourth exemplary embodiment may be applied to the plurality of devices (for example, the television set and the STB or the DVD recorder, the refrigerator and the microwave oven, the washing machine and the iron, and the air conditioner and the fan or the air cleaner) in which the coordination is used.

(2) In the fourth exemplary embodiment, the integrated use characteristic information about the plurality of air conditioners is generated, and the package recommended guarantee type of the plurality of air conditioners is decided from the generated integrated use characteristic information. However, the fourth exemplary embodiment is not limited to this configuration. For example, the package recommended guarantee type of the plurality of air conditioners may be decided by majority voting of the recommended guarantee types of the air conditioners, the package recommended guarantee types of the air conditioners being decided based on the use characteristic information about each air conditioner.

FIG. 25D illustrates the integrated use characteristic information about the three air conditioners having the device IDs of dID5 to dID7. For example, it is assumed that the four air conditioners are installed in the identical house. Because the fourth air conditioner is identical to the air conditioners having the device IDs of dID5 to dID7 in the type of the device, the package recommended guarantee content of the three air conditioners having the device IDs of dID5 to dID7 may be presented to the user as the recommended guarantee content of the fourth air conditioner without generating the use characteristic information about the fourth air conditioner together with information (for example, average cleaning interval in FIG. 25D=3.2 days) indicating an integrated degree of use included in the integrated use characteristic information.

(Modifications)

(1) In each exemplary embodiment, the recommended guarantee content is decided based on the use history information in the predetermined period (the constant period from the purchase date of the device). However, each exemplary embodiment is not limited to this configuration.

(1.1) For example, for the user who already applied for the guarantee service based on the recommended guarantee content generated in each exemplary embodiment, 1) an update recommended guarantee content of the guarantee service is decided based on the use history information in a constant period (for example, before 1 year from the end of the guarantee period and before 2 months from the end of the guarantee period) within the guarantee period of the guarantee service, and 2) the decided update recommended guarantee content may be presented to the user before the end of the already-applied guarantee service. At this point, the flow of the processing of deciding the update recommended guarantee content is identical to that of each exemplary embodiment, and therefore the description is not given.

(1.2) For example, for the user who already applied for the guarantee service based on the recommended guarantee content generated in each exemplary embodiment, 1) in the case where a new function is added to the device (or the function of the device is updated) via, for example, the network, the update recommended guarantee content is decided based on the use history information in a predetermined period (for example, for 10 months from the day on which the function is added (the day on which the function is updated), and 2) the decided update recommended guarantee content may be presented to the user. At this point, the flow of the processing of deciding the update recommended guarantee content is identical to that of each exemplary embodiment, and therefore the description is not given.

In the case where the use characteristic information generating algorithm or the recommended guarantee content decision table depends on the use functional module like the use characteristic information generating algorithm and recommended guarantee content decision table of the third exemplary embodiment (for example, see FIG. 22D), the use characteristic information generating algorithm and the recommended guarantee content decision table may be updated according to the addition of the new functional module. It is assumed that the new functional module is added to the device by updating software via, for example, the network or installing a new component or a peripheral device on the device.

(1.3) For example, for the user who already applied for the guarantee service based on the recommended guarantee content generated in each exemplary embodiment, 1) the recommended guarantee type is decided based on the use history information in a constant period (for example, for 10 months from the starting day of the guarantee period and 10 months from the starting day in the second year of the guarantee period) within the guarantee period, 2) the update recommended guarantee content is decided based on the decided recommended guarantee type in the case where the decided recommended guarantee type differs from the recommended guarantee type of the already-applied guarantee service, and 3) the decided update recommended guarantee content may be presented to the user. At this point, the flow of the processing of deciding the update recommended guarantee content is identical to that of each exemplary embodiment, and therefore the description is not given.

(2) In each exemplary embodiment, the server of the service provider acquires the use history information about the device to generate the use characteristic information. However, each exemplary embodiment is not limited to this configuration.

(2.1) For example, the cloud server of the data center may include a use characteristic information generator equivalent to the use characteristic information generator of the service provider, generate the use characteristic information from the use history information about the device, and transmit the use characteristic information to the server of the service provider. In this case, the server of the service provider may include a use characteristic information management unit instead of the use history information management unit and the use characteristic information generator, acquire the use characteristic information from the cloud server, and manage the use characteristic information using the use characteristic information management unit. The cloud server of the data center may coordinate with the server of the service provider to generate the use characteristic information from the use history information about the device.

(2.2) For example, each device may include a use characteristic information generator equivalent to the use characteristic information generator of the service provider, generate the use characteristic information from the use history information about the device, and transmit the use characteristic information to the cloud server of the data center. In this case, the cloud server may include a use characteristic information management unit instead of the use history information management unit, and manage the received use characteristic information using the use characteristic information management unit, and transmit the use characteristic information to the server of the service provider. In this case, the server of the service provider may include a use characteristic information management unit instead of the use history information management unit and the use characteristic information generator, acquire the use characteristic information from the cloud server, and manage the use characteristic information using the use characteristic information management unit.

(3) In each exemplary embodiment, the recommended guarantee content is decided based on the use history information about the device. Alternatively, the recommended guarantee content may be decided based on various pieces of information in addition to the use history information about the device.

(3.1) For example, the recommended guarantee content may be decided based on installation place information about the device and information about a use environment of the device (use environment information) in addition to the use history information about the device. As to the installation place information, examples of the installation place include a drawing room, a living room, a guest room, a dining room, a kitchen, a bathroom, a washroom, and a dressing room for the air conditioner, examples of the installation place include a balcony, a garden, and a garage for an air conditioner outdoor unit. For the washing machine, examples of the installation place include an indoor place and an outdoor place. Examples of the information about the use environment include an indoor temperature, indoor humidity, and an outdoor temperature for the air conditioner, and examples of the information about the use environment include a degree of dirt of ambient air for the air cleaner. The use environment information includes not only the information that can directly be acquired from the device but also the information that can indirectly be acquired through another device. For example, the use environment information about the device may be detected or monitored by another device such as a sensor and a monitoring camera, and the cloud server may acquire the use environment information about the device from another device. An extra guarantee fee of the recommended guarantee content may be set to the device used in an environment in which the product life is considered to be shortened (the failure of the device is considered to be generated), or the shorter guarantee period may be set to the device used in the environment.

For example, in the case where the washing machine is installed indoor, the guarantee fee may be set lower compared with the guarantee fee of the washing machine installed outdoor. In the case where the washing machine is installed indoor, the guarantee period may be set longer compared with the guarantee period of the washing machine installed outdoor. In addition to the recommended guarantee content, the information presented to the user of the device may include information identifying the installation place of the device and information about the use environment of the device.

(3.2) For example, the recommended guarantee content may be decided based on the use history information (error history information) about the device of the identical type of another group (for example, a device produced in an identical lot by an identical manufacturing line of an identical manufacturing factory in an identical period) in addition to the use history information about the device. For example, the recommended guarantee content may be decided based on the average use characteristic information about the device of another group produced in the identical lot by the identical manufacturing line of the identical manufacturing factory in the identical period with the target device.

For example, the cloud server presumes that, in the case where a function (for example, re-heating) of another device (for example, the microwave oven in the home of Mr./Ms. B) is performed, another device having the type identical to that of a target device (for example, the microwave oven in the home of Mr./Ms. A) and manufacturing information (for example, an identical lot number) identical to that of the target device, another device does not normally operate (for example, input of a re-heating key is not recognized).

The cloud server may acquire, from the device, an error code (for example, an error code “E02” in the case where a microcomputer of the microwave oven always recognizes that at least two keys are input even if the user inputs only one key on a control panel of the microwave oven) corresponding to a cause of the device that does not normally operate.

The server of the service provider may acquire the error code of another device (for example, the microwave oven in the home of Mr./Ms. B) from the cloud server, and decide the recommended guarantee content of the target device (for example, the microwave oven in the home of Mr./Ms. A) based on error code history information. With increasing error code notification, the server of the service provider may reduce the guarantee fee included in the guarantee content. The guarantee fee in which the price of a replacement component corresponding to the error code is reduced may be presented to the user.

(4) In each exemplary embodiment, the device management system may further include means for acquiring information about the user who uses each device, and the use history information about the device may include the user information of the user who used the device, in addition to the use time and the use condition of the device. In this case, the use characteristic information about each user is generated as the use characteristic information in addition to the use characteristic information about the device used by all the users who use the device, and the generated use characteristic information about the device used by all the users and the use characteristic information about each user may be presented to all the users together with the recommended guarantee content generated based on the use characteristic information about the device used by all the users who use the device. Alternatively, the generated use characteristic information about the device that is used by all the users and the use characteristic information about each user may be presented to a representative (for example, the user who most uses the device) together with the recommended guarantee content generated based on the use characteristic information about the device used by all the users. In the case where the device management system further manages information about an attribute (a parent and a child) of the user, the generated use characteristic information about the device used by all the users and the use characteristic information about each user may be presented to the user who is the parent together with the recommended guarantee content.

For example, a fingerprint authentication system is arranged in the manipulation button of the device, the user (a child, a husband, and a wife) of the device is identified, and the use history information about the device may include data in which data of the identified user of the device corresponds to data (for example, when the cooling function is activated or stopped) of the use of the device (for example, the air conditioner). The information indicating the use situation of the device (for example, the monthly number of days during each of which the air conditioner is used for greater than or equal to 2 hours is obtained for predetermined months, and the monthly numbers of days are averaged) is obtained in each of the child, the wife, and the husband the information may be presented to a mobile phone of the husband who is registered as the user of the device together with the recommended guarantee content.

Therefore, after recognizing the use characteristic information about a person except oneself, each user can determine whether to apply for the guarantee contract of the device.

The use characteristic information about each user is obtained based on the use history information about each user, and a sharing rate of the guarantee fee of each user may be decided based on the obtained use characteristic information about each user.

(5) In each exemplary embodiment, the use characteristic information about the device is generated based on the use history information about the device in the predetermined period, and the recommended guarantee content of the device is decided based on the use characteristic information about the device. However, each exemplary embodiment is not limited to this configuration. For example, in the case where the use characteristic information about the device that should accept the guarantee is considered to be similar to the use characteristic information about another device having the type identical to that of the device, the recommended guarantee content may be decided based on the already acquired use characteristic information about another device having the type identical to that of the device without acquiring the use characteristic information about the device that should accept the guarantee. For example, in the case where the use characteristic of the newly-purchased television set is considered to be similar to the use characteristic of the already existing television set like the replacement of the television set, the recommended guarantee content may be decided based on the use characteristic information about the already existing television set, and presented to the user as a guide.

(6) In each exemplary embodiment, the use characteristic information about the device is generated based on the use history information about the device in the predetermined period, the recommended guarantee content of the device is decided based on the use characteristic information about the device, and the decided recommended guarantee content is presented to the user. However, each exemplary embodiment is not limited to this configuration. For example, in the case where the use characteristic information significantly shortening the life of the device is generated, the generated use characteristic information and information indicating that the recommended guarantee content cannot be presented or information indicating that the guarantee contract cannot be performed may be presented to the user. In the case where the use characteristic information, which is generated every time the device is used, significantly shortens the life of the device, warning information indicating that the recommended guarantee content cannot be presented when the user similarly continues the use of the device or warning information indicating that the guarantee contract cannot be performed when the user similarly continues the use of the device may be presented to the user.

For example, the technology described in the above aspect can be implemented by the following cloud service type. However, there is no limitation to the cloud service type that implements the technology described in the above aspect.

(Service Type 1: Stand-Alone Data Center Type)

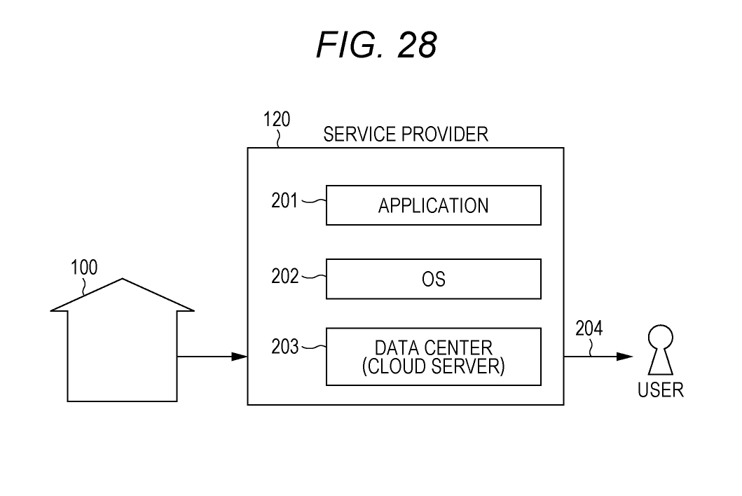

FIG. 28 illustrates service type 1 (stand-alone data center type). In service type 1, service provider 120 acquires information from group 100, and provides services to users. In service type 1, service provider 120 functions as a data center operating company. That is, the service provider owns cloud server 111 that manages big data. Accordingly, the data center operating company does not exist.

In service type 1, service provider 120 operates and manages data center 203 (cloud server 111). Service provider 120 also manages OS 202 and application 201. Service provider 120 performs service provision 204 by using OS 202 and application 201 that are managed by service provider 120.

(Service Type 2: IaaS Based Type)

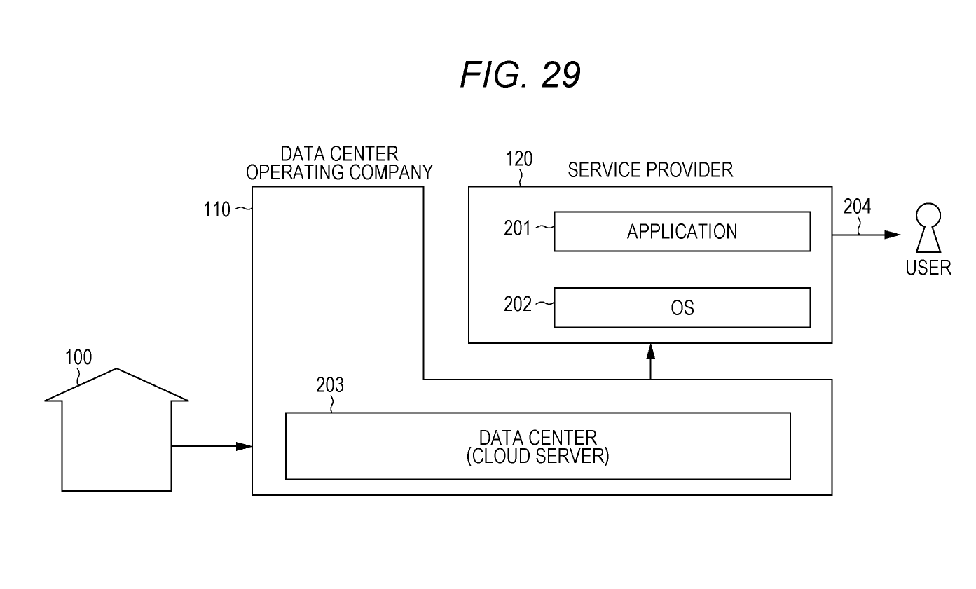

FIG. 29 illustrates service type 2 (IaaS based type). As used herein, IaaS is an abbreviation of Infrastructure as a Service. IaaS is a cloud service delivery model that provides infrastructures for configuring and operating computer systems as services offered via the Internet.

In service type 2, data center operating company 110 operates and manages data center 203 (cloud server 111). Service provider 120 also manages OS 202 and application 201. Service provider 120 performs service provision 204 by using OS 202 and application 201 that are managed by service provider 120.

(Service Type 3: PaaS Based Type)

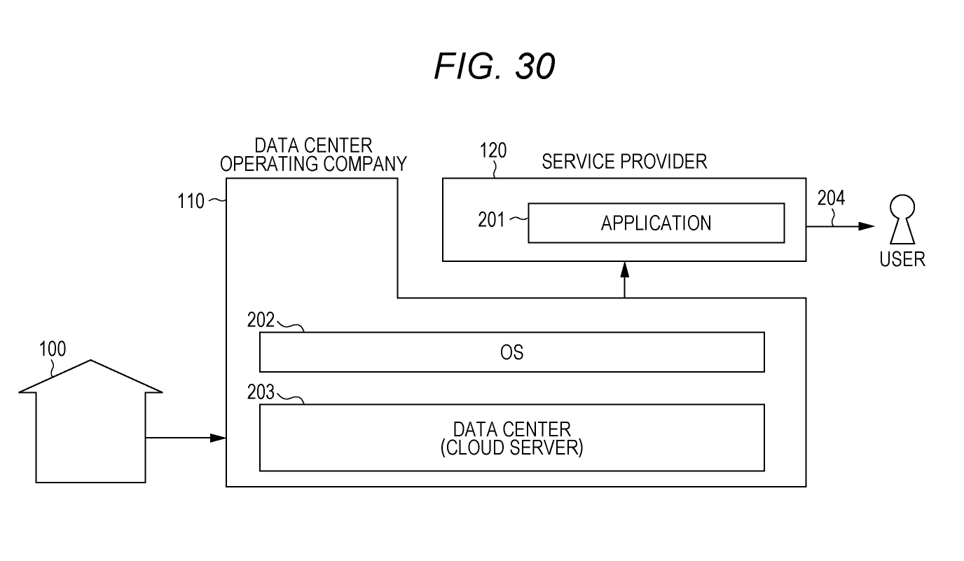

FIG. 30 illustrates service type 3 (PaaS based type). As used herein, PaaS is an abbreviation of Platform as a Service. PaaS is a cloud service delivery model that provides a platform serving as a base configuring and operating software as services offered via the Internet.

In service type 3, data center operating company 110 manages OS 202, and operates and manages data center 203 (cloud server 111). Service provider 120 also manages application 201. Service provider 120 performs service provision 204 by using OS 202 managed by data center operating company 110 and application 201 managed by service provider 120.

(Service Type 4: SaaS Based Type)

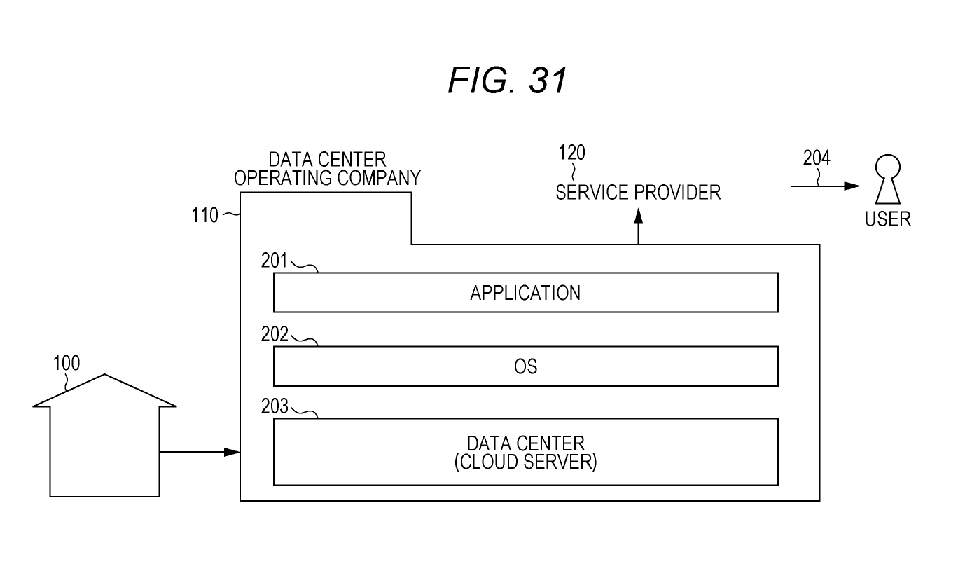

FIG. 31 illustrates service type 4 (SaaS based type). As used herein, SaaS is an abbreviation of Software as a Service. For example, SaaS is a cloud service delivery model that has a function of allowing, for example, companies and individuals (users) who do not own data centers (cloud servers) to use applications provided by platform providers who own their data centers (cloud servers) via a network such as the Internet.

In service type 4, data center operating company 110 manages application 201 and OS 202, and operates and manages data center 203 (cloud server 111). Also, service provider 120 performs service provision 204 by using OS 202 and application 201 that are managed by data center operating company 110.

In any of the above types described above, it is construed that service provider 120 performs an act of providing services. Also, for example, the service provider or the data center operating company may develop, on their own, an OS, an application or a big data database, or may outsource such development to a third party.

### INDUSTRIAL APPLICABILITY

The information presentation method of the present disclosure is useful as the method for being able to properly presenting the recommended guarantee content based on the type and the use history of the device.

### REFERENCE MARKS IN THE DRAWINGS

10 user
20 user
100 group
101 a plurality of devices
102 home gateway
110 data center operating company
111 cloud server
112 user management unit
113 device management unit
114 use history information management unit
120 service provider
121 server
122 user management unit
123 device management unit
124 use history information management unit
125 use characteristic information generator
126 recommended guarantee content decision unit
127 recommended guarantee content display controller
128 service point adder
130 network
201 application
202 OS
203 data center
401 user management DB
402 device management DB
403 use history management DB
501 user management DB
502 device management DB
503 use history management DB

1. An information presentation method for presenting a recommended guarantee content of a first device included in a plurality of devices, the information presentation method comprising:
acquiring use history information including data indicating use of the first device;
generating information indicating a use situation of the first device based on the use history information and processing defined in each type of the device;
deciding the recommended guarantee content of the first device based on the information indicating the use situation of the first device; and
presenting the recommended guarantee content to a user of the first device.

2. The information presentation method according to claim 1, wherein the information indicating the use situation of the first device includes information indicating a degree of use of the first device,
the recommended guarantee content includes at least one of a guarantee fee, a guarantee period, and a guarantee coverage that are decided based on the information indicating the degree of use of the first device, and
the information indicating the degree of use of the first device is presented to the user of the first device together with the recommended guarantee content.

3. The information presentation method according to claim 2, wherein the information indicating the degree of use of the first device includes information indicating a degree of use of a specific functional module included in the first device.

4. The information presentation method according to claim 3, further comprising:
generating a service point applicable to the guarantee fee included in the recommended guarantee content based on the information indicating the degree of use of the first device; and
adding the generated service point to a service point possessed by the user of the first device,
wherein the post-addition service point is presented to the user of the first device together with the recommended guarantee content.

5. The information presentation method according to claim 4, further comprising:
acquiring information identifying the user of the first device, the information corresponding to the data indicating the use of the first device; and
generating information indicating the use situation of the first device in each user based on the use history information further including the information identifying the user of the first device that corresponds to the data indicating the use of the first device, and the processing defined in each type of the device,
wherein the information indicating the use situation of the first device in each user is presented to the user of the first device together with the recommended guarantee content.

6. The information presentation method according to claim 5, wherein the use history information includes data indicating the use of the first device in a second period included in a first period started from a purchase date of the first device,
the guarantee period of the recommended guarantee content is started after expiration of the first period, and
the first period is a guarantee period of the first device by a device manufacturer.

7. The information presentation method according to claim 5, wherein the use history information includes data indicating the use of the first device in a fourth period included in a third period started after the expiration of the first period started from the purchase date of the first device,
the guarantee period of the recommended guarantee content is started after expiration of the third period, and
the first period is a guarantee period of the first device by a device manufacturer.

8. The information presentation method according to claim 7, wherein the data indicating the use of the first device includes data indicating use of a functional module that is newly added to the first device or updated, and
the fourth period is a period started from a day on which the functional module is newly added or updated.

9. The information presentation method according to claim 5, wherein information indicating a degree of use of the specific functional module in a period until an exchange of the specific functional module is reset when the specific functional module is exchanged.

10. The information presentation method according to claim 5, further comprising:
acquiring information identifying an installation place of the first device,
wherein a guarantee fee for installing the first device indoor is lower than a guarantee fee for installing the first device outdoor, or a guarantee period for installing the first device indoor is longer than a guarantee period for installing the first device outdoor.

11. The information presentation method according to claim 5, further comprising
acquiring error history information indicating that a second device is not normally operated as use history information about the second device that is identical to the first device in a type, the second device having manufacturing information identical to that of the first device; and
deciding the recommended guarantee content of the first device based on the error history information.

12. The information presentation method according to claim 5, wherein the first device is a television set that can receive terrestrial broadcasting,
the specific functional module is a terrestrial-broadcasting-related functional module including a function of receiving the terrestrial broadcasting,
the use history information includes information indicating when the terrestrial-broadcasting-related functional module is used, and
information indicating the degree of use of the specific functional module includes an average number of days of each month of a number of days on which the terrestrial-broadcasting-related functional module is used for a predetermined time or more per day in a fifth period included in the first period started from the purchase date of the first device.

13. The information presentation method according to claim 5, wherein the plurality of devices include a television set and a lighting device,
the television set and the lighting device differ from each other in the type of the device,
the first device is the lighting device, and
information indicating a degree of use of the lighting device includes an average number of days of each month of a number of days on which the lighting device is used for a predetermined time or less per day in a sixth period included in the first period started from the purchase date of the first device.

14. The information presentation method according to claim 2, further comprising:
acquiring use history information including data indicating use of each of n (n is a natural number) devices each of which is identical to the first device in a type;
generating information indicating a degree of use of each of the n devices based on the use history information corresponding to each of the n devices and the processing defined in each type of the device;
generating information indicating an integrated degree of use of the first device and the n devices based on the information indicating the degree of use of the first device and the information indicating the degree of use of each of the n devices;
deciding a package recommended guarantee content of the first device and the n devices based on the information indicating the integrated degree of use; and
presenting the package recommended guarantee content to the user of the first device together with the information indicating the integrated degree of use.

15. The information presentation method according to claim 14, further comprising:
using the package recommended guarantee content as a recommended guarantee content of a third device that is identical to the first device in a type; and
presenting the package recommended guarantee content as the recommended guarantee content of the third device to the user of the third device together with the information indicating the integrated degree of use.

16. The information presentation method according to claim 15, wherein the first device is a first air conditioner,
the n devices are n air conditioners,
the information indicating the degree of use of the first device is a number of days decided based on an average number of days of each month of a number of days on which the first air conditioner is used for a predetermined time or more per day in a predetermined period,
the information indicating the degree of use of each of the n devices is a number of days decided based on an average number of days of each month of a number of days on which each of the n air conditioners is used for the predetermined time or more per day in the predetermined period, and
the information indicating the integrated degree of use is an average value of the decided number of days for the first air conditioner and the decided number of days for each of the n air conditioners.

17. An information presentation system presenting a recommended guarantee content of a first device included in a plurality of devices, the information presentation system comprising:
an acquiring unit that acquires use history information including data indicating use of the first device;
a generator that generates information indicating a use situation of the first device based on the use history information and processing defined in each type of the device;
a decision unit that decides the recommended guarantee content of the first device based on the information indicating the use situation of the first device; and
a presenting unit that presents the recommended guarantee content to the user of the first device.

18. A program causing a computer to perform the information presentation method according to claim 1.

19. A computer-readable non-temporary recording medium in which the program according to claim 18 is stored.
